(19) United States
(12) Patent Application Publication
(10) Pub. No.: US 2007/0139780 A1
(43) Pub. Date: Jun. 21, 2007

(54) Process for producing coating film, antireflection film and process for producing the same, sheet polarizer using the film, and image display device using these

(75) Inventors: Takato Suzuki, Kanagawa (JP); Kazuhiko Nojo, Shizuoka (JP); Tomonari Ogawa, Shizuoka (JP); Yoichi Hasegawa, Shizuoka (JP); Kazuhiro Oki, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, TOKYO (JP)

(21) Appl. No.: 11/629,777

(22) PCT Filed: Jun. 13, 2005
(86) PCT No.: PCT/JP05/11189

§ 371 Date: Jan. 3, 2007

(30) Foreign Application Priority Data
Jun. 17, 2004 (JP) 2004-180010
Sep. 29, 2004 (JP) 2004-285219

(51) Int. Cl. G02B 1/10

(52) U.S. Cl. 359/586

(57) ABSTRACT

The present invention provides a process for producing an antireflection film comprising applying, using a slot die, a coating solution onto a web which is backed up by a back-up roller and runs continuously to form at least one layer which has a thickness of 200 nm or less in a dried state and has a refractive index lower than that of the web. The slot die has an edge lip downstream of the running web which has a land length along the running web is 30 to 100 μm, and the space between the edge lip of the slot die upstream of the running web and the surface of the web is set to be 30 to 120 μm larger than the space between the edge lip of the slot die downstream of the running web and the surface of the web.

### TECHNICAL FIELD

The present invention relates to a process for producing a coating film comprising continuously forming a coating film on a continuous strip substrate (hereinafter referred to as web), an antireflection film and a process for producing the same, a sheet polarizer using the film, and an image display device using these.

### BACKGROUND ART

With higher performance and wider spread of information-communication related equipments, audio visual equipments, etc., there have been rapidly expanding demands for components using thin films of the order of 10 nm to 100 nm and increasing needs for producing such thin films with high productivity. Such thin films are often used as optical components and thin films having such optical functions are generally called optical thin films. Optical thin films have film thickness of about ¼- to 1-fold visible wavelength (optical film thickness nd=physical film thickness×refractive index) and are allowed to have a variety of functions as single-layer films or multi-layer films. Major products using an optical thin film include: band path filters, dichroic mirrors, dichroic filters, cold mirror filters, beam splitters, antireflection films, near infrared cut filters, laser mirrors and ND filters.

Antireflection films having an antireflection layer are used in various image display devices such as liquid crystal displays (LCD), plasma display panels (PDP), electroluminescence displays (ELD) and cathode ray tubes (CRT). They are also used in lenses of eyeglasses and cameras.

As these antireflection films, multi-layer films produced by laminating transparent thin films of metal oxides have been commonly used. The reason for using a plurality of transparent thin films is that doing so prevents the reflection of light in the widest possible wavelength region in the visible range.

These transparent thin films of metal oxides have been formed by chemical vapor deposition (CVD) process or physical vapor deposition (PVD) process, in particular, vacuum vapor deposition or sputtering process as one kind of physical vapor deposition processes. However, film forming processes by vapor deposition or sputtering are poor in productivity, and therefore not suitable for mass production, though transparent thin films of metal oxides have excellent optical characteristics as antireflection films.

As alternatives to the above described vapor deposition processes, there have been proposed processes in which antireflection films are formed by the coating of inorganic fine particles (Japanese Examined Application Publication No. 60-59250, Japanese Patent Application Laid-open Nos. 59-50401, 7-151904, 2003-200097 and 2003-211052). Of these patent documents, Japanese Examined Application Publication No. 60-59250 proposes an antireflection film made up of an antireflection layer that has a very fine void and organic matter in the form of fine particles. The antireflection layer is formed by the coating process. The coating layer undergoes activating gas treatment after the coating operation, and the very fine void is formed by the elimination of the gas from the coating layer.

Japanese Patent Application Laid-open No. 59-50401 discloses an antireflection film formed by laminating a substrate, a layer with a high refractive index and a layer with a low refractive index in this order as well as an antireflection film formed by providing a layer with an intermediate refractive index between the substrate and the layer with a high refractive index of the above antireflection film. The layer with a low refractive index is formed by the coating of polymer or inorganic fine particles.

Japanese Patent Application Laid-open No. 7-151904 proposes a process for forming an antireflection layer by a die coating process. Japanese Patent Application Laid-open Nos. 2003-200097 and 2003-211052 propose processes for forming an antireflection layer by a die coating process in which the construction of the die is devised to assure sufficient accuracy of thin-film coating.

However, when intending to form an antireflection film by a coating process, since the thickness of the coating film is as very thin as about ½- to ¼-fold the visible wavelength, thickness non-uniformity of the order of several nm produces a large deviation. In addition, slight thickness non-uniformity of each layer causes discoloration and a large shift of color tone, resulting in visually detectable non-uniformity. Thus, a coating technology which assures accurate control of film thickness is very important. The portions where film thickness non-uniformity mostly occurs during the antireflection film production process are portions having been subjected to coating and drying after the coating operation.

In contrast with the above described proposals, dip coating, microgravure coating and reverse roll coating processes have been mainly used as processes for coating antireflection films.

However, in the dip coating process, the vibration of the coating solution in the fluid receiving tank is unavoidable, which makes step-like non-uniformity more likely to occur. In the reverse roll coating process and the microgravure coating process, the eccentricity or deflection of the coating-related roll makes step-like non-uniformity more likely to occur. Further, in the microgravure coating process, non-uniformity in the amount of coating is likely to occur depending on the precision with which the gravure roll has been made or on the change in the roll and the blade with time caused by their hitting each other.

In addition, since these coating processes are of post-metering type, it is relatively hard to ensure stable film thickness. As a result, in these coating processes, there is a limit to which the coating speed is increased, and therefore they do not make full use of their characteristic of high productivity, though their productivity is higher than that of vapor deposition processes.

In the meantime, the above described die coating process, which is proposed in Japanese Patent Application Laid-open No. 7-151904, is of pre-metering type, and therefore offering the advantage of highly stable film thickness. However, in this process, thin film coating is performed using a commonly used die construction, it can only realize a coating speed almost as high as that of the above described coating processes. Specifically, in the coating of a thin layer, such as an antireflection layer, film thickness non-uniformity markedly occurs in the direction perpendicular to and parallel to the direction in which the transparent substrate is conveyed, and it is difficult to keep the stability of film thickness.

In contrast, Japanese Patent Application Laid-open Nos. 2003-200097 and 2003-211052 state that in the die coating processes proposed therein, thin film coating can be performed with high precision since the die construction is devised.

However, even when thin film coating is performed with the die construction disclosed in these patent specifications, thin film coating at a high speed is difficult to perform depending on the type of the coating solution and sometimes thin film coating itself is impossible. Further, even if wet film thickness is kept stable at the high-speed film coating step, a satisfactory plane cannot sometimes be obtained due to the film thickness non-uniformity caused in the drying step right after the high-speed film coating step.

When a coating solution contains an organic solvent, particularly when film thickness non-uniformity of the order of several nm caused in the steps of film coating and drying is visually observed as a defective plane, such non-uniformity results in significant deterioration of film quality.

In the drying step, hot-air drying is usually employed. The hot-air drying excels in drying efficiency; however, it has the problem of being unable to produce a uniform coating layer. Specifically, in the drying process, air strikes the coated surface directly or via a perforated plate, a rectifying plate or the like and causes the coated surface to fall into disorder and the thickness of the coating layer to be non-uniform, or convection makes the rate of the solvent evaporation from the coated surface non-uniform, which results in occurrence of what is called orange peel surface. It is possible to obtain a satisfactory plane by controlling the conditions under which air is blown against the coating film to decrease the rate of the solvent evaporation; however, if the coating rate is decreased so as to increase the productivity, a drying step requires a longer time to complete drying. Thus, this is not a preferable process in terms of a productivity increase.

The present invention has been made in the light of the above described circumstances. Accordingly, an object of the present invention is to provide a process for producing a coating film and a process for producing an antireflection film both of which provide the resultant films with high-definition image drawing characteristics and excellent antireflection and anti-glare properties. And another object of the present invention is to provide a process for producing an antireflection film which provides the resultant film with high film thickness uniformity and whose productivity is superior to other coating processes such as vapor deposition processes.

### DISCLOSURE OF THE INVENTION

To accomplish the above described objects, the first aspect of the present invention is a process for producing an antireflection film comprising applying, using a slot die, a coating solution onto a transparent substrate which is backed up by a back-up roller and runs continuously to form at least one layer, on the transparent substrate, having a thickness of 200 nm or less in a dried state and having a refractive index lower than that of the transparent substrate, characterized in that the slot die has a first edge lip having a land length along a running direction of the transparent substrate of 30 to 100 μm in downstream of the running transparent substrate, and a space between a second edge lip of the slot die in upstream of the running transparent substrate and a surface of the transparent substrate is set to be 30 to 120 μum larger than a space between the first edge lip of the slot die in downstream of the running transparent substrate and a surface of the transparent substrate.

In other words, after directing tremendous research efforts toward the solution of the above described problems, the present inventor has found a novel process for producing an antireflection film in which a thin layer of coating with a thickness of 200 nm or less, such as a layer of coating for an antireflection film, can be produced stably and without causing film thickness non-uniformity by using a coating apparatus that includes a slot die having a devised shape.

The second aspect of the present invention is the process for producing an antireflection film according to the first aspect of the present invention, characterized in that the coating solution has a viscosity at the time of coating of 20.0 mPa·sec or less and the coating solution is applied onto the transparent substrate in an amount of 2.0 to 5.0 ml/m². Not only devising the shape of the slot die, but specifying the amount and viscosity of the coating solution applied to the transparent substrate makes it possible to obtain a satisfactory plane.

Specifically, the present invention is useful when the amount of the coating solution applied onto the transparent substrate is 20 ml/m² or less; however, to stably form a layer of coating with a thickness 200 nm or less, the amount of the coating solution applied to the transparent substrate needs to be 2 to 5 ml/m². And doing so makes it possible to obtain a satisfactory plane. If the amount of the coating solution is less than 2 ml/m², it is impossible to apply the coating solution onto the entire surface of the transparent substrate, whereas if the amount is more than 5 ml/m², non-uniformity occurs in the coating layer due to the disorder caused in the drying process.

The third aspect of the present invention is the process for producing an antireflection film according to the first or second aspect of the present invention, characterized in that substantially three layers with different refractive indices: an intermediate-refractive-index layer, a high-refractive-index layer, and a low-refractive-index layer are formed on the above described transparent substrate in this order. Forming such three layers on the transparent substrate makes it possible to produce a high-quality antireflection film.

The fourth aspect of the present invention is the process for producing an antireflection film according to the third aspect of the present invention, characterized in that in relation to a designed wavelength λ (=400 to 680 nm) for the antireflection film, the intermediate-refractive-index layer satisfies the following formula 1, the high-refractive-index layer satisfies the following formula 2, and the low-refractive-index layer satisfies the following formula 3:
(λ/4)×0.80<n1d1<(λ/4)×1.00 (Formula 1)
(λ/2)×0.75<n2d2<(λ/2)×0.95 (Formula 2)
(λ/4)×0.95<n3d3<(λ/4)×1.05 (Formula 3)
wherein, in the formula 1, n1 represents a refractive index of the intermediate-refractive-index layer and d1 represents a layer thickness (nm) of the intermediate-refractive-index layer; in the formula 2, n2 represents a refractive index of the high-refractive-index layer and d2 represents a layer thickness (nm) of the high-refractive-index layer; and in the formula 3, n3 represents a refractive index of the low-refractive-index layer and d3 represents a layer thickness (nm) of the low-refractive-index layer.

The fifth aspect of the present invention is the process for producing an antireflection film according to the fourth aspect of the present invention, characterized in that the intermediate-refractive-index layer has a refractive index n1 of 1.60 to 1.65, the high-refractive-index layer has a refractive index n2 of 1.85 to 1.95, and the low-refractive-index layer has a refractive index n3 of 1.35 to 1.45, as compared with the above described transparent substrate having a refractive index of 1.45 to 1.55.

The sixth aspect of the present invention is the process for producing an antireflection film according to any one of the first to fifth aspects of the present invention, characterized in that the layer having a refractive index lower than that of the above described transparent substrate or the low-refractive-index layer is composed of a thermoset and/or an ionizing radiation curable fluorine-containing resin.

The seventh aspect of the present invention is the process for producing an antireflection film according to any one of the third, fourth. and sixth aspects of the present invention, characterized in that the high-refractive-index layer comprises inorganic fine particles that contain titanium dioxide, as a main component, including at least one element selected from a group consisting of cobalt, aluminum and zirconium and has a refractive index of 1.55 to 2.40.

The eighth aspect of the present invention is the process for producing an antireflection film according to any one of the first to seventh aspects of the present invention, characterized in that the antireflection film includes at least one hard coat layer between the layer having a refractive index lower than that of the transparent substrate or the low-refractive-index layer and the transparent substrate. Providing such a hard coat layer makes it possible to produce a high-quality antireflection film.

The ninth aspect of the present invention is the process for producing an antireflection film according to any one of the first to eighth aspects of the present invention, characterized in that one or more layers constituting the antireflection film are continuously formed without being wound. Continuously forming such layers makes it possible to increase the productivity of the antireflection film.

The tenth aspect of the present invention is an antireflection film, characterized by comprising at least one layer obtained by the process described in any one of the first to ninth aspects of the present invention.

The eleventh aspect of the present invention is a process for producing a coating film by applying, using a slot die, a coating solution onto a continuously running web so that a resultant coating layer has a thickness of 200 nm or less in a dried state, characterized in that the slot die has a first edge lip having a land length along a running direction of the web of 30 μm to 100 μm in downstream of the running web, and the coating solution applied onto the web is dried using a drying equipment which performs drying while avoiding turbulence of air adjacent to a coated surface with a drier that has a casing surrounding the web right after the application and keeping concentration of a solvent vapor of the coated surface high under drying.

The twelfth aspect of the present invention is the process for producing a coating film according to the eleventh aspect of the present invention, characterized in that a condenser which condenses and recovers a solvent in the coating solution is provided on the coated surface side of a position through which the web runs within the above described drier.

The thirteenth aspect of the present invention is the process for producing a coating film according to the twelfth aspect of the present invention, characterized in that the condenser includes a cooling mechanism, thereby being able to control its temperature.

The fourteenth aspect of the present invention is a process for producing a coating film by applying, using a slot die, a coating solution onto a continuously running web so that a resultant coating layer has a thickness of 200 nm or less in a dried state, characterized in that the slot die has a first edge lip having a land length along a running direction of the web of 30 μm to 100 μm in downstream of the running web, and a surface of the coating film is dried using a drying equipment which performs drying while moving a gas along a surface of the coating film so that velocity of the gas relative to the running web is −0.1 m/sec to and 0.1 m/sec.

The fifteenth aspect of the present invention is a process for producing a coating film by applying, using a slot die, a coating solution onto a continuously running web so that a resultant coating layer has a thickness of 200 nm or less in a dried state, and drying the coating layer in a drying equipment, characterized in that the slot die has a first edge lip having a land length along a running direction of the web of 30 μm to 100 μm in downstream of the running web, and the drying equipment is designed to allow a gas of an organic solvent evaporating from the coating solution applied onto the web to escape to an exhaust chamber via holes in a rectifying member and exhaust the gas of the organic solvent having entered the exhaust chamber to an outside through an exhaust pipe, while the web is conveyed through the drying equipment.

The sixteenth aspect of the present invention is the process for producing a coating film according to any one of the eleventh to fifteenth aspects of the present invention, characterized in that a space between a second edge lip of the slot die in upstream of the running web and a surface of the web is set to be larger than a space between the first edge lip of the slot die in downstream of the web and the web.

The seventeenth aspect of the present invention is the process for producing a coating film according to the sixteenth aspect of the present invention, characterized in that the space between the second edge lip of the slot die in upstream of the continuously running web and the surface of the above described web is set to be 30 μm to 120 μm larger than the space between the first edge lip of the slot die in downstream of the web and the web.

The eighteenth aspect of the present invention is the process for producing a coating film according to any one of the eleventh to seventeenth aspects of the present invention, characterized in that the drying equipment has a total length such that it takes 2 seconds or longer to convey the above described coating film through the drying equipment and the solvent in the coating solution has an evaporation rate in the drying equipment of 0.3 g/(m²·sec) or higher.

The nineteenth aspect of the present invention is an antireflection film, characterized in that the antireflection film is produced by the process for producing a coating film according to any one of the eleventh to eighteenth aspects of the present invention.

The twentieth aspect of the present invention is an antireflection film, characterized in that the antireflection film comprises a coating film according to the nineteenth aspect of the present invention, and the coating film has at least one layer having a thickness of 200 nm or less in a dried state and having a refractive index lower than that of a transparent substrate as the web.

The twenty-first aspect of the present invention is a sheet polarizer, characterized in that the sheet polarizer comprises a polarizing film and any one of a coating film of the tenth aspect, a coating film of the twentieth aspect of the present invention and an antireflection film of the nineteenth aspect of the present invention applied onto at least one surface of the polarizing film.

The twenty-second aspect of the present invention is a sheet polarizer, characterized in that the sheet polarizer comprises a polarizing film, any one of a coating film of the tenth aspect, a coating film of the twentieth aspect of the present invention and an antireflection film of the nineteenth aspect of the present invention applied onto one surface of the polarizing film, and an anisotropic optical compensation film applied onto the other surface of the polarizing film.

The twenty-third aspect of the present invention is an image display device, characterized in that the image display device is constituted by at least one of a coating film of the tenth aspect, a coating film of the twentieth aspect of the present invention and an antireflection film of the nineteenth aspect of the present invention.

The twenty-fourth aspect of the present invention is an image display device, characterized in that the image display device is constituted by a sheet polarizer according to the twenty-first or twenty-second aspect of the present invention.

As described above, according to the present invention, a coating film and an antireflection film of high productivity and high quality can be provided.

### BRIEF DESCRIPTION OF THE DRAWINGS

FIG. 1 is a schematic cross-section showing the basic layer structure of an antireflection film in accordance with the present invention;

FIG. 2 is a schematic cross-section showing one example of layer structure of an antireflection film;

FIG. 3 is a schematic cross-section showing one example of layer structure of an antireflection film;

FIG. 4 is a schematic cross-section showing one example of layer structure of an antireflection film;

FIG. 5 is a schematic cross-section showing one example of layer structure of an antireflection film;

FIG. 6 is a schematic cross-section showing one example of layer structure of an antireflection film;

FIG. 7 is a schematic cross-section showing one example of layer structure of an antireflection film;

FIG. 8 is an explanatory drawing showing one example of construction of an apparatus that continuously performs film coating for each layer;

FIG. 9 is a cross-section of a coater employing a slot die;

FIGS. 10A and 10B are enlarged views showing the major part of a slot die;

FIG. 11 is a perspective view showing a slot die and its vicinities;

FIG. 12 is a cross-section showing the positional relationship between a vacuum chamber and a web;

FIG. 13 is a cross-section showing the positional relationship between a vacuum chamber and a web;

FIG. 14 is a schematic diagram showing an apparatus in accordance with another embodiment which is used in the process for producing a coating film of the present invention;

FIG. 15 is a schematic diagram showing an apparatus in accordance with another embodiment which is used in the process for producing a coating film of the present invention;

FIG. 16 is a plan view of the apparatus shown in FIG. 15;

FIG. 17 is a schematic diagram showing an apparatus in accordance with another embodiment which is used in the process for producing a coating film of the present invention;

FIG. 18 is a plan view of the apparatus shown in FIG. 17;

FIG. 19 is a cross-sectional view of the apparatus shown in FIG. 17;

FIGS. 20A and 20B are schematic diagrams showing an apparatus in accordance with another embodiment which is used in the process for producing a coating film of the present invention;

FIGS. 21A and 21B are schematic diagrams showing an apparatus in accordance with another embodiment which is used in the process for producing a coating film of the present invention;

FIGS. 22A and 22B are schematic diagrams showing an apparatus in accordance with another embodiment which is used in the process for producing a coating film of the present invention;

FIG. 23 is a schematic diagram showing the major part of an apparatus in accordance with another embodiment which is used in the process for producing a coating film of the present invention;

FIG. 24 is a schematic diagram showing the major part of an apparatus in accordance with another embodiment which is used in the process for producing a coating film of the present invention;

FIG. 25 is a schematic diagram showing the major part of an apparatus in accordance with another embodiment which is used in the process for producing a coating film of the present invention;

FIG. 26 is a table showing a result of the examples 3 to 6, and 7 to 10;

FIG. 27 is a table showing a result of the examples 1, and 11 to 15; and

FIG. 28 is a table showing a result of the examples 1, and 16 to 19.

### BEST MODE FOR CARRYING OUT THE INVENTION

In the following, the antireflection film, process for producing the antireflection film, sheet polarizer using the antireflection film, and image display device using the antireflection film and the sheet polarize of the present invention will be described in detail in terms of their preferred embodiments with reference to the accompanying drawings.

[Structure of Antireflection Film]

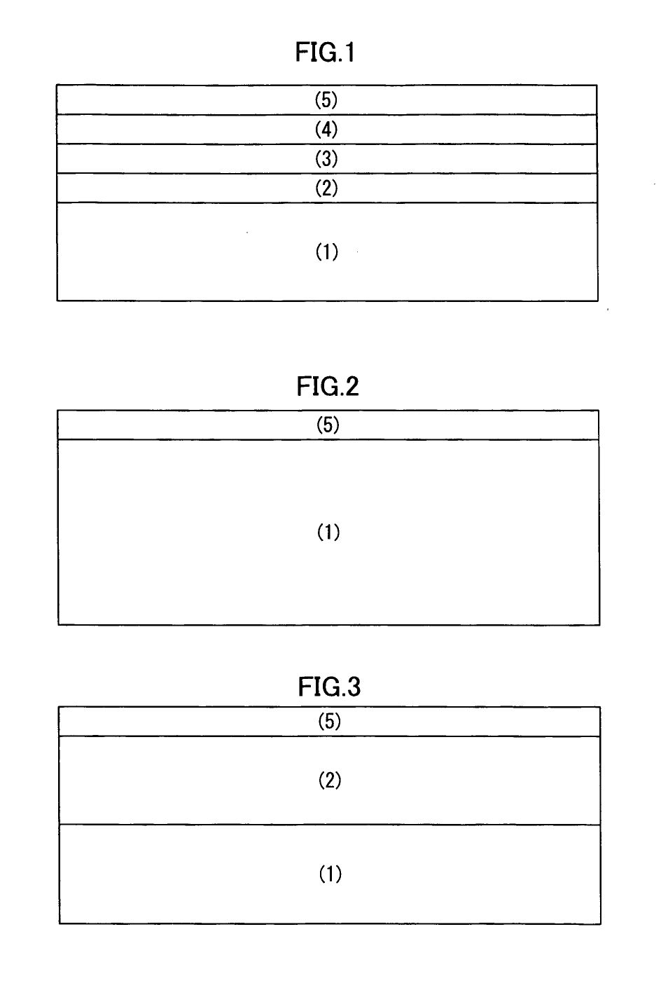

FIG. 1 is a schematic cross-section showing the basic layer structure of an antireflection film in accordance with the present invention. The antireflection film has a layer structure made up of a transparent substrate (1), a hard coat layer (2), an intermediate-refractive-index layer (3), a high-refractive-index layer (4) and a low-refractive-index layer (5) in this order.

Japanese Patent Application Laid-open No. 59-50401 states that in the antireflection film having a 5-layer structure as above, the optical film thickness—that is, the product of the refractive index and the film thickness of each of the intermediate-refractive-index layer (3), the high-refractive-index layer (4) and the low-refractive-index layer (5) in relation to the designed wavelength λ is preferably about λ/4 or a multiple of the same.

However, to realize the reflectance characteristics, in accordance with the present invention, of low reflectance and decreased color tone of reflected light, the intermediate-refractive-index layer (3), the high-refractive-index layer (4) and the low-refractive-index layer (5) need to satisfy the following formulae 1, 2 and 3, respectively, in relation to the designed wavelength λ (=400 to 680 nm). The designed wavelength λ is preferably 400 to 600 nm, more preferably 450 to 550 nm and most preferably 475 to 525 nm.

[Numerical Formula 1]
(λ/4)×0.80<n1d1<(λ/4)×1.00 (Formula 1)
[Numerical Formula 2]
(λ/2)×0.75<n2d2<(λ/2)×0.95 (Formula 2)
[Numerical Formula 3]
(λ/4)×0.95<n3d3<(λ/4)×1.05 (Formula 3)
In the above formulae, n1 represents the refractive index of the intermediate-refractive-index layer (3) and d1 the layer thickness (nm) of the same, n2 represents the refractive index of the high-refractive-index layer (4) and d2 the layer thickness (nm) of the same, and n3 represents the refractive index of the low-refractive-index layer (5) and d3 the layer thickness (nm) of the same.

Further, to a transparent substrate with refractive index 1.45 to 1.55 which is composed of, for example, triacetylcellulose (refractive index: 1.49), the refractive indices n1, n2 and n3 need to be 1.60 to 1.65, 1.85 to 1.95 and 1.35 to 1.45, respectively. And to a transparent substrate with refractive index 1.55 to 1.65 which is composed of, for example, polyethylene terephthalate (refractive index: 1.66), the refractive indices n1, n2 and n3 need to be 1.65 to 1.75, 1.85 to 2.05 and 1.35 to 1.45, respectively.

It is known in the art that when a material for the intermediate-refractive-index layer (3) or the high-refractive-index layer (4) having the refractive index as described above cannot be selected, a layer that is optically equivalent to the intermediate-refractive-index layer (3) or the high-refractive-index layer (4) and has a substantially set refractive index can be formed using the principle of an equivalent film which is formed by combining more than one layer: layers with a refractive index higher than that of the set one and layers with a refractive index lower than that of the set one. Such equivalent films can be used to realize the reflectance characteristics in accordance with the present invention.

In the present invention, “substantially three layers” also include an antireflection layer which uses such equivalent films and is made up of 4 or 5 layers with different refractive indices.

A film made by laminating a low-refractive-index layer (5), as a refractive-index layer, on a transparent substrate (1) or on a transparent substrate (1) with a hard coat layer (2) applied thereto can be suitably used as an antireflection film.

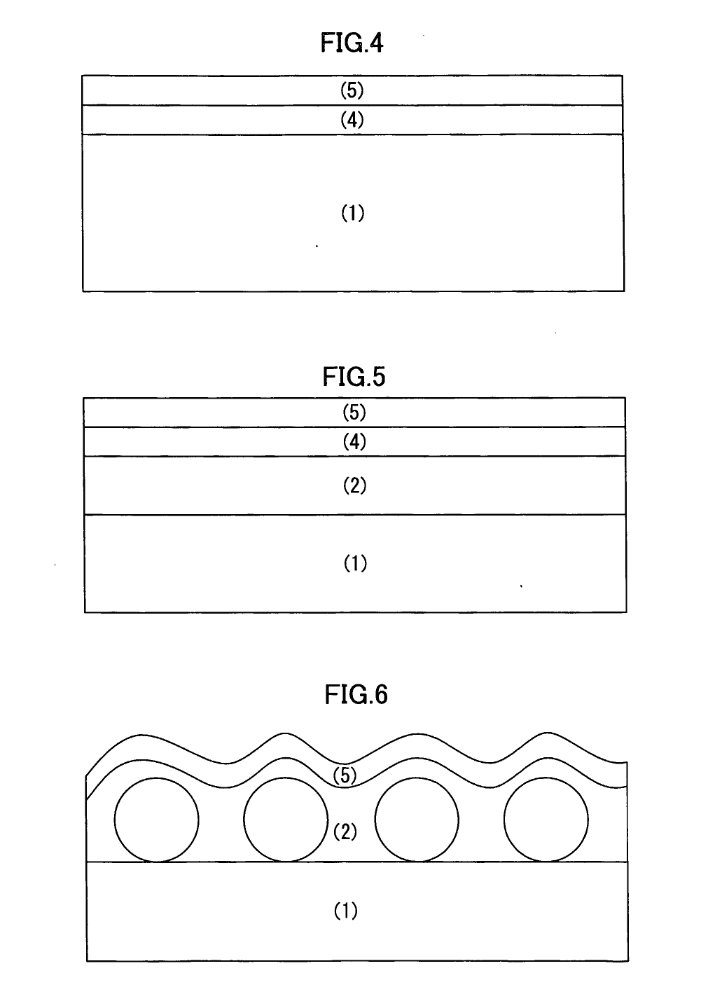

As shown in FIGS. 2 to 7, films made by laminating a high-refractive-index layer (4) and/or a low-refractive-index layer (5) on a transparent substrate (1) or on a transparent substrate with a hard coat layer (2) applied thereto can also be used as antireflection films.

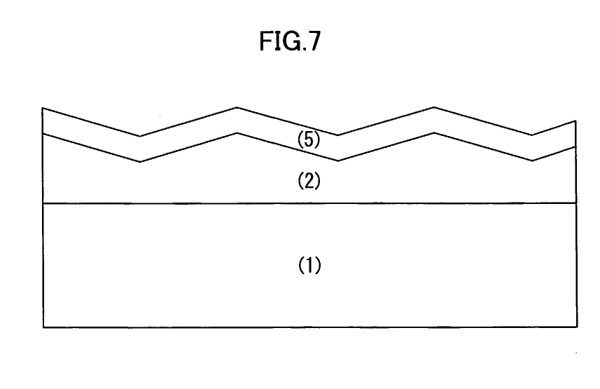

The hard coat layer (2) may have anti-glare properties. The anti-glare properties may be provided by dispersing mat particles in the layer, as shown in FIG. 6, or by shaping the layer surface by embossing etc., as shown in FIG. 7.

[Description of Materials for Respective Layers]

<Substrate Film>

The transparent substrate described below can be used as a substrate film used in the antireflection film of the present invention. A substrate film is sometimes referred to as web. As the transparent substrate (1), preferably a plastic film is used. Examples of materials for such plastic films include: cellulose esters (e.g. triacetylcellulose, diacetylcellulose, propionylcellulose, butylylcellulose, acetylpropionylcellulose, nitrocellulose); polyamide; polycarbonate; polyesters (e.g. polyethylene terephthalate, polyethylene naphthalate, poly-1,4-cyclohexanedimethylene terephthalate, polyethylene-1,2-diphenoxyethane-4,4′-dicarboxylate, polybutylene terephthalate); polystyrene (e.g. syndiotactic polystyrene); polyolefins (e.g. polypropylene, polyethylene, polymethylpentene); polysulfone; polyethersulfone; polyarylate; polyetherimide; polymethyl methacrylate; and polyetherketone.

When using an antireflection film of the present invention as one side of the surface protective film of a sheet polarizer, which is to be used in a liquid crystal display device, organic EL display device or the like, triacetylcellulose is preferably used. As a triacetylcellulose film, known films such as TAC-TD80U (Fuji Photo Film Co., Ltd.) or films disclosed in Journal of Technical Disclosure No. 2001-1745 are preferably used.

When using an antireflection film of the present invention as a laminating film for a glass substrate etc., which is to be used in flat CRT or PDP, polyethylene terephthalate or polyethylene naohthalate is preferably used.

The light transmittance of the transparent substrate (1) is preferably 80% or more and more preferably 86% or more. The haze of the transparent substrate (1) is preferably 2.0% or less and more preferably 1.0% or less. The refractive index of the transparent substrate (1) is preferably 1.4 to 1.7.

The thickness of the transparent substrate (1) of the present invention is preferably, not limited to, 30 to 150 μm, more preferably 40 to 130 μm and much more preferably 70 to 120 μm.

[Hard Coat Layer]

The hard coat layer (2) is provided on the surface of the transparent substrate (1) so as to provide the antireflection film with physical strength (sometimes referred to as resistance to scuffing). Particularly preferably the hard coat layer (2) is provided between the transparent substrate (1) and the high-refractive-index layer (4).

Preferably the hard coat layer (2) is formed by the crosslinking reaction or polymerization reaction of a photocurable and/or a thermoset compound. For example, it can be formed by applying onto the transparent substrate (1) a coating composition that includes polyester (meth)acrylate, polyurethane (meth)acrylate, a polyfunctional monomer or oligomer, or an organometallic compound containing a hydrolysable functional group and subjecting the curable compound to crosslinking reaction or polymerization reaction.

As a curable functional group, a photopolymerizable functional group is preferable. And as an organometallic compound containing a hydrolysable functional group, an organic alkoxysilyl compound is preferable. Concrete examples of such compounds include the same ones as the matrix binders for the high-refractive-index layer (4) described later.

In a further preferable embodiment, polymerizable compounds which are cured by radical polymerization reaction and cationic polymerization reaction are used. Such polymerizable compounds may contain both a radically polymerizable group and a cationically polymerizable group in a molecule or may be mixtures of polymerizable compounds in which a radically polymerizable group and a cationically polymerizable group are contained in different molecules.

In a multi-layer antireflection film which is composed of a curable film formed from a curable composition which contains mainly the above described polymerizable compounds, shaping of the surface by embossing can be performed uniformly and stably. This is probably because the thermoelastic deformation of the hard coat layer (2) properly acts during embossing.

Concrete examples of preferred curable compositions include: curable compositions which contain both a crosslinkable polymer having a repeating unit represented by the following chemical formula 1 and a compound containing two or more ethylenic unsaturated groups per molecule and are cured by polymerizing the ring-opening polymerizable group in the crosslinkable polymer and the ethylenic unsaturated group.

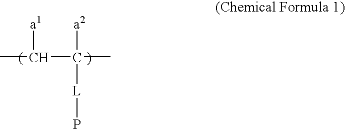

In the chemical formula 1, a¹ and a², the same or different, independently represent a hydrogen atom, an aliphatic group, —COOR₁, or —CH₂COOR₁; R₁ a hydrocarbon group; P a monovalent group including a ring-opening polymerizable group or an ethylenic unsaturated group; and L a single bond or a divalent linkage group.

Crosslinkable polymers that include a repeating unit represented by the chemical formula 1 will be described in detail. In the chemical formula 1, a¹ and a² independently represent a hydrogen atom, an aliphatic group, preferably an alkyl group with 1 to 4 carbon atoms, —COOR₁, or —CH₂COOR₁. R₁ represents a hydrocarbon group, preferably an alkyl group with 1 to 4 carbon atoms, and more preferably a hydrogen atom or a methyl group.

L represents a single bond or a divalent linkage group, preferably a single bond, —O—, an alkylene group, an arylene group, *—COO—, *—CONH—, *—OCO— or *—NHCO— (* means that the group is linked to the backbone chain on the side marked with *).

P represents a monovalent group including a ring-opening polymerizable group or an ethylenic unsaturated group. The monovalent group including a ring-opening polymerizable group is a monovalent group having a ring structure in which ring-opening polymerization progresses by the action of cations, anions or radicals. Among these, cationic ring-opening polymerization of heterocyclic compounds is particularly preferable.

Examples of preferable monovalent groups including a ring-opening polymerizable group are: a vinyloxy group; and monovalent groups containing an iminoether ring such as an epoxy, oxetane, tetrahydrofuran, lactone, carbonate or oxazoline ring. Of these groups, particularly preferable are monovalent groups containing an epoxy, oxetane or oxazoline ring, and most preferable is monovalent groups containing an epoxy ring.

When P represents an ethylenic unsaturated group, examples of preferable ethylenic unsaturated groups include: acryloy, methacroyl, styryl and vinyloxycarbonyl groups.

The crosslinkable polymers including a repeating unit represented by chemical formula 1, which is used in the present invention, are synthesized preferable by the process for polymerizing the corresponding monomers, because such a process is easy and simple. In this case, radical polymerization reaction is preferably employed because it is most simply and easily performed.

In the following, concrete examples of preferable repeating units represented by chemical formula 1 are shown as chemical formulae 2. It is, however, to be understood that these are shown for illustrative purpose only and not intended to limit the present invention.

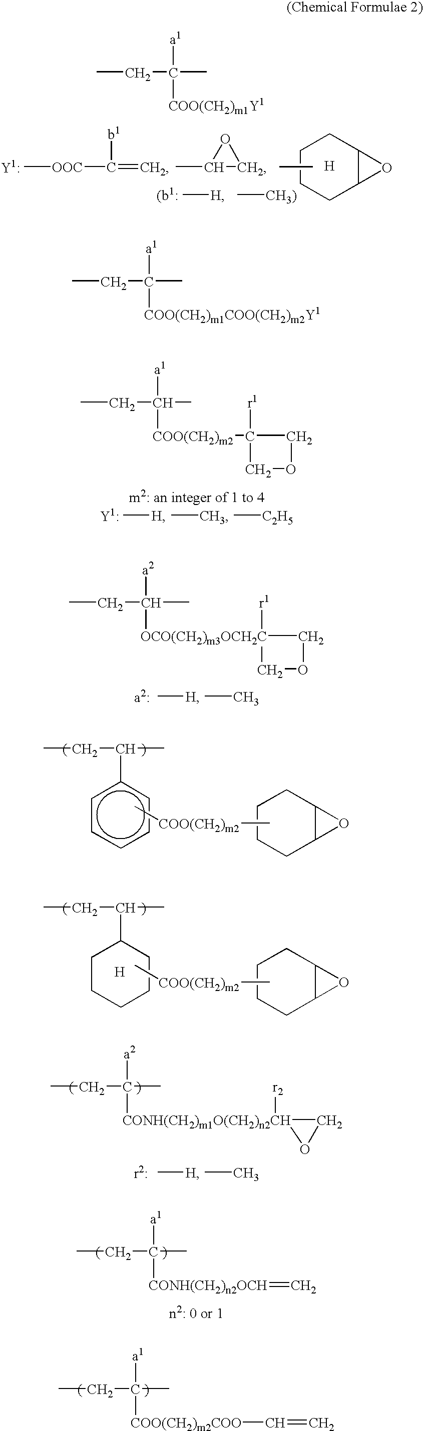

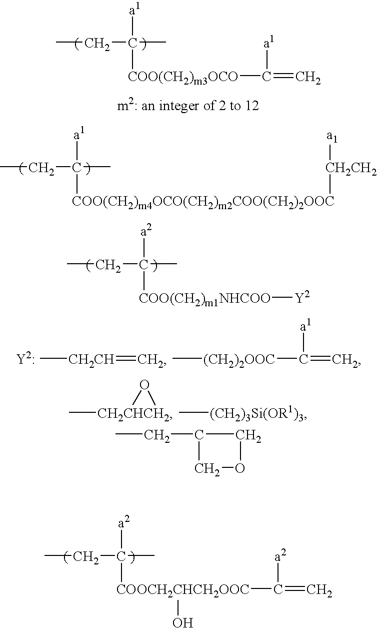

Examples of repeating units represented by chemical formula 1, which are more preferably used in the present invention, are repeating units derived from methacrylate or acrylate having an epoxy ring. Of these repeating units, particularly preferable examples are E-1 and E-3 derived from glycidyl methacrylate or glycidyl acrylate.

The crosslinkable polymers including a repeating unit represented by chemical formula 1, which are used in the present invention, may be copolymers made up of more than one kind of repeating units represented by chemical formula 1. Selecting the copolymers of E-1 or E-3, of these copolymers, enables effective decrease of shrinkage in curing.

The crosslinkable polymers including a repeating unit represented by chemical formula 1, which are used in the present invention, may be copolymers including a repeating unit other than that represented by chemical formula 1. Particularly when intending to control the Tg or the hydrophilic or hydrophobic nature of the crosslinkable polymer, or when intending to control the amount of the ring-opening polymerizable group contained in the crosslinkable polymer, the crosslinkable polymers can be copolymers including a repeating unit other than that represented by chemical formula 1. To introduce a repeating unit other than that represented by chemical formula 1, preferably a technique is used in which the corresponding monomer is copolymerized.

Monomers preferably used, when intending to introduce a repeating unit other than that represented by chemical formula 1 by copolymerizing the corresponding vinyl monomer, include: for example, esters or amides derived from acrylic acid or α-alkylacrylic acid (e.g. methacrylic acid) (e.g. N-i-propylacrylamide, N-n-butylacrylamide, N-t-butylacrylamide, N,N-dmethylacrylamide, N-methylmethacrylamide, acrylamide, 2-acrylamide-2-methylpropanesulfonic acid, acrylamidepropyltrimethylammonium chloride, methacrylamide, diacetoneacrylamide, acryloylmorpholine, N-methylolacryloamide, N-methylolmethacryloamide, alkyl ester (meth)acrylate (alkyl groups include: for example, methyl, ethyl, propyl, butyl, pentyl, hexyl, octyl, decyl, dodecyl, hexadecyl and octadecyl groups), 2-hydroxyethyl(meth)acrylate, 2-hydroxypropyl(meth)acrylate, 2-methyl-2-nitropropyl(meth)acrylate, 2-methoxyethyl(meth)acrylate, 2-ethoxyethyl(meth)acrylate, 2-methoxymethoxyethyl(meth)acrylate, 2,2,2-trifluoroethyl(meth)acrylate, 3-methoxybutyl(meth)acrylate, ethyl carbitol (meth)acrylate, phenoxyethyl(meth)acrylate, octafluoropentyl(meth)acrylate, cyclohexyl(meth)acrylate, cyclopentyl(meth)acrylate, 2-isobornyl(meth)acrylate, 2-norbornylmethyl(meth)acrylate, 5-norbornene-2-ylmethyl(meth)acrylate, 3-methyl-2-norbornylmethyl(meth)acrylate, benzyl(meth)acrylate, phenethyl(meth)acrylate, heptadecafluorodecyl(meth)acrylate, dimethylaminoethyl(meth)acrylate); acrylic acid or α-alkylacrylic acid (e.g. acrylic acid, methacrylic acid, itaconic acid); vinyl esters (e.g. vinyl acetate); esters derived from maleic acid or fumaric acid (e.g. dimethyl maleate, dibutyl maleate, diethyl fumarate); maleimides (e.g. N-phenylmaleimide); maleic acid; fumaric acid; sodium salt of p-styrenesulfonic acid; acrylonitrile; methacrylonitrile; dienes (e.g. butadiene, cyclopentadiene, isopurene); aromatic vinyl compounds (e.g. styrene, p-chlorostyrene, t-butylstyrene, α-methylstyrene, sodium styrenesulfonate); N-vinylpyrrolidone; N-vinyloxazolidone; N-vinylsuccinimide; N-vinylformamide; N-vinyl-N-methlformamide; N-vinylacetamide; N-vinyl-N-methylacetoamide; 1-vinylimidazole; 4-vinylpyridine; vinylsulfonic acid; sodium vinylsulfonate; sodium allylsulfonate; sodium methallylsulfonate; vinylidene chloride; vinyl alkyl ethers (e.g. methyl vinyl ether); ethylene; propylene; 1-butene; and isobutene.

These vinyl monomers may be used in combination of two or more. Besides these vinyl monomers, those described in Research Disclosure (No. 19551, July, 1980) can also be used.

Vinyl monomers particularly preferably used in the present invention are esters derived from acrylic acid or methacrylic acid, amides, and aromatic vinyl compounds.

A repeating unit having a reactive group other than a ring-opening polymerizable group or ethylenic unsaturated group can also be introduced as a repeating unit other than that represented by chemical formula 1. A technique for using, as a crosslinkable polymer, a copolymer including a reactive group other than a ring-opening polymerizable group is suitably used particularly when intending to enhance the hardness of the hard coat layer (2) or when intending to improve the adhesion between the substrate or the hard coat layer and another functional layer to be used on the substrate or the hard coat layer. A repeating unit having a reactive group other than a ring-opening polymerizable group is introduced preferably by the process for copolymerizing the corresponding vinyl monomer (hereinafter referred to as “reactive monomer”), because such a process is easy and simple.

Concrete examples of preferred reactive monomers are shown below; however, it is to be understood that those examples are shown for illustrative purpose only and not intended to limit the present invention.

<Concrete Examples of Preferred Reactive Monomers>

Concrete examples of preferred reactive monomers include: hydroxyl group-containing vinyl monomers (e.g. hydroxyethyl acrylate, hydroxyethyl methacrylate, allylalcohol, hydroxypropyl acrylate, hydroxypropyl methacrylate); isocyanate group-containing vinyl monomers (e.g. isocyanatoethyl acrylate, isocyanatoethyl methacrylate); N-methylol group-containing vinyl monomers (e.g. N-methylol acrylamide, N-methylol methacrylamide); carboxyl group-containing vinyl monomers (e.g. acrylic acid, methacrylic acid, itaconic acid, carboxyethyl acrylate, vinyl benzoate); alkylhalide-containing vinyl monomers (e.g. chloromethyl styrene, 2-hydroxy-3-chloropropyl methacrylate); acid anhydride-containing vinyl monomers (e.g. maleic anhydride); formyl group-containing vinyl monomers (e.g. acrolein, methacrolein); sulfinic acid-containing vinyl monomers (e.g. potassium styrenesulfinate); active methylene containing vinyl monomers (e.g. acetoacetoxyethyl methacrylate); amino group-containing monomers (e.g. allylamine); and alkoxysilyl group-containing monomers (e.g. methacryloyloxypropyltrimethoxysilane, acryloyloxypropyltrimethoxysilane).

In the crosslinkable polymer including the repeating unit represented by chemical formula 1, which is used in the present invention, the percentage of the repeating unit is 30% by mass to 100% by mass, preferably 50% by mass to 100% by mass, and particularly preferably 70% by mass to and 100% by mass.

When the repeating unit other than that represented by chemical formula 1 does not have a crosslinkably reactive group, if the amount of the repeating unit is too much, the hardness of the hard coat layer is lowered. When the repeating unit other than that represented by chemical formula 1 does have a crosslinkably reactive group, though the hardness of the hard coat layer can sometimes be maintain, the shrinkage on curing can sometimes become large or the brittleness can sometimes deteriorate.

Particularly when the crosslinking reaction accompanies decrease in molecular weight, such as dehydration or dealcoholation, just like the case where a copolymer of an alkoxysilyl group-containing monomer (e.g. methacryloyloxypropyl trimethoxysilane) and a repeating unit represented by chemical formula 1 is used, shrinkage on curing tends to be large.

When introducing a repeating unit that has a crosslinkably reactive group, with which crosslinking reaction progresses accompanying decrease in molecular weight, into the crosslinkable polymer including a repeating unit represented by chemical formula 1, which is used in the present invention, the percentage of the repeating unit represented by chemical formula 1 in the crosslinkable polymer is preferably 70% by mass to 99% by mass, more preferably 80% by mass to 99% by mass, and particularly preferably 90% by mass to 99% by mass.

The preferred molecular weight range of the crosslinkable polymer that includes a repeating unit represented by chemical formula 1 is 1000 to 1000000, more preferably 3000 to 200000 and most preferably 5000 to 100000, on the basis of mass average molecular weight. The above described mass average molecular weight values are those determined by GPC in terms of polystyrene.

Compounds which contain 2 or more ethylenic unsaturated groups per molecule and can be used in the present invention will be described. Examples of preferable ethylenic unsaturated groups include: acryloyl, methacryloyl, styryl and vinyl ether groups. Of these ethylenic unsaturated groups, particularly preferable ones are methacryloyl and acryloyl groups and most preferable one is an acryloyl group Although compounds containing 2 or more ethylenic unsaturated groups can be used in the present invention, compounds containing 3 or more ethylenic unsaturated groups can be more preferably used. Of such compounds, compounds having acryloyl groups are preferable, and compounds having 2 to 6 acrylic ester groups per molecule, referred to as polyfunctional acrylate monomer, and oligomers having several acrylic ester groups per molecule and a molecular weight of several hundreds to several thousands, referred to as urethane acrylate, polyester acrylate or epoxyacrylate, are preferably used. Concrete examples of such compounds are the same as polyfunctional monomers used for the high-refractive-index layer (4) described later.

Preferably, these polymerizable compounds are used with a polymerization initiator, and concrete examples of such initiators are the same as those used for the high-refractive-index layer (4) described later.

Preferably, the hard coat layer (2) contains inorganic fine particles whose primary particles have average particle size of 300 nm or less. The average particle size of the primary particles is more preferably 10 to 150 nm and much more preferably 20 to 100 nm. The term “average particle size” herein used means the mass average size. Keeping the average particle size of the primary particles 200 nm or less makes it possible to form a hard coat layer (2) whose transparency is well maintained.

Inorganic fine particles contribute to increasing the hardness of the hard coat layer (2), and besides, they have the function of inhibiting the shrinkage on curing of the coating layer. They are also added to control the refractive index of the hard coat layer (2).

Concrete examples of compositions of the hard coat layer (2) include those described in Japanese Patent Application Laid-open Nos. 2002-144913 and 2000-9908 and WO 0/46617.

The content of inorganic fine particles in the hard coat layer (2) is preferably 10 to 90% by mass and more preferably 15 to 80% by mass with respect to the total mass of the hard coat layer (2).

The high-refractive-index layer (4) can also serve as the hard coat layer (2). When the high-refractive-index layer (4) also serves as the hard coat layer (2), preferably the hard coat layer (2) is formed in such a manner as to contain inorganic fine particles which are finely dispersed by the technique used for the high-refractive-index layer (4) described later.

The film thickness of the hard coat layer (2) can be properly designed depending on its application. The film thickness of the hard coat layer (2) is preferably 0.2 to 15 μm, more preferably 0.5 to 12 μm and particularly preferably 0.7 to 10 μm.

The strength of the hard coat layer (2) is preferably H or higher, more preferably 2H or higher and most preferably 3H or higher, on the basis of the pencil hardness test in accordance with JIS K5400.

Further, when evaluating the strength of the hard coat layer (2) on the basis of Taber abrasion test in accordance with JIS (Japanese Industrial Standards) K5400, the smaller the abrasion in the test piece is, the more preferable the hard coat layer (2) is.

[High-Refractive-Index Layer]

The high-refractive-index layer (4) of the present invention is typically composed of a curable film with a refractive index of 1.55 to 2.40 which is produced by coating a curable composition containing at least inorganic fine particles with a high refractive index and a matrix binder. The above described refractive index of inorganic fine particles is preferably 1.65 to 2.30 and more preferably 1.80 to 2.00. The high-refractive-index layer (4) of the present invention has a refractive index of 1.55 to 2.40. Layers having a refractive index in such a range are what are called high-refractive-index layers or intermediate-refractive-index layers; however, hereinafter the layer is sometimes generically called high-refractive-index layer.

[Composition for High-Refractive-Index Layer]

[Particles with High Refractive Index]

The inorganic fine particles with a high refractive index that are contained in the high-refractive-index layer (4) of the present invention are preferably such that their refractive index is 1.80 to 2.80 and their primary particles have an average particle size of 3 to 150 nm. Particles having a refractive index less than 1.80 are less effective in increasing the refractive index of the coating, whereas those having a refractive index of more than 2.80 are colored; thus, particles outside the above range are not preferable. Particles whose primary particles have an average particle size of more than 150 nm increases the haze of the formed coating film and impairs the transparency of the same, and hence not preferable, whereas particles whose primary particles have an average particle size of less than 3 nm make it hard to maintain the high refractive index of the formed film.

The inorganic particles more preferably used in the present invention are such that their refractive index is 1.90 to 2.80 and their primary particles have an average particle size of 3 to 100 nm and much more preferably their refractive index is 1.90 to 2.80 and their primary particles have an average particle size of 5 to 80 nm.

Concrete examples of preferable inorganic fine particles with a high refractive index include: particles containing, as a main component, an oxide, complex oxide or sulfide of, for example, Ti, Zr, Ta, In, Nd, Sn, Sb, Zn, La, W, Ce, Nb, V, Sm or Y. The term “main component” herein used means the ingredient whose content (% by mass) is higher than that of any other ingredients that constitute the particles.

The inorganic fine particles preferably used in the present invention are those containing, as a main component, an oxide or complex oxide of at least one metal element selected from the group consisting of Ti, Zr, Ta, In and Sn. The inorganic fine particles used in the present invention may contain various elements.

Examples of various elements which may be contained in the inorganic fine particles used in the present invention include: Li, Si, Al, B, Ba, Co, Fe, Hg, Ag, Pt, Au, Cr, Bi, P and S. In the particles containing tin oxide or indium oxide as a main component, to enhance the electrical conductivity, it is preferable that they contain elements of Sb, Nb, P, B, In, V or halogen. It is particularly preferable that they contain about 5 to 20% by mass of antimony oxide.

Particularly preferable inorganic fine particles include: those containing titanium dioxide, as a main component, as well as at least one element selected from the group consisting of Co, Zr and Al (hereinafter sometimes referred to as “specific oxide”). Of the elements, Co, Zr and Al, particularly preferable one is Co.

The total content of Co, Al and Zr is preferably 0.05 to 30% by mass of the Ti content, more preferably 0.1 to 10% by mass, much more preferably 0.2 to 7% by mass, particularly preferably 0.3 to 5% by mass, and most preferably 0.5 to 3% by mass The elements, Co, Al or Zr, exist in the inside or on the surface of the inorganic fine particles that contain titanium dioxide as a main component. They exist preferably in the inside of the inorganic fine particles which contain titanium dioxide as a main component and most preferably both in the inside and on the surface of the inorganic fine particles. These specified metal elements may exist in the form of an oxide.

Other preferable inorganic fine particles include: those composed of complex oxide particles of titanium element and at least one metal element selected from the metal elements whose oxides have a refractive index of 1.95 or more (hereinafter these metal elements are sometimes referred to simply as “Met”), the complex oxide having at least one kind of metal ion selected from the group consisting of Co, Zr and Al ions doped thereinto (hereinafter these inorganic fine particles are sometimes referred to as “specific complex oxide”).

Examples of preferable metal elements of the metal oxide whose oxides have a refractive index of 1.95 or more include: Ta, Zr, In, Nd, Sb, Sn and Bi. Particularly preferable ones are Ta, Zr, Sn and Bi. The amount of the metal ions doped into the above described complex oxide is, from the viewpoint of maintaining the refractive index of the complex oxide, preferably within the range of 25% by mass or less of the total amount of the metals [Ti+Met] that constitute the complex oxide. The amount is more preferably 0.05 to 10% by mass, much more preferably 0.1 to 5% by mass, and most preferably 0.3 to 3% by mass.

The metal ions having been doped into the complex oxide may exist in the form of metal ions or metal atoms and appropriately exist on the surface of or in the inside of the complex oxide. Preferably they exist both on the surface of and in the inside of the complex oxide.

Preferably the inorganic fine particles used in the present invention have a crystal structure or an amorphous structure. Preferably, the crystal structure contains rutile, rutile/anatase mixed crystal, or anatase as a chief component. Particularly preferably it contains the rutile structure as a chief component. The use of inorganic fine particles having a crystal structure whose chief component is the rutile structure enables the inorganic fine particles of a specific oxide or specific complex oxide of the present invention to have a refractive index of 1.90 to 2.80, preferably 2.10 to 2.80 and more preferably 2.20 to 2.80. Further, it makes it possible to inhibit the photocatalytic activity of titanium dioxide, thereby enabling the weathering resistance of the high-refractive-index layer (4) of the present invention to be significantly improved.

To dope the above described specific metal elements or metal ions, any traditionally known methods can be used. For example, such doping can be performed in accordance with the methods described in Japanese Patent Application Laid-open Nos. 5-330825 and 11-263620, Japanese National Publication of International Patent Application No. 11-512336, and European Patent No. 0335773, the ion implanting methods (e.g. Syunichi Gonda, Jyunzo Ishikawa, Eiji Kamijyo (eds): “Ion Beam Application Technology” CMC Publishing Co., LTD., 1989, Yasushi Aoki, Hyomen Kagaku, Vol. 18, (5), p. 262, 1998. Shoichi Anpo, et al., Hyomen Kagaku, Vol. 20 (2), p. 60, 1999), etc.

The inorganic fine particles used in the present invention may undergo surface treatment. In surface treatment, the surface of the inorganic fine particles is modified and the wettability of the surface is controlled using an inorganic compound and/or an organic compound, whereby the fine particle formation in an organic solvent or their dispersibility or dispersion stability in the composition for forming a high-refractive-index layer can be improved.

Inorganic compounds which can be physically or chemically adsorbed on the particle surface and modify the same include: for example, inorganic.compounds containing silicon (e.g. SiO₂), inorganic compounds containing aluminum (e.g. Al₂O₃, Al(OH)₃), inorganic compounds containing cobalt (e.g. CoO₂, Co₂O₃, Co₃O₄), inorganic compounds containing zirconium (e.g. ZrO₂, Zr(OH)₄), and inorganic compounds containing iron (e.g. Fe₂O₃).

Examples of organic compounds which can be used for surface treatment include: traditionally known surface modifiers for inorganic fillers such as metal oxides and inorganic pigments. Such surface modifiers are described in, for example, Stabilization of Pigment Dispersion and Surface Treatment Technology/Evaluation, 1^{st} Chapter, (TECHNICAL INFORMATION INSTITUTE Co., LTD., 2001).

Concrete examples include organic compounds having a polar group that has an affinity for the surface of the above described inorganic particles. Such organic compounds include compounds referred to as coupling compound. Polar groups having an affinity for the surface of the above described inorganic particles include: for example, carboxyl, phosphono, hydroxyl, mercapto, cyclic acid anhydride and amino groups. Organic compounds having at least one kind of polar group per molecule are preferably used.

Examples of such organic compounds include: long-chain aliphatic carboxylic acids (e.g. stearic acid, lauric acid, oleic acid, linoleic acid, linolenic acid); polyol compounds (e.g. pentaerythritol triacrylate, dipentaerythritol pentaacrylate, ECH (epichlorohydrin)-modified glycelol triacrylate); phosphono group-containing compounds (e.g. EO (ethylene oxide)-modified phosphoric acid triacrylate); and alkanolamines (e.g. ethylene diamine with EO added (5 mol)).

Coupling compounds include traditionally known organometallic compounds such as silane coupling agents, titanate coupling agents and aluminate coupling agents. Of these coupling compounds, silane coupling agents are most preferable. Concrete examples of silane coupling agents include, for example, compounds described in Japanese Patent Application Laid-open Nos. 2002-9908 and 2001-310423, columns 0011 to 0015.

Two or more kinds of these types of surface treatment can be used in combination.

As oxide fine particles used in the present invention, those having a core/shell structure, where the core is the oxide fine particles themselves and the shell is composed of inorganic compounds, are preferably used. Preferably, the shell is composed of oxides of at least one element selected from the group consisting of Al, Si and Zr. Concrete examples of such particles include those described in Japanese Patent Application Laid-open No. 2001-166104.

The shape of the inorganic fine particles used in the present invention is not limited to any specific one; however, rice grain-shaped, spherical, cubic, spindle-shaped or indefinite shaped ones are preferable. In the inorganic fine particles of the present invention, either one kind of particles alone or two or more kinds of particles together can be used.

(Dispersant)

To use the inorganic fine particles used in the present invention as stable specified ultra-fine particles, it is preferable to use a dispersant together with the fine particles. Preferably, dispersants used are low molecular-weight or high molecular-weight compounds that contain a polar group having an affinity for the surface of the inorganic fine particles.

Examples of such polar groups include: hydroxyl, mercapto, carboxyl, sulfo, phosphono, oxyphosphono, —P(═O)(R₁)(OH), —O—P(═O)(R₁)(OH), amide (—CONHR₂, —SO₂NHR₂), cyclic acid anhydride-containing, amino, and quaternary ammonium groups.

In the above formula, R₁ represents a hydrocarbon group with 1 to 18 carbon atoms (e.g. a methyl, ethyl, propyl, butyl, hexyl, octyl, decyl, dodecyl, octadecyl, chloroethyl, methoxyethyl, cyanoethyl, benzyl, methylbenzyl, phenethyl or cyclohexyl group). R₂ represents a hydrogen atom or the same group represented by R₁ described above.

In the above described polar groups, groups having a dissociated proton may be in the form of their salt. And the above described amino group and quaternary ammonium group may be any one of primary amino group, secondary amino group and tertiary amino group. Preferably they are independently a tertiary amino group or a quaternary ammonium group.

Groups binding to the nitrogen atom of the secondary amino, tertiary amino or quaternary ammonium group are preferably aliphatic groups with 1 to 12 carbon atoms (e.g. the same groups as the above described R₁ group).

The tertiary amino group may be an amino group which forms a ring containing a nitrogen atom (e.g. a piperidine, morpholine, piperazine or pyridine ring) and the quaternary ammonium group may be a quaternary ammonium group of these cyclic amino groups. Groups binding to the nitrogen atom of the. secondary amino, tertiary amino or quaternary ammonium group are more preferably alkyl groups with 1 to 6 carbon atoms.

The polar groups of the dispersants applicable to the present invention are preferably anionic groups with a pKa value of 7 or less or the salt of the dissociated groups of such anionic groups. Particularly preferable are carboxyl, sulfo, phosphono and oxyphosphono groups, or the salts of the dissociated groups thereof.

Preferably, the dispersants further contain a crosslinkable or polymerizable functional group. Examples of such crosslinkable or polymerizable functional groups include: ethylenic unsaturated groups capable of undergoing addition reaction/polymerization reaction by radical species (e.g. (meth)acryloyl, allyl, styryl, vinyloxy, carbonyl and vinyloxy groups); cationically polymerizable groups (e.g. epoxy, thioepoxy, oxetanyl, vinyloxy and spiroorthoester groups); and condensation-polymerizable groups (e.g. hydrolysable silyl and N-methylol groups). Preferable are ethylenic unsaturated groups, epoxy groups, and hydrolysable silyl group.

Concrete examples of such dispersants include compounds described in Japanese Patent Application Laid-open No. 11-153703, U.S. Pat. No. 6,210,858 B1, Japanese Patent Application Laid-open No. 2002-2776069, and columns 0013 to 0015 of Japanese Patent Application Laid-open No. 2001-310423.

Still preferably, the dispersants used in the present invention are polymer dispersants. Particularly preferable polymer dispersants are polymer dispersants having an anionic group and a crosslinkable or polymerizable functional group. Examples of such crosslinkable or polymerizable functional groups include the same functional groups as described above.

The amount of the dispersant used is preferably in the range of 1 to 100% by mass, more preferably 3 to 50% by mass, and most preferably 5 to 40% by mass based on the inorganic fine particles used in the present invention. Two or more kinds of such dispersants may be used in combination.

(Dispersion Medium)

A dispersion medium used in the wet dispersion of the inorganic fine particles in the present invention can be appropriately selected from the group consisting of water and organic solvents. Such a dispersion medium is preferably a liquid having a boiling point of 50° C. or higher and more preferably an organic solvent having a boiling point in the range of 60 to 180° C.

Preferably the amount of the dispersion medium used is 5 to 50% by mass per 100% of the dispersed composition including both inorganic fine particles and dispersant, and more preferably 10 to 30% by mass. The use of a dispersion medium in such amounts allows dispersion to easily progress and the resultant dispersion to have a viscosity in the range that ensures good workability.

Examples of dispersion media applicable to the present invention include: alcohols, ketones, esters, amides, ethers, ether esters, hydrocarbons, and halogenated hydrocarbons.

Concrete examples are: alcohols (e.g. methanol, ethanol, propanol, butanol, benzyl alcohol, ethylene glycol, propylene glycol and ethylene glycol monoacetate); ketones (e.g. methyl ethyl ketone, methyl isobutyl ketone, cyclohexanone and methylcyclohexanone); esters (e.g. methyl acetate, ethyl acetate, propyl acetate, butyl acetate, ethyl formate, propyl formate, butyl format and ethyl lactate); aliphatic hydrocarbons (e.g. hexane and cyclohexane); halogenated hydrocarbons (e.g. methyl chloroform); aromatic hydrocarbons (e.g. benzene, toluene and xylene); amides (e.g. dimethylformamide, dimethylacetamide and n-methylpyrrolidone); ethers (e.g. dioxane, tetrahydrofuran, ethylene glycol dimethyl ether and propylene glycol dimethyl ether); and ether alcohols (e.g. 1-methoxy-2-propanol, ethyl cellosolve and methyl carbinol).

Two or more kinds of the above described dispersion media may be used in combination. Preferable dispersion media include: for example, toluene, xylene, methyl ethyl ketone, methyl isobutyl ketone, cyclohexanone and butanol. Coating solvents containing a ketone solvent (e.g. methyl ethyl ketone, methyl isobutyl ketone or cyclohexanone) as a main component are also preferably used.

(Ultrafine Particle Formation from Inorganic Fine Particles)

When preparing a curable coating composition for forming the high-refractive-index layer (4) of the present invention so that inorganic ultra-fine particles with an average particle size of 100 nm or less are dispersed therein, the stability of the composition fluid is increased, inorganic ultra-fine particles exist in the matrix of the cured film, which has been formed of the curable coating composition, in the uniformly dispersed state, and a transparent high-refractive-index film having uniform optical characteristics is realized. Preferably, the ultra-fine particles existing in the matrix of the cured film have an average particle size in the range of 3 to 100 nm, more preferably in the range of 5 to 100 nm and particularly preferably in the range of 10 to 80 nm.

Further, preferably the curable coating composition does not contain coarse particles having an average particle size of 500 nm or more. Particularly preferably it dose not contain coarse particles having an average particle size of 300 nm or more. The use of such a curable coating composition, a curable coating composition free from coarse particles, makes it possible to form a cured film whose surface has a specified irregular shape as described above.

To disperse the above described inorganic particles having a high refractive index to produce a curable coating composition that contains ultra-fine particles, but does not contain coarse particles, a wet dispersion method is employed in which such particles are dispersed together not only with the above described dispersant, but also with media having an average particle size of less than 0.8 mm.

Dispersers applicable to such a wet dispersion method include traditionally known ones, such as sand grinder mill (e.g. bead mill with a pin), dyno-mill, high-speed impeller mill, pebble mill, roller mill, attritor and colloid mill. To disperse the fine particles of oxides used in the present invention into ultra-fine particles, sand grinder mill (e.g. bead mill with a pin), dyno-mill or high-speed impeller mill is preferably used.

Media used with the above described disperser have an average particle size of 0.8 mm or less. The use of media having an average particle size in such a range enables the above described inorganic fine particles to have an average particle size of 100 nm or less and ultra-fine particles having a uniform particle size to be produced. The average particle size of the media is preferably 0.5 mm or less and more preferably 0.05 to 0.3 mm.

Beads are preferably used as media for wet dispersion. Concrete examples of such beads include: zirconia beads, glass beads, ceramic beads and steel beads. Zirconia beads having an average particle size of 0.05 to 0.2 mm are particularly preferable from the viewpoint of durability—that is, the beads are hard to fracture during dispersion and of ultrafine particle formation.

The dispersion temperature in the dispersion step is preferably 20 to 60° C. and more preferably 25 to 450° C. When dispersing the inorganic fine particles at temperatures in this range, the dispersed particles neither re-aggregate nor settle. The reason for this is probably that at such temperatures, adsorption of the dispersant on the inorganic compound particles is suitably performed, which inhibits poor dispersion stability due to the desorption of the dispersant from the particles at room temperature.

The use of the above described dispersion method makes it possible to desirably form a high-refractive-index film that has satisfactory transparency and excels in refractive index uniformity, film strength and adhesion to the adjacent layer.

Before the above described wet dispersion step, pre-dispersion treatment may be performed. Examples of dispersers used for pre-dispersion treatment include: ball mill, triple roll mill, kneader and extruder.

Further, after the dispersed particles in the dispersion satisfy the above described range of average particle size and monodispersibility of particle size, to remove coarse aggregates in the dispersion, preferably a filter medium is arranged so that the coarse aggregates undergo microfiltration in the bead-separation step. Preferably, the filter medium used for microfiltration has a filtration particle size of 25 μm or less.

Any type of filter medium can be used for the microfiltration, as long as it has the above described performance. Types of filter medium include: for example, filament, felt and mesh types. Any material can be used for the filter medium for the microfiltration, as long as it has the above described performance and does not adversely affect the coating solution. Examples of such materials include: stainless steel, polyethylene, polypropylene and nylon.

(Matrix of High-Refractive-Index Layer)

The high-refractive-index layer (4) includes: at least inorganic ultra-fine particles with a high refractive index; and a matrix. According to one preferred embodiment of the present invention, the matrix of the high-refractive-index layer is formed by: coating a composition for forming a high-refractive-index layer which includes either (i) an organic binder or (ii) at least one of an organometallic compound having a hydrolysable functional group and a partial-condensation product of the organometallic compound; and curing the composition forming a high-refractive-index layer.

(i) Organic Binder

Organic binders which can be contained in the high-refractive-index layer (4) of the present invention include: for example, those produced using
(a) a traditionally known thermoplastic resin,
(b) a combination of a traditionally known reactive curable resin and a curing agent, and
(c) a combination of a binder precursor (a curable polyfunctional monomer or polyfunctional oligomer described later) and a polymerization initiator.

A coating composition for forming a high-refractive-index layer is prepared using: the ingredient for forming an organic binder, (a), (b) or (c); and the above described dispersion that contains complex oxide fine particles with a high refractive index and a dispersant. The coating composition is applied onto a transparent substrate to form a coating film, the formed coating film is cured by a process depending on the ingredient for forming a binder used, so that a high-refractive-index layer (4) is produced.

A curing process is properly selected depending on the type of the binder ingredient used. Curing processes include: for example, processes which allow crosslinking reaction or polymerization reaction to occur in a curable compound (e.g. a polyfunctional monomer or polyfunctional oygomer) by means of at least either heating or light irradiation. Preferably, a cured binder is formed by using the above described combination (c) and exposing the same to light so that the curable compound undergoes crosslinking reaction or polymerization reaction.

Preferably, the dispersant contained in the dispersion of complex oxide fine particles with a high refractive index undergoes crosslinking reaction or polymerization reaction at the same time or after the coating composition for a high-refractive-index layer is applied onto a transparent substrate.

The binder contained in the cured film thus produced is, for example, such that the anionic group of the dispersant is entrapped in it by the crosslinking or polymerization reaction of the dispsersant and the curable polyfuctional monomer or polyfunctional oligomer, as a precursor of the binder.

Further, since the anionic group has a function of keeping inorganic fine particles in the dispersed state, the binder contained in the cured film is provided with a film forming function by its crosslinked or polymerized structure, whereby the physical strength, chemical. resistance and weathering resistance of the cured film, which contains inorganic compound fine particles with a high refractive index, can be improved.

Examples of thermoplastic resins as described above include: polystyrene, polyester, cellulose, polyether, vinyl chloride, vinyl acetate, polyvinyl chloride/polyvinyl acetate copolymer, polyacrylic, polymethacrylic, polyolefin, urethane, silicon and imide resins.

Preferably, the above described reactive curable resin, in other words, a thermoset resin and/or an ionizing radiation curable resin is used. Examples of thermoset resins applicable include: phenol, urea, diallyl phthalate, melamine, guanamine, unsaturated polester, polyurethane, epoxy, amino alkyd, melamine-urea co-condensation, silicon and polysiloxane resins.

Examples of ionizing radiation curable resins include: resins having a radically polymerizable unsaturated group (e.g. a (meth)acryloyloxy, vinyloxy, styryl or vinyl group) and/or a cationically polymerizable group (e.g. an epoxy, thioepoxy, vinyloxy or oxetanyl group), such as polyester, polyether, (meth)acrylic, epoxy, urethane, alkyd, spiro acetal, polybutadiene, and polythiol-polyene resins with a relatively low molecular weight.

These reactive curable resins are used together with traditionally known compounds such as a curing agent, for example, a crosslinking agent (e.g. an epoxy, polyisocyanate, polyol, polyamine or melamine compound) or polymerization initiator (e.g. an UV photoinitiator such as an azobis, organic peroxide, organic halogen, onium salt or ketone compound) or a polymerization accelerator (e.g. an organometallic compound, acidic compound or basic compound). Concrete examples of such compounds include those described in Shinzo Yamashita and Tosuke Kaneko: Handbook of Crossliking Agents, Taiseisha, 1981.

In the following, a preferred process for forming a cured binder, that is, a process for forming a cured binder in which the above described combination (c) is used and exposed to light so that the curable compound undergoes crosslinking reaction or polymerization reaction will be described.

The functional groups of the photocurable polyfunctional monomer or polyfunctional oligomer may be either radically polymerizable ones or cationically polymerizable ones.

Examples of radically polymerizable functional groups include: ethylenic unsaturated groups such as (meth)acryloyl, vinyloxy, styryl and allyl groups. Of these groups, a (meth)acryloyl group is preferable.

Preferably, the binder contains a polyfunctional monomer that has two or more radically polymerizable groups per molecule.

Such a radically polymerizable polyfunctional monomer is preferably selected from the group consisting of compounds having at least 2 terminal ethylenic unsaturated bonds. Preferably such a monomer is a compound having 2 to 6 terminal ethylenic unsaturated bonds per molecule. A group of such compounds are widely known in the polymer material field. And in the present invention, these compounds can be used without any limitation. These compounds can take the chemical form of a monomer, prepolymer,—that is a dimmer, trimer or oligomer, or the mixture thereof, or the copolymer thereof.

Examples of monomers having two or more ethylenic unsaturated groups include: esters of pohydric alcohol and (meth)acrylic acid (e.g. ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate and polyester polyacrylate); the above esters modified with ethylene oxide or caprolactone; vinylbenzene and the derivatives thereof (e.g. 1,4-divinylbenzene, 4-vinylbenzoic acid-2-acryloyl ethyl ester and 1,4-divinylcyclohexanone); vinylsulfone (e.g. divinylsulfone); acrylamide (e.g. methylene bisacrylamide); and methacrylamide. Two or more kinds of these monomers can be used in combination.

Examples of radically polymerizable monomers include: unsaturated carboxylic acids (e.g. acrylic acid, methacrylic acid, itaconic acid, crotonic acid, isocrotonic acid and maleic acid); esters thereof; and amides. Of these radically polymerizable monomers, esters of unsaturated carboxylic acids and aliphatic polyhydric alcohol compounds and amides of unsaturated carboxylic acids and aliphatic polyfunctional amine compounds are preferable.

Addition reaction products of esters or amides of unsaturated carboxylic acids having a nucleophilic substituent such as hydroxyl, amino or mercapto group with mono- or polyfunctional isocyanates or epoxies as well as dehydration/condensation reaction products of esters or amides of unsaturated carboxylic acids having a nucleophilic substituent such as hydroxyl, amino or mercapto group with polyfunctional carboxylic acids are also suitably used.

Reaction products of esters or amides of unsaturated carboxylic acids having an electrophilic substituent such as isocyanate or epoxy group and mono- or polyfunctional alcohols, amines or thiols are also suitably used. Alternatively, compounds produced by using unsaturated phosphonic acid or styrene instead of the above described unsaturated carboxylic acids can also be used.

Examples of aliphatic polyhydric alcohol compounds include: alkandiol, alkantriol, cyclohexandiol, cyclohexantriol, inositol, cyclohexandimethanol, pentaerythritol, sorbitol, dipentaerythritol, tripentaerythritol, glycerol and diglycerol.

Examples of polymerizable ester compounds (monoesters or polyesters) of these aliphatic polyhydric alcohol compounds and unsaturated carboxylic acids include the compounds described in Japanese Patent Application Laid-open No. 2001-139663, columns 0026 to 0027.

Other polymerizable esters suitably used include: for example, vinyl methacrylate; allyl methacrylate; allyl acrylate; esters of aliphatic alcohols described in Japanese Patent Publication Nos. 46-27926 and 51-47334 and Japanese Patent Application Laid-open No. 57-196231; esters having an aromatic skeleton described in Japanese Patent Application Laid-open No. 2-226149; and esters having an amino group described in Japanese Patent Application Laid-open No. 1-165613.

Concrete examples of polymerizable amides formed of aliphatic polyfunctional amine compounds and unsaturated carboxylic acids include: methylene bis-(meth)acrylamide, 1,6-hexamethylene bis-(meth)acrylamide, diethylene triamine tris(meth)acrylamide, xylene bis(meth)acrylamide, and amide having a cyclohexylene structure described in Japanese Patent Publication 54-21726.

Vinylurethane compounds having two or more polymerizable vinyl groups per molecule (e.g. Japanese Patent Publication 48-41708), urethane acrylates (e.g. Japanese Patent Publication 2-16765), urethane compounds having an ethylene oxide skeleton (e.g. Japanese Patent Publication 62-39418), polyester acrylates (e.g. Japanese Patent Publication 52-30490), and photo-curable monomers and oligomers described in Journal of the Adhesion Society of Japan (vol. 20, No. 7, 300-308, 1984) can also be used.

Tow or more kinds of these radically polymerizable polyfunctional monomers may be used in combination.

In the following, compounds containing a cationically polymerizable group (hereinafter sometimes referred to as “cationically polymerizable compound” or “cationically polymerizable organic compound”) which can be used in the formation of the binder for the high-refractive-index layer (4) will be described.

Any compounds in which polymerization reaction and/or crosslinking reaction occurs when they are exposed to activation energy in the presence of activation energy sensitive cationic polymerization initiator can be used as cationically polymerizable compounds in the present invention. Typical examples of such compounds include: epoxy, cyclic thioether, cyclic ether, spiroorthester, and vinylether compounds. Either one kind of the above described cationically polymerizable organic compounds or two or more kinds of the same together may be used in the present invention.

The cationically polymerizable organic compounds preferably have 2 to 10 cationically polymerizable groups per molecule and particularly preferably 2 to 5. The molecular weight of such compounds is 3000 or less, preferably in the range of 200 to 2000 and particularly preferably in the range of 400 to 1500. If the compounds have too low a molecular weight, a problem of their volatilization during the film forming process occurs, whereas they have too high a molecular weight, their compatibility with the composition for forming the high-refractive-index layer becomes worse. Thus, the molecular weights outside the above described range are not preferable.

Examples of the above described epoxy compounds include: aliphatic epoxy compounds and aromatic epoxy compounds.

Aliphatic epoxy compounds include: for example, polyglycidyl ethers of aliphatic polyhydric alcohols or addition products thereof with alkylene oxide; polyglycidyl esters of long-chain aliphatic polybasic acids; homo- or co-polymers of glycidyl acrylate or glycidyl methacrylate.

Examples of the above described epoxy compounds include: besides the above describe epoxy compounds, monoglycidyl ethers of aliphatic higher alcohols; glycidyl esters of higher fatty acids, epoxy soy bean oil; butyl epoxystearate; octyl epoxystearate; epoxy linseed oil; and epoxy polybutadiene.

Examples of cycloaliphatic epoxy compounds include: polyglycidyl ethers of polyhydric alcohols having at least one cycloaliphatic ring, or cyclohexene oxide- or cyclopentene oxide-containing compounds obtained by epoxidizing compounds that contain an unsaturated cycloaliphatic ring (e.g. cyclohexene, cyclopentene, dicyclooctene or tricyclodecene) with a proper oxidizing agent such as hydrogen peroxide or peracid.

Aliphatic epoxy compounds include: for example, mono-or poly-glycidyl ethers of mono- or polyhydric phenols having at least one aromatic nucleus or addition products thereof with alkylene oxide. Concrete examples of these epoxy compounds include: compounds described in Japanese Patent Application Laid-open No. 11-242101, columns 0084 to 0086; and compounds described in Japanese Patent Application Laid-open No. 10-158385, columns 0044 to 0046.

Considering rapid curability, of these epoxy compounds, aromatic epoxides and cycloaliphatic epoxides are preferable and cycloaliphatic epoxides are particularly preferable. Either one kind of the above described epoxy compounds alone or two or more kinds of the same together may be used in the present invention.

Examples of the above described cyclic thioether compounds include compounds having the same structures as those of the above epoxy compounds, provided that the epoxy ring is replaced with a thioepoxy ring.

Concrete examples of compounds containing an oxetanyl group, as cyclic ethers, include compounds described in Japanese Patent Application Laid-open No. 2000-239309, columns 0024 to 0025. Preferably, these compounds are used together with epoxy group-containing compounds.

Examples of spiroorthester compounds include compounds described in Japanese National Publication of International Patent Application No. 2000-506908.

Examples of vinylhydrocarbon compounds include: styrene compounds; vinyl group-substituted alicyclic hydrocarbon compounds (e.g. vinylcyclohexane and vinylcycloheptene); compounds described above in connection with radically polymerizable monomers (compounds whose VI corresponds to —O—); propenyl compounds (e.g. those described in Journal of Polymer Science: Part A: Polymer Chemistry, Vol. 32, 2895 (1994)); alkoxyallene compounds (e.g. those described in Journal of Polymer Science: Part A; Polymer Chemistry, Vol. 33, 2493 (1955)); vinyl compounds (e.g. those described in Journal of Polymer Science: Part A: Polymer Chemistry, Vol. 34, 1015 (1996) and Japanese Patent Application Laid-open No. 2002-29162); and isopropenyl compounds (e.g. those described in Journal of Polymer Science: Part A: Polymer Chemistry, Vol. 34, 2051 (1996)).

Two or more kinds of these compounds may be used in combination.

In the present invention, preferably compounds which have at least one kind of group selected from the group consisting of the above described radically polymerizable groups and cationically polymerizable groups at least in the molecule are used as polyfunctional compounds. Such compounds include: for example, compounds described in Japanese Patent Application Laid-open No. 8-277320, columns 0031 to 0052; and compounds described in Japanese Patent Application Laid-open No. 2000-191737, column 0015. It should be understood that these examples are shown for an illustrative purpose only and not intended to limit the compounds used in the present invention.

Preferably the polyfunctional compounds used in the present invention contain the above described radically polymerizable compounds and cationically polymerizable compounds with radically polymerizable compound—cationically polymerizable compound ratio of 90:10 to 20:80 and more preferably 80:20 to 30:70.

In the following, polymerization initiators used in combination with the binder precursor in the above described combination (c) will be described in detail. Such polymerization initiators include: for example, thermal polymerization initiators and photopolymerization initiators.

The polymerization initiators (L) applicable to the present invention are the compounds that generate radicals or acids when exposed to light and/or heat. Preferably the photopolymerization initiators (L) used in the present invention have the maximum absorption wavelength of 400 nm or less. The use of photopolymerization initiators (L) having absorption wavelengths in the ultraviolet region makes it possible to handle the compounds under an incandescent lamp. Compounds having the maximum absorption wavelength in the near infrared region can also be used.

First, the compounds (L1) that generate radicals will be described in detail. The radical-generating compounds (L1) suitably used in the present invention are the compounds that generate radicals, when exposed to light and/or heat, and initiate and promote the polymerization of compounds having polymerizable unsaturated groups.

Known polymerization initiators or compounds having a bond whose bond dissociation energy is small can be properly selected and used as the compounds (L1). Two or more kinds of radical-generating compounds may be used in combination.

Examples of such radical-generating compounds include: traditionally known thermal radical polymerization initiators such as organic peroxide compounds and azo polymerization initiators; and photo radical polymerization initiators such as amine compounds (described in Japanese Patent Publication 44-20189), organic halogenated compounds, carbonyl compounds, metharocene compounds, hexaarylbiimidazole compounds, organoborate compounds and disulfone compounds.

Concrete examples of the above described organic halogenated compounds include compounds described in Wakabayashi et al., Bull Chem. Soc Japan, 42, 2924 (1969), U.S. Pat. No. 3,905,815, Japanese Patent Application Laid-open No. 63-298339, and M. P. Hutt, Journal of Heterocyclic Chemistry 1 (No. 3), (1970). In particular, they include: oxazole compounds substituted with trihalomethyl group; and s-triazine compounds.

Examples of more preferable organic halogenated compounds include: s-triazine derivatives with at least one mono-, di- or tri-halogen-substituted methyl group binding to their s-triazine ring.

Examples of other organic halogenated compounds include: ketones, sulfides, sulfones and nitrogen-containing heterocycles described in Japanese Patent Application Laid-open No. 5-27830, columns 0039 to 0048.

Example of the above described carbonyl compounds include: compounds described in Saishin UV-koka Gijyutsu (Latest UV Curing Technology), 60-62 (TECHNICAL INFORMATION INSTITUTE Co., LTD., 1991), Japanese Patent Application Laid-open No. 8-134404, columns 0015 to 0016, and Japanese Patent Application Laid-open No. 11-217518, columns 0029 to 0031. In particular, they include: acetophenone compound, hydroxyacetophenone compound; benzophenone compound; thioxane compound; benzoin compounds such as benzoin ethyl ether and benzoin isobutyl ether; benzoate ester derivatives such as ethyl p-dimethylamnobenzoate and ethyl p-diethylamnobenzoate; benzyldimethylketal; and acylphosphine oxide.

Examples of the above described organic peroxide compound include compounds described in Japanese Patent Application Laid-open No. 2001-139663, column 0019.

Examples of the above described metharocene compounds include: various kind of titanocene compounds described in Japanese Patent Application Laid-open Nos. 2-4705 and 5-83588; and iron—arene complexes described in Japanese Patent Application Laid-open Nos. 1-304453 and 1-152109.

Example of the above described hexaarylbiimidazole compounds include: various compounds described in Japanese Examined Application Publication No. 6-29285 and U.S. Pat. Nos. 3,479,185, 4,311,783 and 4,622,286.

Examples of the above described organoborate compounds include: organoborate compounds described in Japanese Patent No. 2764769, Japanese Patent Application Laid-open No. 2002-116539, and Kunz and Martin, Rad Tech '98. Proceeding Apr. 19-22, 1998, Chicago. In particular, they include compounds described in Japanese Patent Application Laid-open No. 2002-116539, columns 0022 to 0027.

Concrete examples of other organoboron compounds include transition metal-coordinated organoboron complexes described in Japanese Patent Application Laid-open Nos. 6-348011, 7-128785, 7-140589, 7-306527 and 7-292014.

Examples of the above described sulfone compounds include compounds described in Japanese Patent Application Laid-open No. 5-239015. Examples of the above described disulfone compounds include compounds described in Japanese Patent Application Laid-open No. 61-166544, which are represented by general formulae (II) and (III).

Either one kind of these radical-generating compounds alone or two or more kinds of the same together may be used. The amount of the radical-generating compounds applicable is 0.1 to 30% by mass, preferably 0.5 to 25% by mass and particularly preferably 1 to 20% by mass per 100% of radically polymerizable monomers. The addition of the radical-generating compounds in amounts within this range allows the radically polymerizable monomers to be highly polymerizable while ensuring the stability with time of the composition for forming the high-refractive-index layer. Various examples of such compounds are described in Saishin UV-koka Gijyutsu (Latest UV Curing Technology), TECHNICAL INFORMATION INSTITUTE Co., LTD., 1991, 159, and they are useful for the present invention.

Preferable examples of commercially available photo-cleavage type of photo radical polymerization initiators include: Irgacure (651, 184, 819, 907, 1870 (CGI-403/Irg184 =7/3 mixed initiator), 500, 369, 1173, 2959, 4265, 4263, etc.) OXE01), etc. by Ciba Specialty Chemicals; KAYACURE (DETX-S, BP-100, BDMK, CTX, BNS, 2-EAQ, ABQ, CPTX, EPD, ITX, QTX, BTC, MCA, etc.) by Nippon Kayaku Co., Ltd.; and Esacure (KIP100F, KB1, EB3, BP, X33, KT046, KT37, KIP150, TZT), etc. by Sartomer Company Inc.

In the following, acid generators (L2) which can be used as the photo polymerization initiator (L) will be described in detail. Examples of such acid generators (L2) include: known compounds, such as photo initiators for photo cationic polymerization, photo-decoloring agents or photo-discoloring agents for pigments, and known acid generators used for micro resist etc., and the mixtures thereof.

The acid generators (L2) also include: for example, organic halogen compounds and disulfone compounds. Concrete examples of organic halogen compounds and disulfone compounds are the same as those described in connection with the above described radical generating compounds.

Onium compounds include: for example, diazonium, ammonium, iminium, phophonium, iodonium, sulfonium, arsonium and selenonium salts. Concrete examples of such compounds are compounds described in Japanese Patent Application Laid-open No. 2002-29162, columns 0058 to 0059.

The acid generators (L2) suitably used in the present invention are onium salts. Of onium salts, diazonium, iodonium, sulfonium and iminium salts are preferable in terms of photosensitivity in photopolymerization initiation and material stability of the compounds.

Concrete examples of onium salts suitably used in the present invention include: aluminized sulfonium salts described in Japanese Patent Application Laid-open No. 9-268205, column 0035; diaryliodonium salts or triarylsulfonium salts described in Japanese Patent Application Laid-open No. 2000-71366, columns 0010 to 0011; sulfonium salts of thiobenzoic acid S-phenyl ester described in Japanese Patent Application Laid-open No. 2001-288205, column 0017; and onium salts described in Japanese Patent Application Laid-open No. 2001-133696, columns 0030 to 0033.

Other examples of acid generators include: compounds such as organometallic compounds/organic halides described in Japanese Patent Application Laid-open No. 2002-29162, columns 0059 to 0062; photoacid generators having an o-nitrobenzyl protective group; and compounds (e.g. iminosulfonate) that generate sulfonic acid by photo-degradation.

Either one kind of these acid generators or two or more kinds of the same together may be used. The amount of such acid generators applicable is 0.1 to 20% by mass, preferably 0.5 to 15% by mass and particularly preferably 1 to 10% by mass per 100% of cationically polymerizable monomers. Adding such acid generators in amounts within the above described is preferable in terms of the stability of the composition for forming the high-refractive-index layer and polymerization reactivity.

Preferably, the composition for forming the high-refractive-index layer used in the present invention contains 0.5 to 10% by mass of radical polymerization initiator and 1 to 10% by mass of cationic polymerization initiator per 100% of radically polymerizable compound plus cationically polymerizable compound. More preferably it contains 1 to 5% by mass of radical polymerization initiator and 2 to 6% by mass of cationic polymerization initiator per 100% of radically polymerizable compound plus cationically polymerizable compound.

The composition for forming the high-refractive-index layer used in the present invention may be used together with traditionally known UV spectral sensitizers or chemical sensitizers, when polymerization reaction is performed by ultraviolet irradiation. Examples of such sensitizers include: Michler's ketone, amino acids (e.g. glycine) and organic amines (e.g. butylamine, dibutylamine).

When polymerization reaction is performed by near infrared irradiation, preferably near infrared spectral sensitizers are used.

As such near infrared spectral sensitizers that are used with the composition for forming the high-refractive-index layer, any light-absorbing substances can be used, as long as they have an absorption band at least at one portion in the wavelength region 700 nm or more. Preferably used are compounds having a molecular extinction coefficient of 10000 or more. More preferably used are compounds having an absorption in the region of 750 to 1400 nm and a molecular extinction coefficient of 20000 or more.

It is more preferable that such near infrared spectral sensitizers have an absorption minimum in the visible region of 420 nm to 700 nm and are optically transparent. As such near infrared spectral sensitizers, various types of pigments or dyes known as near infrared absorbing pigments or dyes can be used. Of such pigments or dyes, traditionally known near infrared absorbing agents are preferably used.

Applicable are commercially available dyes and known dyes described in: documents (e.g. “Near Infrared Absorbing Coloring Matter”, Kagaku Kogyo (Chemical Industry), 1986, May, 45-51 and Development of Functional Coloring matter and Trend of Market in '90s, Chapter 2, Section 2.3 (1990), CMC Publishing Co., LTD.); Ikemori & hashiratani (eds): Special Functional Coloring Matter, 1986, CMC Publishing Co., LTD.; J. FABIAN, Chem. Rev., 92, 1197-1226 (1992); a catalog published in 1995 by NIPPON KANKOH-SHIKISO INSTITUTE; a Laser Coloring Matter catalog published in 1989 by Exciton Inc.; or Patent Publications.

(ii) Organometallic Compound Having a Hydrolysable Functional Group

Preferably, a cured film is formed by sol-gel processing after forming a coating film by using an organometallic compound having a hydrolysable functional group as the matrix of the high-refractive-index layer (4) used in the present invention. Examples of such organometallic compounds include compounds including Si, Ti, Zr or Al. Examples of hydrolysable functional groups include: alkoxy, alkoxycarbonyl, halogen, and hydroxyl groups. Particularly preferable are alkoxy groups such as methoxy, ethoxy, propoxy and butoxy groups.

Preferred organometallic compounds are organosilicon compounds represented by the following chemical formula 3 and the partially hydrolyzed products thereof (partial condensation products). It is well known that the organosilicon compounds represented by chemical formula 3 easily undergoes hydrolysis and then dehydration/condensation reaction.
(R^{a})m-Si(X)n (Chemical formula 3)
wherein R^{a} represents an optionally substituted aliphatic group with 1 to 30 carbon atoms or aryl group with 6 to 14 carbon atoms; X a halogen atom (e.g. chlorine or bromine), OH, OR₂ or OCOR₂ group; R₂ an optionally substituted alkyl group; m is an integer of 0 to 3; n an integer of 1 to 4; and the sum of m and n is 4, provided that when m is 0, X represents an OR₂ or OCOR₂ group.

In chemical formula 3, aliphatic groups represented by R^{a} are preferably those with 1 to 18 carbon atoms (e.g. methyl, ethyl, propyl, butyl, pentyl, hexyl, octyl, decyl, dodecyl, hexadecyl, octadecyl, benzyl, phenethyl, cyclohexyl, cyclohexylmethyl, hexenyl, decenyl or codecenyl), more preferably those with 1 to 12 carbon atoms and particularly preferably those with 1 to 8 carbon atoms.

Examples of aryl groups represented by R^{a} include: phenyl, naphthyl and anthranil groups. Preferably the aryl group is a phenyl group.

The substituents are not limited to any specific ones; however, preferable are halogen atoms (e.g. fluorine, chlorine and bromine), hydroxyl, mercapto, carboxyl, epoxy, alkyl (e.g. methyl, ethyl, i-propyl, propyl and t-butyl), aryl (e. g. phenyl and naphthyl), aromatic heterocyclic (furil, pyrazolyl and pyridyl), alkoxy (e.g. methoxy, ethoxy, i-propoxy and hexyloxy), aryloxy (e.g. phenoxy), alkylthio (e.g. methylthio and ethylthio), arylthio (e.g. phenylthio), alkenyl (e.g. vinyl and 1-propenyl), alkoxysilyl (e.g. trimethoxysilyl and triethoxysilyl), acyloxy (e.g. acetoxy and (meth)acryloyl), alkoxycarbonyl (e.g. methoxycarbonyl and ethoxycarbonyl), aryloxycarbonyl (e.g. phenoxycarbonyl), carbamoyl (e.g. carbamoyl, N-methylcarbamoyl, N,N-dimethylcarbamoyl and N-methyl-N-octylcarbamoyl), and acylamino (e.g. acetylamino, benzoylamino, acrylamino and methacrylamino) substituents.

Of these substituents, more preferable are hydroxyl, mercapto, carboxyl, epoxy, alkyl, alkoxysilyl, acyloxy and acylamino groups. And particularly preferable are epoxy, polymerizable acyloxy ((meth)acryloyl) and polymerizable acylamino (acrylamino, methacrylamino) substituents. These substituents may be further optionally substituted.

R₂ represents an optionally substituted alkyl group. The substituents on the alkyl group are the same as those of R₁.

m is an integer of 0 to 3. n is an integer of 1 to 4. The sum of m and n is 4. Preferably m is 0, 1 or 2 and particularly preferably 1. When m is 0, X represents an OR₂ or OCOR₂ group.

The amount of the compound of chemical formula 3 contained in the high-refractive-index layer (4) is preferably 10 to 80% by mass, more preferably 20 to 70% by mass and particularly preferably 30 to 50% by mass per 100% of the solid content in the same layer.

Concrete examples of the compounds represented by chemical formula 3 include: compounds described in Japanese Patent Application Laid-open No. 2001-166104, columns 0054 to 0056.

In the high-refractive-index layer (4), preferably the organic binder has silanol groups. Allowing the binder to have silanol groups makes it possible to further improve the physical strength, chemical resistance and weathering resistance of the high-refractive-index layer (4).

Silanol groups can be introduced into a binder by: for example, mixing an organosilicon compound of chemical formula 3 which has crosslinkable or polymerizable functional groups, along with a binder precursor (curable polyfunctional monomer or polyfunctional oligomer) and a polymerization initiator, as constituents of the binder which in turn constitutes a coating composition for forming a high-refractive-index layer, and a dispersant contained in the dispersion of the inorganic fine particles with a high refractive index into the coating composition; applying the coating composition onto a transparent substrate; and allowing the above dispersant, polyfunctional monomer or oligomer, and the organosilicon compound represented by chemical formula 3 to undergo crosslinking reaction or polymerization reaction.

Preferably the hydrolysis/condensation reaction for curing the above organometallic compound is performed in the presence of a catalyst. Examples of catalyst applicable include: inorganic acids such as hydrochloric acid, sulfuric acid and nitric acid; organic acids such as oxalic acid, acetic acid, formic acid, trifluoroacetic acid, methansulfonic acid and toluenesulfonic acid; inorganic bases such as sodium hydroxide, potassium hydroxide and ammonium; organic bases such as triethylamine and pyridine; metal alkoxides such as triisopropoxyaluminum, tetrabutoxyzirconium and tetrabutoxytitanate; and metal chlate compounds of β-diketones of β-ketoesters. Concrete examples of such catalysts include compounds described in Japanese Patent Application Laid-open No. 2000-275403, columns 0071 to 0083.

The amount of these catalyst compounds contained in the composition is 0.01 to 50% by mass, preferably 0.1 to 50% by mass and more preferably 0.5 to 10% by mass per 100% of organometallic compound. Preferably the reaction conditions are properly controlled depending on the reactivity of the organometallic compound.

In the high-refractive-index layer (4), preferably the matrix has specific polar groups. Examples of specific polar groups include: anionic, amino and quaternary ammonium groups. Concrete examples of anionic, amino and quaternary ammonium groups are the same as those described in connection with the dispersant.

The matrix of the high-refractive-index layer (4) which has specific polar groups can be obtained by: for example, mixing a dispersion which contains inorganic fine particles with a high refractive index and a dispersant into a coating composition for forming a high-refractive-index layer; further mixing, as a cured film-forming component, at least either one of the combination of a binder precursor having specific polar groups (curable polyfuctional monomer or polyfunctional oligomer having specific polar groups) and a polymerization initiator and the organosilicon compound represented by chemical formula 3 which has specific polar groups and crosslinking or polymerizable functional groups into the above coating composition; if desired, further mixing monofunctional monomer having specific polar groups and crosslinkable or polymerizable functional groups into the above coating composition; applying the coating composition onto a transparent substrate; and allowing the above dispersant, monofunctional monomer, polyfunctional monomer or oligomer, and/or the organosilicon compound represented by chemical formula 3 to undergo crosslinking reaction or polymerization reaction.

The monofunctional monomer having specific polar groups functions as a dispersing aid for inorganic fine particles in the coating composition. In addition, if the monofunctional monomer is allowed to undergo crosslinking reaction or polymerization reaction, after coating, with the dispersant and polyfunctional monomer or oligomer to be formed into a binder, the satisfactorily uniform dispersibility of the inorganic fine particles in the high-refractive-index layer (4) is maintained, whereby a high-refractive-index layer (4) having excellent physical strength, chemical resistance and weathering resistance can be.produced.

The amount of the monofunctional monomer with an amino group or quaternary ammonium group used is preferably 0.5 to 50% by mass and more preferably 1 to 30% by mass per 100% of dispersant. If a binder is formed by crosslinking reaction or polymerization reaction at the same time or after the coating of a high-refractive-index layer (4) is performed, the monofunctional monomer is allowed to function effectively before the coating of a high-refractive-index layer (4) is performed.

The matrix of the high-refractive-index layer (4) used in the present invention can also be formed by using traditionally known organic polymer having crosslinking or polymerizable functional groups, which corresponds to the above described organic binder (a), and curing the same. Preferably, the formed high-refractive-index layer has a structure in which the polymer is further crosslinked and polymerized.

Examples of such polymers include: polyolefin (composed of saturated hydrocarbon), polyether, polyurea, polyurethane, polyester, polyamine, polyamide and melamine resin. Of theses polymers, preferable are polyolefin, polyether and polyurea and more preferable are polyolefin and polyether. The mass average molecular weight of the organic polymer before being cured is preferably 1×10³ to 1×10⁶ and more preferably 3×10³ to 1×10⁵.

Preferably, the organic polymer before being cured is a copolymer having: a repeating unit which contains the same specific polar group as those described above; and a repeating unit which contains a crosslinked or polymerized structure. The amount of the repeating unit, in the polymer, which contains an anionic group is preferably 0.5 to 99% by mass, more preferably 3 to 95% by mass and most preferably 6 to 90% by mass per 100% of repeating units. The repeating unit may contain two or more anionic groups which may be the same or different.

When the organic polymer has a repeating unit that contains a silanol group, the amount of the repeating unit contained in the polymer is preferably 2 to 98% by mol, more preferably 4 to 96% by mol and most preferably 6 to 94% by mol.

When the organic polymer has a repeating unit that contains an amino group or quaternary ammonium group, the amount of the repeating unit contained in the polymer is preferably 0.1 to 50% by mass and more preferably 0.5 to 30% by mass.

If a silanol, amino or quaternary ammonium group is contained in the repeating unit that contains an anionic group or in the repeating unit that has a crosslinked or polymerized structure, the same effect can be produced.

The amount of the repeating unit, in the polymer, which has a crosslinked or polymerized structure is preferably 1 to 90% by mass, more preferably 5 to 80% by mass and most preferably 8 to 60% by mass per 100% of the polymer.

Preferably, a matrix made up of a binder having undergone crosslinking or polymerization reaction is formed by applying a coating composition for forming a high-refractive-index layer onto a transparent substrate and allowing the binder contained in the coating composition to undergo crosslinking or polymerization reaction at the same time or after the coating composition is applied.

The high-refractive-index layer (4) of the present invention may further contain other compounds appropriately selected depending on the application and purpose for which it is used. For example, when a low-refractive-index layer (5) is provided on the high-refractive-index layer (4), it is preferable that the refractive index of the high-refractive-index layer (4) is higher than that of the transparent substrate. Organic compounds are allowed to have an increased refractive index when they contain an aromatic ring, a halogenating element other than fluorine (e.g. Br, I or Cl), or an atom such as S, N or P. Thus, a binder can also be preferably used which is obtained by allowing a curable compound containing the above described ring, element or atom to undergo crosslinking or polymerization reaction.

(Other Compositions for High-Refractive-Index Layer)

The high-refractive-index layer (4) of the present invention may further contain other compounds appropriately selected depending on the application and purpose for which it is used. For example, it is preferable that the refractive index of the high-refractive-index layer (4) is higher than that of the transparent substrate. And a binder can also be preferably used which is obtained by allowing a curable compound containing an aromatic ring, a halogenating element other than fluorine (e.g. Br, I or Cl), or an atom such as S, N or P to undergo crosslinking or polymerization reaction.

The high-refractive-index layer (4) of the present invention may further contain, besides the above described ingredients (such as inorganic fine particles, polymerization initiator and sensitizer), additives such as resin, surfactant, antistatic agent, coupling agent, thickening agent, color protection agent, coloring materials (pigment, dye), anti-foaming agent, leveling agent, flame-retardant, ultraviolet absorber, infrared absorber, adhesion promoter, polymerization inhibitor, antioxidant, surface modifier and conductive metal fine particles.

[Intermediate-Refractive-Index Layer]

In the antireflection film of the present invention, preferably a high-refractive-index layer (4) is formed by laminating two layers with different refractive indices. Specifically, a low-refractive-index layer (5) is formed on the high-refractive-index layer (4) that has a refractive index higher than that of the low-refractive-index layer (5) and an intermediate-refractive-index layer (3) with a refractive index between those of the substrate and the high-refractive-index layer (4) is formed adjacent to the high-refractive-index layer (4) on the opposite side to the low-refractive-index layer (5). As described above, the refractive indices of the layers are relative ones.

Although any known materials can be used as the materials for making up the intermediate-refractive-index layer (3), the same materials as those used for the above described high-refractive-index layer (4) are preferably used. The refractive index of the layer can be easily controlled by selecting the kind and amount of the inorganic fine particles used. The layer is formed in the same manner as described in connection with the high-refractive-index layer (4) so that a thin film of 30 to 500 nm thick, more preferably 50 to 300 nm thick is formed.

[Low-Refractive-Index Layer]

Preferably, a low-refractive-index layer (5) is formed of a cured film of a copolymer that has a repeating unit derived from fluorine-containing vinyl monomer and a repeating unit having a (meth)acryloyl group on its side chain as essential constituents. From the viewpoint of lower refractive index and film hardness compatibility, it is preferable to use a curing agent such as (meth)acrylate or a filler such as inorganic fine particles or organic fine particles together with the above described copolymer.

The refractive index of the low-refractive-index layer (5) is preferably 1.20 to 1.49, more preferably 1.25 to 1.48 and particularly preferably 1.30 to 1.46.

The thickness of the low-refractive-index layer (5) is preferably 50 to 200 nm and more preferably 70 to 100 nm. The haze of the low-refractive-index layer (5) is preferably 3% or less, more preferably 2% or less and most preferably 1% or less. The definite strength of the low-refractive-index layer (5) is H or higher, more preferably 2H or higher and most preferably 3H or higher at the applied load of 500 g, on the basis of the pencil hardness test in accordance with JIS K5400.

To improve the stainproofing performance of the antireflection film, the contact angle of water on.the surface of the low-refractive-index layer (5) is preferably 90° or more, more preferably 95° or more and particularly preferably 100° or more.

In the following, the copolymer used in the low-refractive-index layer (5) of the present invention will be described.

Concrete examples of fluorine-containing monomer units include: fluoroolefins (e.g. fluoroethylene, vinylidene fluoride, tetrafluoroethylene, perfluorooctylethylene hexafluoropropylene, and perfluoro-2,2-dimethyl-1,3-dioxol); partially or completely fluorinated alkyl ester derivatives of (meth)acrylic aid (e.g. Biscoat (by Osaka Organic Chemical Industries Ltd.) and M-2020 (DAIKIN INDUSTRIES, Ltd.)); and partially or completely fluorinated vinyl ether. Of these monomer units, perfluoroolefins are preferable, and from the viewpoint of refractive index, solubility, transparency and availability, hexafluoropropylene is particularly preferable.

Constituting units for providing crosslinking reactivity include: for example, constituting units obtained by polymerizing monomers that have a self-crosslinking functional group per molecule, such as glycidyl(meth)acrylate and glycidyl vinyl ether; constituting units obtained by polymerizing monomers having a carboxyl, hydroxyl, amino or sulfo group (e.g. (meth)acrylic acid, methylol (meth)acrylate, hydroxyalkyl (meth)acrylate, allyl acrylate, hydroxyethyl vinyl ether, hydroxybutyl vinyl ether, maleic acid and crotonic acid); and constituting units obtained by introducing a crosslinking-reactive group such as (meth)acryloyl group into the above described constituting units by polymer reaction (e.g. by a technique for allowing acrylic acid chloride to act on hydroxyl group).

Besides the above described fluorine-containing monomer unit and constituting unit for providing crosslinking reactivity, monomers containing no fluorine can also be copolymerized, from the viewpoint of solubility in a solvent, transparency of coating, etc. Monomer units which can be used together with the above described fluorine-containing monomer unit and constituting unit for providing crosslinking reactivity are not limited to any specific ones. They include: for example, olefins (e.g. ethylene, propylene, isoprene, vinyl chloride and vinylidene chloride); acrylic esters (e.g. methyl acrylate, methyl acrylate, ethyl acrylate, 2-ethylhexyl acrylate); methacrylic esters (e.g. methyl methacrylate, ethyl methacrylate, butyl methacrylate and ethylene glycol dimethacrylate); styrene derivatives (e.g. styrene, divinylbenzene, vinyltoluene and oc-methylstyrene); vinyl ethers (e.g. methyl vinyl ether, ethyl vinyl ether and cyclohexyl vinyl ether); vinyl esters (e.g. vinyl acetate, vinyl propionate and vinyl cinnamate); acrylamides (e.g. N-tert-butyl acrylamide and N-cyclohexyl acrylamide); methacrylamides; and acrylonitrile derivatives.

As described in Japanese Patent Application Laid-open Nos. 10-25388 and 10-147739, a curing agent may be appropriately used together with the above polymer.

The fluorine-containing polymers particularly useful for the present invention are random copolymers of perfluoroolefins and vinyl ethers or vinyl esters. Preferably, such polymers have a group capable of undergoing crosslinking reaction individually (e.g. radical-reactive group such as (meth)acryloyl group, epoxy group, and ring-opening polymerizable group such as oxetanyl group). Preferably, these crosslinking reactive group-containing polymer units constitute 5 to 70% by mol of the total polymer units and particularly preferably 30 to 60% by mol.

Preferred embodiments of copolymers used in the present invention include: for example, compounds represented by the following chemical formula 4. 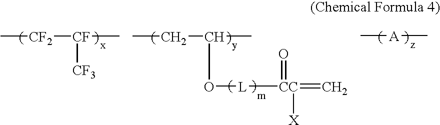
In the chemical formula 4, L represents a linkage group with 1 to 10 carbon atoms, preferably 1 to 6 carbon atoms and more preferably 2 to 4 carbon atoms; and the linkage group may have a straight-chain or branched-chain structure or a ring structure and have a heteroatom selected from the group consisting of O, N and S.

Examples of preferred linkage groups include: *—(CH₂)₂—O—**, *—(CH₂)₂—NH—**, *—(CH₂)₄—O—**, *—(CH₂)₆—O—**, *—(CH₂)₂—O—(CH₂)₂—O—**, O—CONH—(CH₂)₃—O—**, *—CH₂CH(OH)CH₂—O—**, and *—CH₂CH₂OCONH(CH₂)₃—O—** (* indicates the linkage portion on the polymer backbone side and ** the linkage portion on the (meth)acryloyl group side) m represents 0 or 1.

In the above chemical formula 4, X represents a hydrogen atom or a methyl group. From the viewpoint of curing reactivity, X is preferably a hydrogen atom.

In the above chemical formula 4, A represents a repeating unit derived from arbitrary vinyl monomers and is not limited to any specific one, as long as it is a constituent monomer copolymerizable with hexafluoropropylene. It can be selected appropriately from the viewpoint of adhesion to the substrate used, Tg of the polymer used (this contributes to coating strength), solubility in the solvent used, transparency, sliding properties, dust-resistant/stain-proofing properties. It may be made up of a single or a plurality of vinyl monomers depending on the purpose for which it is used.

Preferred examples of such repeating units include: vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether; vinyl esters such as vinyl acetate, vinyl propionate and vinyl butyrate; (meth)acrylates such as methyl (meth)acrylate, ethyl (meth)acrylate, hydroxyethyl (meth)acrylate, glycidyl (meth)acrylate, allyl (meth)acrylate and (meth)acryloyloxypropyl trimethoxysilane; styrene derivatives such as styrene and p-hydroxymethyl styrene; and unsaturated carbonic acids and the derivatives thereof such as crotonic acid, maleic acid and itaconic acid. More preferable are vinyl ether derivatives and vinyl ester derivatives and particularly preferable are vinyl ether derivatives.

In the above chemical formula 4, x, y and z represent the values % by mol of the constituents, which satisfy the following inequality: 30≦x≦60, 5≦y≦70 and 0≦z≦65, preferably 35≦x≦55, 30≦y≦60 and 0≦z≦20, and particularly preferably 40≦x≦55, 40≦y≦55and 0≦z≦10.

Preferred embodiments of copolymers used in the present invention include: for example, compounds represented by the following chemical formula 5.

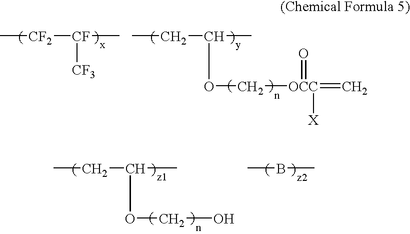

In the chemical formula 5, X, x, y represent the same as those in the above chemical formula 4. Preferred ranges are the same as for the chemical formula 4.

In the chemical formula 5, n is an integer of 2≦n≦10, preferably 2≦n≦6 and more preferably 2≦n≦4.

In the chemical formula 5, B represents a repeating unit derived from arbitrary vinyl monomers and may be made up of a single or a plurality of vinyl monomers. Preferred examples of such repeating units are the same as those described in connection with A in the above described chemical formula 4.

In the chemical formula 5, z1 and z2 represent the value % by mol of the repeating units, which satisfy the following inequality: 0≦z1≦65 and 0≦z2≦65, preferably 0≦z1≦30 and 0≦z2≦10, and particularly preferably 0≦z1≦10 and 0≦z2≦5.

The copolymers represented by chemical formula 4 or 5 can be synthesized by, for example, introducing a (meth)acryloyl group into a copolymer that includes a hexafluoropropylene component and a hydroxyalkyl vinyl ether component using any one of the above described technique.

In the following, preferred concrete examples of copolymers useful for the present invention will be shown; however, it should be understood that these examples are shown for an illustrative purpose only and not intended to limit the present invention.

(Chemical Formula 6)

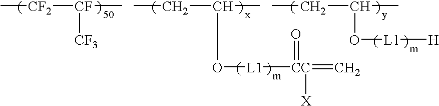

| | | | | | | Number |
|---|---|---|---|---|---|---|
| | | | | | | average |
| | | | | | | molecu- |
| | | | | | | lar |
| | | | | | | weight |
| | | | | | | Mn |
| | x | y | m | L1 | X | (×10⁴) |
| P-1 | 50 | 0 | 1 | *—CH₂CH₂O— | H | 3.1 |
| P-2 | 50 | 0 | 1 | *—CH₂CH₂O— | CH₃ | 4.0 |
| P-3 | 45 | 5 | 1 | *—CH₂CH₂O— | H | 2.8 |
| P-4 | 40 | 10 | 1 | *—CH₂CH₂O— | H | 3.8 |
| P-5 | 30 | 20 | 1 | *—CH₂CH₂O— | H | 5.0 |
| P-6 | 20 | 30 | 1 | *—CH₂CH₂O— | H | 4.0 |
| P-7 | 50 | 0 | 0 | — | H | 11.0 |
| P-8 | 50 | 0 | 1 | *—C₄H₈O— | H | 0.8 |
| P-9 | 50 | 0 | 1 | 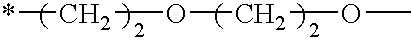 | H | 1.0 |
| P-10 | 50 | 0 | 1 | 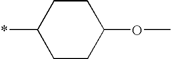 | H | 7.0 |

*indicates the linkage portion on the polymer backbone side.

(Chemical Formula 7)

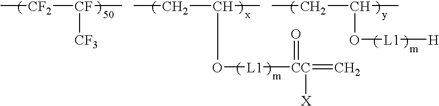

| | | | | | | Number average |
|---|---|---|---|---|---|---|
| | | | | | | molecular weight |
| | x | y | m | L1 | X | Mn (×10⁴) |
| P-11 | 50 | 0 | 1 | *—CH₂CH₂NH— | H | 4.0 |
| P-12 | 50 | 0 | 1 | 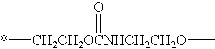 | H | 4.5 |
| P-13 | 50 | 0 | 1 | 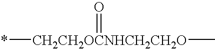 | CH₃ | 4.5 |
| P-14 | 50 | 0 | 1 | 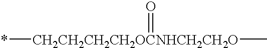 | CH₃ | 5.0 |
| P-15 | 50 | 0 | 1 | 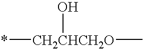 | H | 3.5 |
| P-16 | 50 | 0 | 1 | 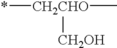 | H | 3.0 |
| P-17 | 50 | 0 | 1 | 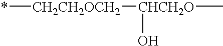 | H | 3.0 |
| P-18 | 50 | 0 | 1 | 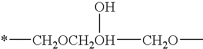 | CH₃ | 3.0 |
| P-19 | 50 | 0 | 1 | 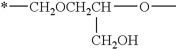 | CH₃ | 3.0 |
| P-20 | 40 | 10 | 1 | *—CH₂CH₂O— | CH₃ | 0.6 |

*indicates the linkage portion on the polymer backbone side.

(Chemical Formula 8)

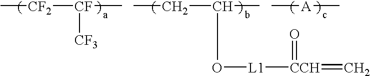

| | | | | | | Number average |
|---|---|---|---|---|---|---|
| | | | | | | molecular weight |
| | a | b | c | L1 | A | Mn (×10⁴) |
| P-21 | 55 | 45 | 0 | *—CH₂CH₂O—** | — | 1.8 |
| P-22 | 45 | 55 | 0 | *—CH₂CH₂O—** | — | 0.8 |
| P-23 | 50 | 45 | 5 | 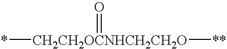 | 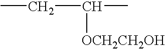 | 0.7 |
| P-24 | 50 | 45 | 5 | 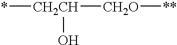 | 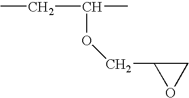 | 4.0 |
| P-25 | 50 | 45 | 5 | 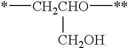 | 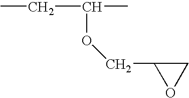 | 4.0 |
| P-26 | 50 | 40 | 10 | *—CH₂CH₂O—** | 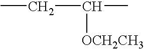 | 4.0 |
| P-27 | 50 | 40 | 10 | *—CH₂CH₂O—** | 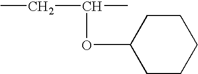 | 4.0 |
| P-28 | 50 | 40 | 10 | *—CH₂CH₂O—** | 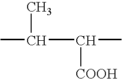 | 5.0 |

*indicates the linkage portion on the polymer backbone side.
**indicates the linkage portion on the acryloyl group side.

(Chemical Formula 9)

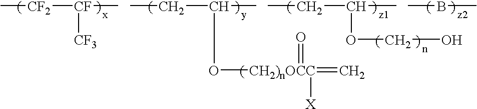

| | | | | | | | | Number average |
|---|---|---|---|---|---|---|---|---|
| | | | | | | | | molecular weight |
| | x | y | z1 | z2 | n | X | B | Mn (×10⁴) |
| P-29 | 50 | 40 | 5 | 5 | 2 | H | 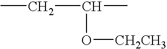 | 5.0 |
| P-30 | 50 | 35 | 5 | 10 | 2 | H | 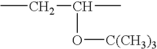 | 5.0 |
| P-31 | 40 | 40 | 10 | 10 | 4 | CH₃ | 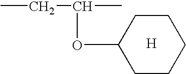 | 4.0 |

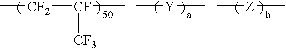

| | | | | | Number average |
|---|---|---|---|---|---|
| | | | | | molecular weight |
| | a | b | Y | Z | Mn (×10⁴) |
| P-32 | 45 | 5 | 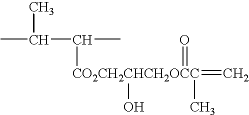 | 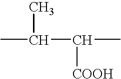 | 4.0 |
| P-33 | 40 | 10 | 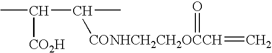 | 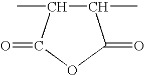 | 4.0 |

(Chemical Formula 10)

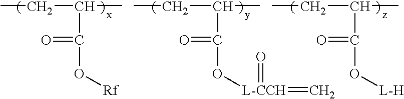

| | | | | | | Number average |
|---|---|---|---|---|---|---|
| | | | | | | molecular weight |
| | x | y | z | Rf | L | Mn (×10⁴) |
| P-34 | 60 | 40 | 0 | —CH₂CH₂C₈F₁₇-n | *—CH₂CH₂O— | 11 |
| P-35 | 60 | 30 | 10 | —CH₂CH₂C₄F₈H-n | *—CH₂CH₂O— | 30 |
| P-36 | 40 | 60 | 0 | —CH₂CH₂C₆F₁₂H | *—CH₂CH₂CH₂CH₂O— | 4.0 |

*indicates the linkage portion on the polymer backbone side.

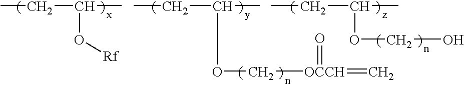

| | | | | | | Number average |
|---|---|---|---|---|---|---|
| | | | | | | molecular weight |
| | x | y | z | n | Rf | Mn (×10⁴) |
| P-37 | 50 | 50 | 0 | 2 | —CH₂C₄F₈H-n | 5.0 |
| P-38 | 40 | 55 | 5 | 2 | —CH₂C₄F₈H-n | 4.0 |
| P-39 | 30 | 70 | 0 | 4 | —CH₂C₈F₁₇-n | 10 |
| P-40 | 60 | 40 | 0 | 2 | —CH₂CH₂C₈F₁₆H-n | 5.0 |

The copolymers preferably used in the present invention can be synthesized by: first synthesizing the precursors of hydroxyl-containing polymers etc. by any one of various polymerization methods, such as solution polymerization, precipitation polymerization, suspension polymerization, bulk polymerization or emulsion polymerization; and then introducing a (meth)acryloyl group by the above described polymer reaction. The polymer reaction can be performed by known operation such as batch, semi-continuous, or continuous operation.

As described above, it is not necessarily advantageous, from the viewpoint of the coating hardness of the low-refractive-index layer (5), that the low-refractive-index layer (5) contains additives such as curing agent. However, from the viewpoint of its interfacial adhesion to the high-refractive-index layer (4), the low-refractive-index layer (5) may contain a curing agent such as polyfunctional (meth)acrylate compound, polyfunctional epoxy compound, polyisocyanate compound, aminoplast, or polybasic acid or its anhydrides.

When adding these additives, the amount of the additives added is preferably in the range of 0 to 30% by mass, more preferably 0 to 20% by mass and particularly preferably 0 to 10% by mass per 100% of the total solid content of the low-refractive-index layer.

Further, to provide the antireflection film with properties such as stain resistance, water resistance, chemical resistance or sliding properties, known agents such as silicone- or fluorine-base stain-proofing agent, slip agent or the like can be appropriately added to the composition for forming the low-refractive-index layer (5). When adding these additives, the amount of the additives added is preferably in the range of 0 to 20% by mass, more preferably 0 to 10% by mass and particularly preferably 0 to 5% by mass per 100% of the total solid content of the layer.

As a radical polymerization initiator, either of the two types: one which generates radical by the action of heat and the other by the action of light can be used.

Examples of compounds which initiate radical polymerization by the action of heat and are used in the present invention include: organic or inorganic peroxides; and organic azo and diazo compounds.

Concrete examples of such compounds include: benzoyl peroxide, halogen-benzoyl peroxide, lauroyl peroxide, acetyl peroxide, dibutyl peroxide, cumene hydroperoxide and butyl hydroperoxide, as organic peroxides; hydrogen peroxide, ammonium persulfate and potassium persulfate, as inorganic peroxides; 2-azo-bis-isobutylonitrile, 2-azo-bis-propionitrile and 2-azo-bis-cyclohexanedinitrile, as azo compounds; and diazoaminobenzene and p-nitrobenzenediazonium, as diazo compounds.

When using compounds which initiate radical polymerization by the action of light, curing of the coating is performed by the irradiation of activation energy.

Examples of such photo radical polymerization initiators include: acetophenones, benzoins, benzophenones, phosphine oxides, ketals, anthraquinones, thioxanthones, azo compounds, peroxides, 2,3-dialkyl dion compounds, disulfide compounds, fluoroamine compounds and aromatic sulfoniums. Examples of acetophenones include: 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophenone and 2-benzyl-2-dimethylamino-1-(4-morpholinophenyl)-butanone.

Examples of benzoins include: benzoin benzenesulfonate ester, benzoin toluenesulfonate ester, benzoin methyl ether, benzoin ethyl ether and benzoin isopropyl ether. Examples of benzophenones include: benzophenone, 2,4-dichlorobenzophenone, 4,4-dichlorobenzophenone and p-chlorobenzophenone. Examples of phosphine oxides include 2,4,6-trimethylbenzoyldiphenylphosphine oxide. Sensitizing dyes can be preferably used together with these photo radical polymerization initiators.

The amount of the compounds, which initiate radical polymerization by the action of heat or light, added is not limited to any specific amount, as long as the compounds can initiate the polymerization of carbon-carbon double bonds in such an. amount; however, generally, the amount is preferably 0.1 to 15% by mass, more preferably 0.5 to 10% by mass and particularly preferably 2 to 5% by mass based on the total solid content of the low-refractive-index layer-forming composition.

As a solvent contained in the coating solution composition for forming a low-refractive-index layer, any solvent can be used, as long as it allows a composition including a fluorine-containing copolymer to be uniformly dissolved or dispersed in it while avoiding the formation of precipitates. Tow or more kinds of solvents together can also be used. Examples of solvents preferably used in the present invention include: ketones (e.g. acetone, methyl ethyl ketone and methyl isobutyl ketone); esters (e.g. ethyl acetate and butyl acetate); ethers (e.g. tetrahydrofuran and 1,4-dioxane); alcohols (e.g. methanol, ethanol, isopropyl alcohol, butanol and ethylene glycol); aromatic hydrocarbons (e.g. toluene and xylene); and water.

The low-refractive-index layer (5) may contain, besides fluorine-containing compounds, additives such as filler (e.g. inorganic fine particles or organic fine particles), silane coupling agent, slip agent (e.g. silicone compounds such as dimethyl silicone) or surfactant. Preferably the low-refractive-index layer (5) contains inorganic fine particles, a silane coupling agent and a slip agent.

In the following inorganic fine particles which the low-refractive-index layer (5) of the present invention can contain will be described.

The amount of the inorganic fine particles coated is preferably 1 to 100 mg/m², more preferably 5 to 80 mg/m² and much more preferably 10 to 60 mg/m². If the amount is too small, the scratch-resistance improving effect is decreased, whereas the amount is too large, minute irregularities are formed on the surface of the low-refractive-index layer (5), whereby the appearance, such as black solidness, of the film or integrated reflectance deteriorates.

Preferably inorganic fine particles have a low refractive index, since they are contained in the low-refractive-index layer (5). Inorganic fine particles with a low refractive index include: for example, fine particles of magnesium fluoride or silica. From the viewpoint of refractive index, dispersion stability and costs, silica fine particles are preferably used. The average particle size of the silica fine particles used is preferably 30% to 150%, more preferably 35% to 80% and much more preferably 40% to 60% of the thickness of the low-refractive-index layer (5).

In other words, when the thickness of the low-refractive-index layer (5) is 100 nm, the particle size of the silica fine particles used is preferably 30 nm to 150 nm, more preferably 35 nm to 80 nm, and much more preferably 40 nm to 60 nm.

If the particle size of the silica fine particles is too small, the scratch-resistance improving effect is decreased, whereas the amount is too large, minute irregularities are formed on the surface of the low-refractive-index layer (5), whereby the appearance, such as black solidness, of the film or integrated reflectance deteriorates. The silica fine particles may be either crystalline or amorphous, or either monodisperse or aggregated as long as the particles satisfy the given size requirements. Most preferably the shape of the silica fine particles is spherical; however, it may have an indeterminate form.

The average particle size of the inorganic fine particles was measured with a Coulter counter unit.

To further reduce the increase in refractive index of the low-refractive-index layer (5), preferably hollow silica fine particles are used. The refractive index of the hollow silica fine particles is 1.17 to 1.40, preferably 1.17 to 1.35 and more preferably 1.17 to 1.30. The term “refractive index” herein used means the refractive index of all the particles. It does not mean the refractive index of the outer shell silica alone that constitutes the hollow silica particles. The percentage of void X of the hollow silica fine particles is expressed by the following equation 4:
x=(4πa3/3)/(4πb3/3)×100
where a is the radius of voids in the particles and b is the radius of the particle outer shells.

The percentage of void X is preferably 10 to 60%, more preferably 20 to 60% and most preferably 30 to 60%.

If the percentage of void is increased to further decrease the refractive index of hollow silica particles, the thickness of the outer shell is decreased, and hence the strength of the particles is also decreased. Thus, from the viewpoint of scratch resistance, particles with a refractive index of less than 1.17 cannot be used.

The refractive index of the hollow silica fine particles was measured with an Abbe's refractometer (by ATAGO Co., Ltd.) Preferably, at least one kind of silica fine particles whose average particle size is less than 25% of the thickness of the low-refractive-index layer (5) (referred to as “silica fine particles of small particle size”) are used in combination with the silica particles having the above described particle size (referred to as “silica fine particles of large particle size”).

The silica fine particles of small particle size can serve as a retaining agent for the silica particles of large particle size because they can reside in the space between the silica particles of large particle size.

When the thickness of the low-refractive-index layer (5) is 100 nm, the average particle size of the silica fine particles of small particle size is preferably 1 nm to 20 nm, more preferably 5 nm to 15 nm and particularly preferably 10 nm to 15 nm. Use of such silica fine particles is preferable in terms of lowering the raw material cost and giving the effect as a retaining agent.

To ensure the dispersion stability of the silica fine particles in the dispersion solution or coating solution, or to enhance the affinity or binding properties of the silica fine particles for the binder components, the silica fine particles may undergo physical surface treatment, such as plasma discharge treatment or corona discharge treatment, or chemical surface treatment by surfactants or coupling agents.

Preferably, the silica fine particles undergo surface treatment using coupling agents. Coupling agents preferably used are, for example, alkoxymetal compounds (e.g. titanium coupling agent and silane coupling agent). Treatment using a silane coupling agent is particularly effective.

The above described coupling agents are used, as surface treatment agents for treating the surface of inorganic filler to be contained in the low-refractive-index layer (5), before preparing a coating solution for the layer. However, preferably the coupling agents are further added, as an additive, to the coating solution at the time of preparing the same.

To decrease the load due to surface treatment, it is preferable that the silica fine particles have been dispersed in a dispersion medium before the surface treatment.

What has been described in connection with the silica fine particles is applicable to other inorganic particles.

As the silane coupling agent, compounds represented by the following chemical formula 11 and/or the derivatives thereof can be used.
(X)n-Si—(OR)m (Chemical Formula 11)

In the above chemical formula 11, X represents an organic functional group and R an alkyl group. Of the silane coupling agents represented by the chemical formula 11, preferable are those which contain a hydroxyl, mercapto, carboxyl, epoxy, alkyl, alkoxysilyl, acyloxy or acylamino group for X. Particularly preferable are silane coupling agents which contain an epoxy, polymerizable acyloxy ((meth)acryloyl) or polymerizable acylamino (e.g. acrylamino and methacrylamino) group. m is an integer of 0 to 3. n is an integer of 1 to 4. The sum of m and n is 4.

Of the compounds represented by the chemical formula 11, particularly preferable are compounds which contain a (meth)acryloyl group, as a crosslinking or polymerizable functional group, for X. Such compounds include: for example, 3-acryloxypropyltrimethoxysilane and 3-methacryloxypropyltrimethoxysilane.

As the slip agent, preferable are fluorine-containing compounds with dimethyl silicone and polysiloxane segment introduced thereinto.

[Other Layers]

The laminated type of antireflection film may further include a moisture barrier layer, antistatic layer, primer layer, substrate layer or protective layer, shield layer, or slip layer. The shield layer is provided so that the film can be shielded from electromagnetic wave or infrared rays.

[Outline of Process for Forming Antireflection Film]

The layers that constitute a multi-layered type of antireflection film can be formed by the coating process such as dip coating, air-knife coating, curtain coating, roller coating, die coating, wire bar coating, gravure coating or extrusion coating (refer to U.S. Pat. No. 2,681,294). Preferably such layers are formed by die coating and more preferably by die coating using a novel die coater described later.

In cases where die coating is employed, coating may be performed for two or more layers simultaneously. Simultaneous coating processes are described in, for example, U.S. Pat. Nos. 2,761,791, 2,941,898, 3,508,947 and 3,526,528 and Yuuji Harazaki, Coating Engineering, 253, Asakura Publishing Co., 1973.

In the antireflection film of the present invention, when foreign matter such as dust or dirt exits, bright spot defects are noticeable because it is produced by laminating at least a high-refractive-index-layer (4) and a low-refractive-index-layer (5). The bright spot defects herein used mean defects visually observed through the reflection of light on the coating film. Such defects can be visually detected by, for example, the operation of painting out the back side of the antireflection film after coating black. The size of visible bright spot defects is generally 50 μm or more. If there exist a number of bright spot defects, the production yield is decreased and a large size of antireflection film cannot be produced.

In the antireflection film of the present invention, the number of bright spot defects is 20/m² or less, preferably 10/m² or less, more preferably 5/m² or less and particularly preferably 1/m² or less.

To continuously produce the antireflection film of the present invention, steps are performed of: continuously delivering a substrate film in a roll; coating and drying a coating solution; curing the coating film; and winding up the substrate film having a cured layer.

A substrate film is continuously delivered from its roll to a clean chamber, where static electricity on the substrate film is removed by an antistatic agent and then foreign matter attached on the substrate film is removed by a duct removing device. Then a coating solution is applied onto the substrate film in a coating chamber provided in the clean chamber and the coated substrate film is conveyed to a drying chamber where it is dried.

The substrate film with a dried coating layer on its surface is delivered from the drying chamber to a radiation curing chamber, where the film is exposed to radiation and the monomer contained in the coating layer is polymerized and cured. The substrate film with a layer having been cure by radiation is then conveyed to a heat curing chamber, where it is heated and the curing the layer is completed. The substrate film with a completely cured layer on its surface is wound up and is again in a roll.

The above described steps may be performed for the respective layers, or the layers can be formed continuously by providing a plurality of coating chambers, drying chambers, radiation curing chambers, and heat curing chambers. From the viewpoint of productivity, it is preferable to form the layers continuously.

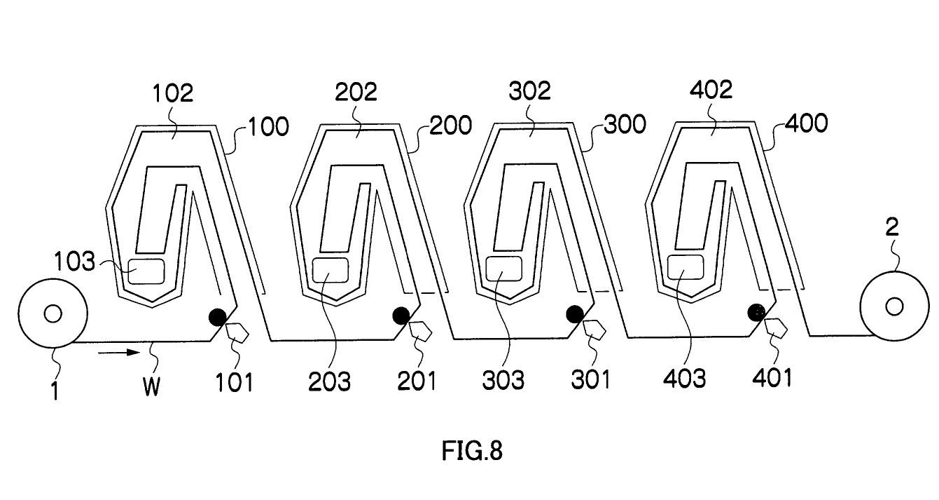

FIG. 8 shows one example of apparatus construction for continuously performing the coating of the layers. The apparatus can include a required number of film forming units (units for forming a coating film on a substrate), 100, 200, 300 and 400 between a delivering device 1, which continuously delivers a substrate film in a roll (hereinafter referred to as web) W, and a winding-up device 2, which winds up the web W.

The apparatus shown in FIG. 8 is a case where coating for 4 layers is continuously performed without winding up the web on the way. It goes without saying that the number of the units can be changed depending on the layer construction of the film.

The film forming units 100 is so constructed that a step 101 of applying a coating solution, a step 102 of drying the applied coating and a step 103 of curing the coating film can be performed on it. The other film forming units 200, 300 and 400 also have the same construction. The steps of applying a coating solution, drying the applied coating and curing the coating film will be described in detail below.

Preferably film forming is performed, using an apparatus in which 3 film forming units are provided, in the steps of: continuously delivering a web W in a roll with a hard coat layer (2) formed on it; performing coating to form an intermediate-refractive-index layer (3), a high-refractive-index layer (4) and a low-refractive-index layer (5) in this order in the respective film forming units; and winding up the coated web. More preferably film forming is performed, using an apparatus shown in FIG. 8 in which 4 film forming units are provided, in the steps of: continuously delivering a web W in a roll; performing coating to form a hard coat layer (2), an intermediate-refractive-index layer (3), a high-refractive-index layer (4) and a low-refractive-index layer (5) in this order in the respective film forming units; and winding up the coated web.

[Pre-preparation before Coating Operation]

To produce an antirefrection film of the present invention in which the number of bright spot defects is reduced, it is necessary to precisely control the dispersion degree of ultra-fine particles with a high refractive index in the coating composition for forming a high-refractive-index layer and perform a microfiltration of the coating solution. At the same time, for the layers that constitute an antireflection layer, preferably, coating in the above described coating section and drying in the above described drying chamber are performed in an atmosphere of air with high cleanness, and besides, dust or dirt on the web W is fully removed before the coating operation.

The degree of air cleanness in the coating and drying steps is preferably class 10 (the number of particles 0.5 μm or more in size is 353/m³ or less) or higher and more preferably class 1 (the number of particles 0.5 μm or more in size is 35.5/m³ or less) or higher, based on the standard for air cleanness stipulated in U.S. standard 209E. Further, preferably the degree of air cleanness is also high in the delivering and winding-up sections—the sections other than those in which the coating/drying steps are performed.

Dust removing processes applicable to the dust removing step as a pre-step for the coating step include: dry dust-removing process such as a process described in Japanese Patent Application Laid-open No. 59-150571 in which a non-woven material or blade is pressed against the web surface; a process described in Japanese Patent Application Laid-open No. 10-309553 in which deposits on the web is removed by blowing air with high cleanness over the web and the removed deposits are sucked through an suction opening and a process described in Japanese Patent Application Laid-open No. 7-333613 in which deposits on the web is removed by blowing compressed air with ultrasonic vibration over the web and the removed deposits are sucked (New Ultra-Cleaner, by Shinko Co., Ltd.).

Examples of dust removing processes also include: wet dust-removing processes such as a process in which the web is introduced into a cleaning bath and deposits on the web is removed with an ultrasonic vibrator; a process described in Japanese Examined Application Publication No. 49-13020 in which a cleaning fluid is supplied to the web, air is blown over the web at high speed to remove deposits on the web and the removed deposits are sucked; and a process described in Japanese Patent Application Laid-open No. 2001-38306 in which the web is rubbed with a wetted roller and a liquid is sprayed over the rubbed surface of the web to remove deposits on the web. Of these dust-removing processes, ultrasonic dust removing or wet dust-removing process are preferable in terms of the dust removing effects.

Before performing the dust-removing step, it is preferable to remove static electricity on the web, because such antistatic cleaning enhances the dust-removing efficiency and prevent dust or dirt from depositing on the web. The antistatic cleaning can be performed using a corona-discharge type of ionizer or a light-irradiation type of ionizer using UV or soft X rays. The static voltage of the substrate film before dust removing and coating is preferably 1000 V or less, more preferably 300 V or less and much more preferably 100 V or less.

In the following the requirements for preparing a coating solution will be described.

[Dispersion Medium for Coating]

When preparing coating solutions for forming the hard coat layer and the low-refractive-index layer of the present invention, the following dispersion media can be used. The dispersion medium used is not limited to any specific one. Either a single dispersion medium alone or two or more kinds of dispersion in the form of a mixture may be used.

Examples of preferred dispersion media include: aromatic hydrocarbons such as toluene, xylene and styrene; chlorinated aromatic hydrocarbons such as chlorobenzene and orth-dichlorobenzene; chlorinated aliphatic hydrocarbons including methane derivatives such as monochloromethane and ethane derivatives such as monochloroethane; alcohols such as methanol, isopropyl alcohol and isobutyl alcohol; esters such as methyl acetate and ethyl acetate; ethers such as ethyl ether and 1,4-dioxane; ketones such as acetone, methyl ethyl ketone, methyl isobutyl ketone and cyclohexanone; glycol ethers such as ethylene glycol monomethyl ether; alicyclic hydrocarbons such as cyclohexanone; aliphatic hydrocarbons such as normal hexane; and the mixture of aliphatic and aromatic hydrocarbons.

Of these solvents, particularly preferable are dispersion media for coating prepared using a single ketone solvent or a mixture of two or more kinds of ketone solvents.

[Physical Properties of Coating Solution]

In the coating process of the present invention, the highest possible coating speed is largely affected by the properties of the coating solution used. Thus, it is necessary to control the physical properties, particularly viscosity and surface tension of the fluid at the instance of coating.

The viscosity of the coating solution is preferably 20.0 mPa·sec or less, more preferably 10.0 mPa·sec or less, much more preferably 5.0 mPa·sec or less and most preferably 2.0 mPa·sec or less.

In some coating solutions, their viscosity varies with shear speed. Thus, the viscosity shown above is the viscosity at a shear speed at the instance of coating. Adding a thixotropic agent to the coating solution is preferable, because the addition of such an agent allows the viscosity at the time of coating, at which high shear force is applied to the coating solution, to be decreased and the viscosity at the time of drying, at which shear force is hardly applied to the coating solution, to be increased, which makes non-uniformity less likely to occur during the drying operation.

The amount of the coating solution applied to the web, though this is not a physical property, also affects the highest possible coating speed. The amount of the coating solution applied to the web is preferably 2.0 to 5.0 ml/m². Increasing the amount of the coating solution applied to the web is preferable, because the highest possible coating speed is enhanced. However, if the amount is too much increased, the loading on drying becomes heavy. Thus, it is preferable to select the optimum amount of the coating solution applied to the web depending on the fluid formulation/the conditions under which the coating step is performed.

The surface tension is preferably in the range of 15 to 36 mN/m. Adding a leveling agent to decrease the surface tension is preferable, because it inhibits non-uniformity from occurring during the drying process. However, if the surface tension is too much decreased, the highest possible coating speed is lowered. Thus, the surface tension is more preferably in the range of 17 to 32 mN/m and much more preferably in the range of 19 to 26 mN/m.

[Filteration]

Preferably the coating solution used undergoes filtration before its application. A filter is preferably used which has the smallest possible pore size within the range that prevents the ingredients in the coating solution from being removed. For the filtration, a filter with an absolute filtration precision of 0.1 to 10 μm is used. Preferably a filter with an absolute filtration precision of 0.1 to 5 μm is used. The thickness of the filter used ie preferably 0.1 to 10 mm and more preferably 0.2 to 2 mm. When using such a filter, preferably filtration is performed at a filtration pressure of 1.5 MPa (15 kgf/cm²) or less, more preferably 1.0 MPa (10 kgf/cm²) or less and much more preferably 0.2 MPa (2 kgf/cm²) or less.

For the filter, any material can be used as long as it does not affect the coating solution. Concrete examples of such materials are the same as those described in connection with the filtration of wet dispersion of inorganic compounds.

Preferably, the filtered coating solution undergoes ultrasonic dispersion so as to aid the deforming of the coating solution and the maintenance of the dispersed state of ingredients to be dispersed.

[Coating Step]

As a process for applying a coating solution to form the layers of the antireflection film, a process using a slot die is. preferably used. A coating process using a slot die is preferable because it makes possible to inhibit the occurrence of film thickness non-uniformity even when coating is performed at high speeds, as described later.

[Construction of Die Coater]

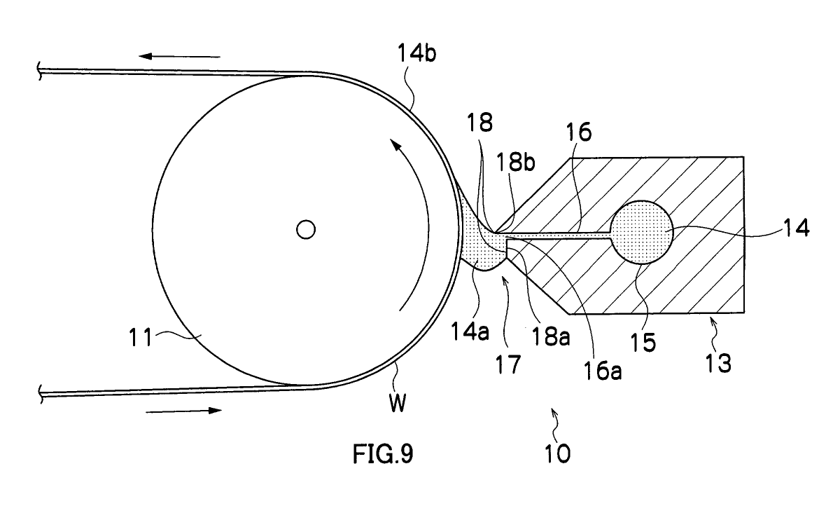

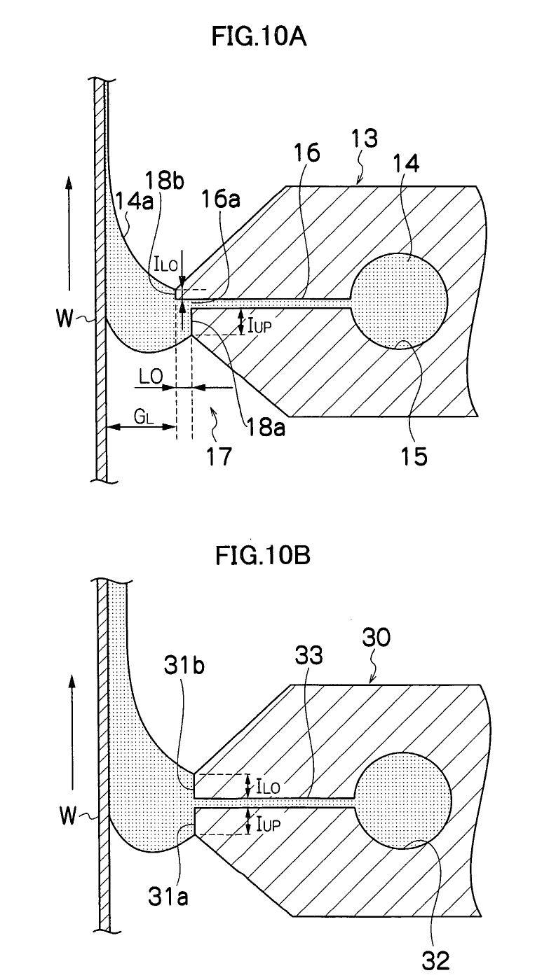

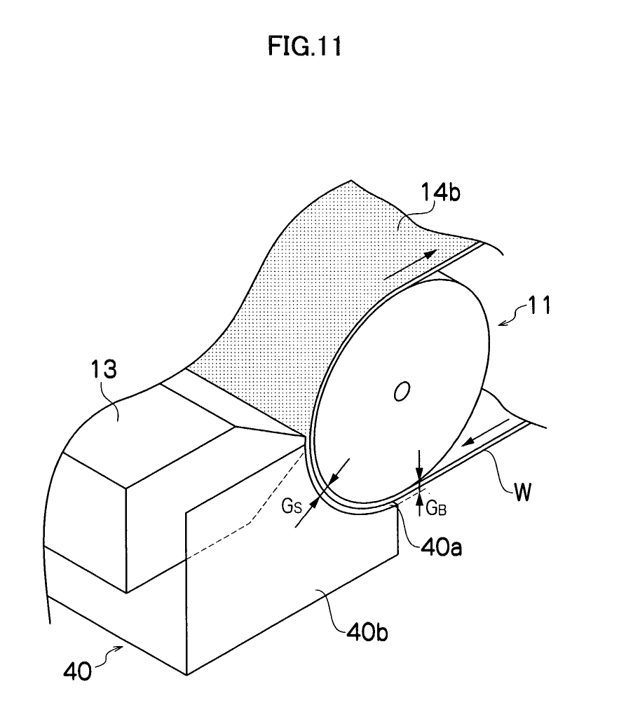

FIG. 9 is a cross-section of a coater employing a slot die in the present invention. A coater 10 applies a coating solution 14 onto a web W, which is continuously running while backed up by a back-up roller 11, to form a coating film 14b on the web W, while extruding the coating solution 14 from a slot die 13 to form a bead 14a.

In the inside of the slot die 13, a pocket 15 and a slot 16 are formed. The pocket 15 has cross-sections made up of a curve and a straight line, which may be approximately circular as shown in FIG. 9 or semicircular. The pocket 15 is a space for reserving a fluid which extends across the width of the slot die 13 while keeping it cross-section in the shape as above. Its effective extension is generally the same as or a little longer than the width of coating.

The coating solution 14 is fed to the pocket 15 from one side of the slot die 13 or from the center portion of the face of the slot die opposite to the opening 16a of the same. The pocket 15 is provided with a stopper which prevents the coating solution 14 from leaking out of the pocket.

The slot 16 is a flow path through which the coating solution 14 flows from the pocket 15 toward the web W, which has a cross-section extending across the width of the slot die 13, like the pocket 15. The width of the opening 16a, which is positioned on the web side of the slot, is regulated using a width-regulator or the like, not shown in the figure, so that it is almost the same as the width of coating. The angle between the slot 16 and the tangent along the length of the running web of the back-up roller 11 at the tip of the slot 16 is preferably 30° to 90°.

The edge lip 17 of the slot die 13 where the opening 16a of the slot 16 is positioned is tapered, and the tip of the tapered lip is a flat portion 18 referred to as land. The portion of the land 18 upstream along the length of the running web W is referred to as upstream land 18a, while the portion of the land 18 downstream along the length of the running web W is referred to as downstream land 18b.

FIGS. 10A and 10B show the cross-section of the slot die 13 and that of a currently used slot die, for comparison. FIG. 10A shows the slot die 13 of the present invention, while FIG. 10B the currently used slot die 30. In the currently used slot die 30, the distance between the upstream lip land 31a and the web W and that between the downstream lip land 31b and the web W is equal. In FIG. 10B, reference numeral 32 denotes a pocket and numeral 33 a slot. In contrast, in the slot die 13 of the present invention, the length of the downstream lip land ILO is decreased, whereby application of wet coating 20 μm or less thick can be performed with high precision.

The land length IUP of the upstream lip land 18a is not limited to any specific length; however, the length in the range of 100 μm to 1 mm is preferably employed. The land length ILO of the downstream lip land 18b is 30 μm to 100 μm, preferably 30 μm to 80 μm and much more preferably 30 μm to 60 μm.

If the land length ILO of the downstream lip is less than 30 μm, the edge or the land of the edge lip 17 is more likely to chip off, which makes lines more likely to occur in the coating film, and hence making it impossible to perform coating. It also makes it difficult to set the position of the wet line downstream, causing a problem of the coating solution's being more likely to spread downstream. It has been well known that the spread of the coating solution downstream means the non-uniformity of wet line, which leads to a problem of causing poor geometries, such as lines, on the coated surface.

In contrast, if the land length ILO of the downstream lip is more than 100 μm, a bead itself cannot be formed, and therefore, it is impossible to perform coating.

The downstream lip land 18b and the upstream lip land 18a form an overbite shape where the downstream lip land 18b is in closer proximity to the web W than the upstream lip land 18a. This makes possible the decrease of vacuum degree, and hence the bead formation suitable for thin film forming. The difference between the distance between downstream lip land 18b and the web W and that between the upstream lip land 18a and the web W (hereinafter referred to as overbite length LO) is preferably 30 μm to 120 μm, preferably 30 μm to 100 μm and most preferably 30 μm to and 80 μm.

When the slot die 13 has an overbite shape, the space GL between the edge lip 17 and the web W shows the space between the land 18b of the downstream lip and the web W.

FIG. 11 is a perspective view showing a slot die and its vicinities used in the coating step of the present invention. To conduct a sufficient vacuum regulation on the bead 14a, a vacuum chamber 40 is provided on the slot die side opposite to the side on which the web W is running at such a position that it does not come in contact with the web W. The vacuum chamber 40 is provided with a back plate 40a and a side plate 40b so as to maintain its working efficiency and there exist spaces GB and GS between the back plate 40a and the web W and between the side plate 40b and the web W, respectively.

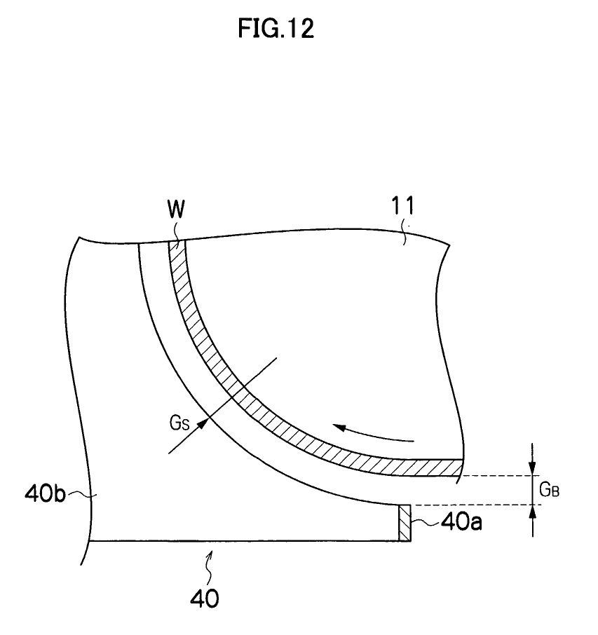

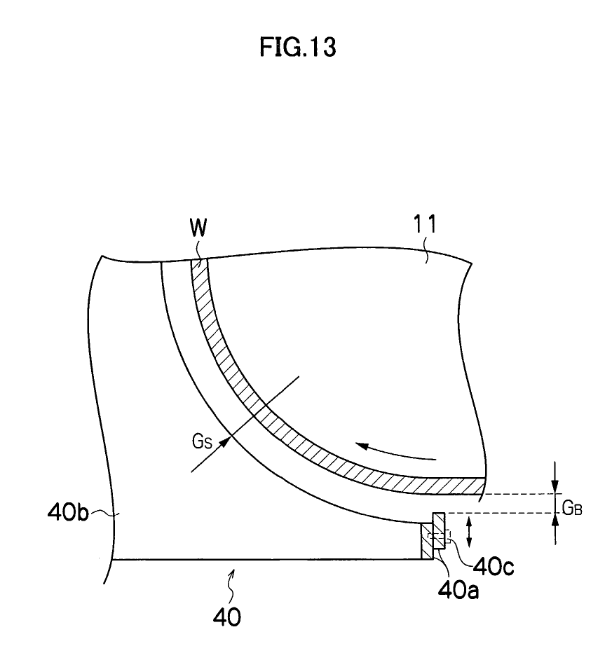

FIGS. 12 and 13 are cross-sections showing the vacuum chamber 40 and the web W in proximity with each other. The side plate 40b and the back plate 40a may be integrated into the chamber body as shown in FIG. 12, or they may be screwed to the chamber body with screws 40c or the like so that the spaces GB and GS are changed appropriately depending on the situation, as shown in FIG. 13.

Whichever structure the vacuum chamber has, the spaces between the back plate 40a and the web W and between the side plate 40b and the web W are defined as GB and GS, respectively. The space GB between the back plate 40a of the vacuum chamber 40 and the web W indicates the space between the top end of the back plate 40a and the web W, when the vacuum chamber 40 is installed below the web W as well as the slot die 13, as shown in FIG. 11.

Preferably, the vacuum chamber 40 is installed so that the space GB between the back plate 40a and the web W is larger than the space GL between the edge lip 17 of the slot die 13 and the web W. This makes it possible to control the change in vacuum degree in the vicinity of the bead caused by the eccentricity of the back-up roller 11.

For example, when the space GL between the edge lip 17 of the slot die 13 and the web W is 30 μm to 100 μm, preferably the space GB between the back plate 40a and the web W is set to 100 μm to 500 μm.

[Material, Precision]

Increase in length, along the length of the web, of the edge lip 17 on the side toward which the web W is running is disadvantageous to the bead formation. And if the length varies between any positions across the width of the slot die, the bead becomes unstable even due to a slight external turbulence. Thus, preferably the length is set so that its variation across the width of the slot die fall within the range of ±20 μm.

If a material such as stainless steel is used for the edge lip 17 of the slot die, it becomes dull at the stage of die processing, as a result, the precision of the edge lip 17 cannot be satisfied even if the length of the edge lip 17 of the slot die along the length of the web is set within the range of 30 to 100 μm.

Accordingly, to maintain high processing precision, it is important to use super hard materials described in, for example, Japanese Patent No. 2817053. Specifically, it is preferable to make up at least the edge lip 17 of the slot die of a super hard alloy produced by binding carbide crystal with an average particle size of 5 μm or less.

Examples of super hard alloys include those produced by binding particles of carbide crystal, such as tungsten carbide (hereinafter referred to as WC), with a binding metal such as cobalt. Other binding metals, such as titanium, tantalum and niobium, and the mixed metals thereof can also be used. The average particle size of WC crystal is preferably 3 μm or less.

To realize coating with high precision, the land length of the edge lip on the side toward which the web is running and the variation in the space across the width of the slot die between the land and the web are important factors. It is desirable to control the combination of these two factors, in other words, to realize the straightness of the edge lip 17 and the back-up roller 11 within the range that can control the width of the variation to some extent. Preferably, the straightness of the edge lip 17 and the back-up roller 11 is realized so that the variation in the above described space falls within the range of 5 μm or less across the width of the slot die.

[Coating Speed]

In the coating process employed in the present invention, since the back-up roller 11 and the edge lip 17 are realized with high precision, the film thickness is highly stable even when coating is performed at high speeds. Further, the coating process employed in the present invention is of pre-metering type, thereby making it easy to ensure stable film thickness even when coating is performed at high speeds.

The coating process employed in the present invention enables high-speed coating, while ensuring stable film thickness, even for such coating solutions that are applied only in small amounts, just like the coating solution used for producing the antireflection film of the present invention. Other coating processes can also be employed; however, in the dip coating, vibration of. the coating solution in the fluid receiving tank is unavoidable, whereby step-like non-uniformity is likely to occur. In the reverse-roll coating or microgravure coating, the eccentricity or deflection of the coating-related roll makes step-like non-uniformity more likely to occur.

Further, in the microgravure coating process, non-uniformity in the amount of coating is likely to occur depending on the precision with which the gravure roll has been made or on the change in the roll and the blade with time caused by their hitting each other. In addition, since these coating processes are of post-metering type, it is relatively hard to ensure stable film thickness. When employing the production process of the present invention, it is preferable, from the viewpoint of productivity, to perform coating at a speed of 25 m/min or higher.

[Drying Step]

In typical processes for controlling drying speed, a drying zone is provided right after a coater and a drying step is provided of drying a wet coating right after the coating step while controlling the drying speed by controlling the environment in the drying zone. In the following, the process for controlling drying speed will be described by several typical examples.

For example, Japanese Patent Application Laid-open No. 9-73016 describes a process that includes a drying step of drying a wet coating right after the coating step, while controlling the moving speed of the gas on the wet coating surface so that the relative speed of the moving gas to the wet coating being conveyed is −0.1 m/sec or higher and 0.1 m/sec or lower. The drying speed can be controlled by warming-up or cooling the wet coating.

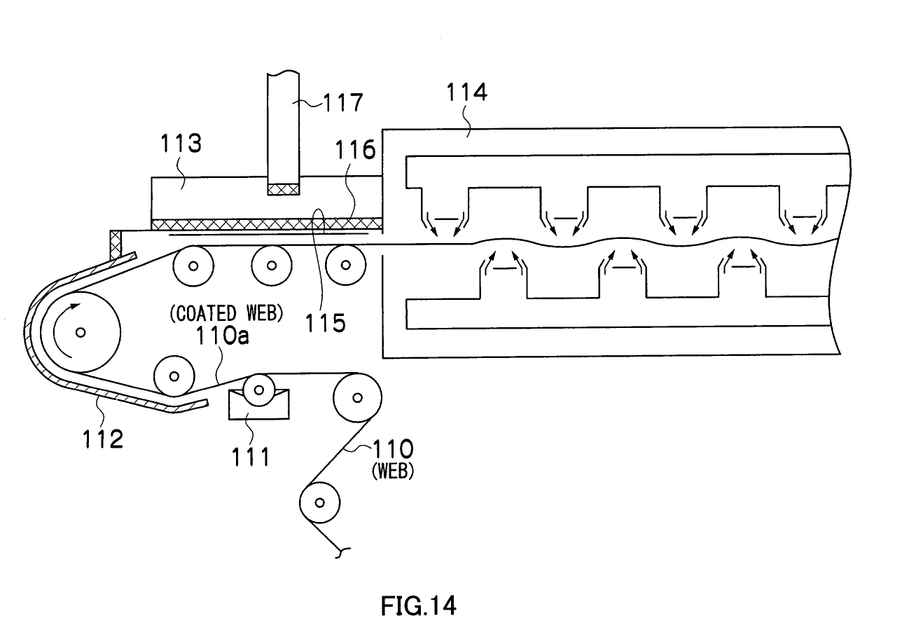

One example of the above described drying step will be described in detail with reference to FIG. 14. A coating film is formed by applying a coating solution onto a web 110 with a coater 111, while conveying the web 110. In FIG. 14, a wire bar coater is shown as one example of coaters; however, the coater applicable to the present invention is not limited to the wire bar coater. The web having a coating film on its surface (hereinafter referred to as coated web) 110a is conveyed along a rectifying plate 112 to a drying zone 113 and then to a heating zone 114. In the heating zone 114, drying is also conducted to evaporate the residual solvent. In the present invention, drying is performed, right after the coating operation until the web enters the heating zone 114, while avoiding blowing air on the coating film as much as possible. In other words, air from the air inlet of the coating chamber (the velocity and direction of the air are almost the same as those of the film being conveyed) is introduced through the wire cloth 116 in the drying zone 113 after the coated web have passed along the rectifying plate 112. The air from the air inlet of the coating chamber is exhausted not only from the air exit of the coating chamber, but from the drying zone 113 through the outlet 117 through a porous plate 115 and a wire cloth 116. Providing such wire cloth and porous plate makes rapid changes in air velocity and air direction hard to occur.

Typically, the space between the rectifying plate 112 and the coated web 111a is 1 mm to 10 mm. The length of the rectifying plate 112 is preferably 1 m to 15 m. The temperature of the drying zone 113 is preferably 10° C. to 50° C. At the time of drying, preferable air is blown (in other words, a gaseous layer is moved) over the wet coating at a velocity, relative to the moving speed (conveyed speed) of the coated web 111a, of −0.1 m/sec or higher and 0.1 m/sec or lower by setting the conditions of the drying zone 113 as above.

Japanese Patent Application Laid-open No. 2001-170547 describes a process, as shown below, which is also suitably used in the present invention. In this process, a drying zone is provided in coating equipment in such a manner that it surrounds a wet coating surface, and drying air is generated which flows in one direction from one side of a continuous strip substrate toward the other side of the same across the width of the continuous strip substrate. The drying air contains gas of a solvent which is the same kind as that of the dispersion medium contained in the coating. The drying speed can be controlled by controlling the air velocity and the amount of the gaceous solvent contained in the air. If the above described drying zone is divided into a plurality zones and the air velocity and the amount of the gaceous solvent contained in the air, which flows in one direction across the width of the continuous strip substrate as described above in each divided zone, is controlled, the drying speed can be controlled more delicately.

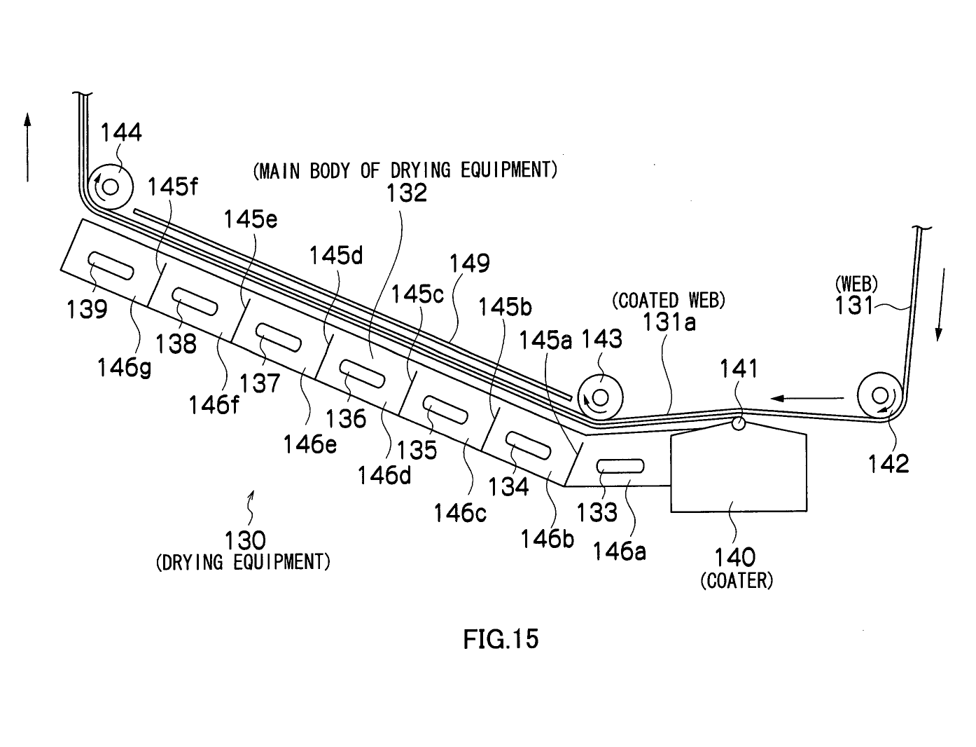

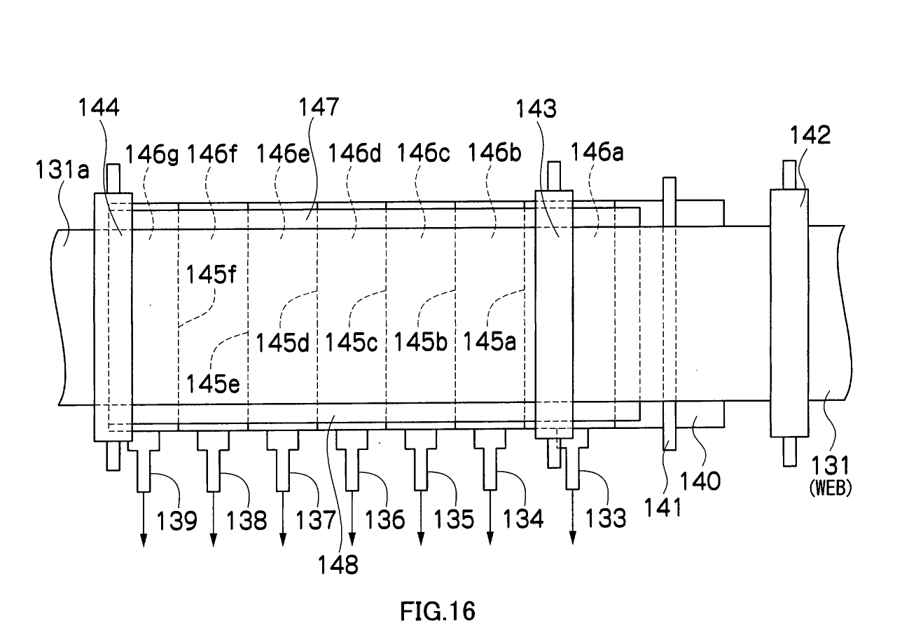

FIG. 15 is a side view of one example of the drying equipment 130 used in the present invention and FIG. 16 is a plan view of the equipment 130 shown in FIG. 15 viewing from the above.

The drying equipment 130 for drying a wet coating shown in FIGS. 15 and 16 includes: a drying equipment body 132 that forms a drying zone, which a continuously running web 131 is passed through so that the wet coating on the web is dried; and unidirectional air flow generating pipes 133 to 139 for generating dried air which flows in one direction from one side of the web 131 toward the other side of the same across the width of the web 131 in the drying zone. The drying equipment 130 is provided right after a coater 140 which applies a coating solution containing an organic solvent onto the continuously running web 131.

As the coater 140, for example, a bar coater equipped with a wire bar 141 can be used. A coating. solution is applied onto the underside of the web 131, which is continuously running while backed up with a plurality of back-up rollers 142, 143 and 144, to form a wet coating. In FIGS. 15 and 16, a wire bar coater is shown as one example of coaters; however, the coater applicable to the present invention is not limited to the wire bar coater.

The drying equipment body 132 is provided right after the coater 140 and formed into a cuboidal casing-like shape along the surface-with-a-coating side of the running web 131 (the under side of the web) where of the sides of the casing, the side on the coated surface side (the upper side of the casing) is removed. Thus, a drying zone is formed which surrounds the coated surface, as an object to be dried, of the running coated web 131a. The drying zone is divided into a plurality of drying zones 146a to 146g (in the present invention 7 divided zones) if the drying equipment body 132 is divided with a plurality of dividers 145a to 145f perpendicular to the running coated web 131a. In this case, the distance between the upper end of each of the divider 145a to 145f which divide the drying equipment body 132 into a plurality of drying zones 146a to 146g and the surface of the coating formed on the coated web 131a is preferably in the range of 0.5 mm to 12 mm and more preferably in the range of 1 mm to 10 mm. In the drying zones 146a to 146g, unidirectional air flow generating means 133 to 139 (refer to FIG. 16) are provided, respectively.

Each of the unidirectional air flow generating means 133 to 139 is made up mainly of: an air inlet formed on one side of the drying equipment body 132; an air exit formed, opposite to the air inlet, on the other side of the drying equipment body 132; and exhaust means connected to the air exit. Once the exhaust means is driven, air drawn from the air inlet to each of the drying zone 146a to 146g is exhausted from the air exit, and thus, drying air that flows in one direction, from one end side (the air inlet side) of the coated web 131a toward the other end side (the air exit side) of the same across the width of the coated web 131a, is generated. The unidirectional air flow generating means 133 to 139 are so designed that the amount of exhaust can be controlled independently by the exhaust means for each drying zone 146a to 146g. The drying air drawn from each air inlet is preferably conditioned air whose temperature/humidity has been conditioned. Further, preferably, the drying air drawn from each air inlet contains gas of the dispersion medium of the coating solution at a controlled concentration.

The drying equipment body 132 is formed to have a width larger than that of the web 131 and have air-flow straightening portions, which are produced by covering the open portion on both sides of the drying zones 146a to 146g with air-rectifying plates 147 and 148. This air-flow straightening portions ensure the distance from each air inlet to the coating film end and the distance from the coating film end to each air exit, and at the same time, they make drying air easier to draw from each air inlet alone so that rapid flow of drying air should not be created in the drying zones 146a to 146g. The length of the air-flow straightening portions, or of the air-rectifying plates 147, 148 are preferably in the range of 50 mm to 150 mm for both air-inlet side and air-exit side.

Of the drying zones 146a to 146g, particularly for the drying zone 146a, which is closest to the coater 140, it is important to prevent fresh air, such as conditioned air described above, outside the drying zone 146a from entering the drying zone 146a immediately after the application of the coating solution. To realize this, it is preferable that the divided drying zone 146a is arranged adjacent to the coater 140 or not only the positions of the above described air-rectifying plates 147, 148, but the positions of the wire bar 141 of the coater 140 and the back-up roller 143 are adjusted so that the web 131 runs very close to the drying zone 146a as if the coated web 131a cover the open portion of the drying one 146a. It is also preferable to provide a shield plate 149 on the opposite side of the coated web 131a to the drying equipment body 132 so that the stable running of the coated web 131a should not be inhibited by air such as the above described conditioned air.

Japanese Patent Application Laid-open No. 2003-93954 discloses a process in which a drying zone is provided right after a coater as in Japanese Patent Application Laid-open No. 2001-170547 and air-rectifying plates with a plurality of holes are provided so as to face the surface of the coating film, and the drying speed is controlled by controlling the opening rate of the holes and the space between the coating film and the air-rectifying plates.

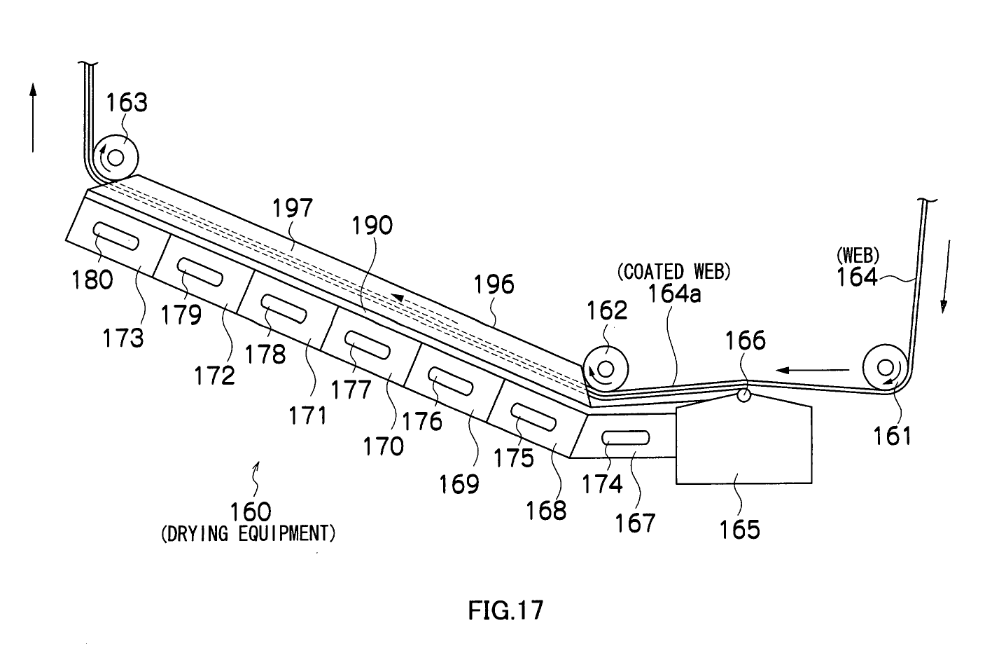

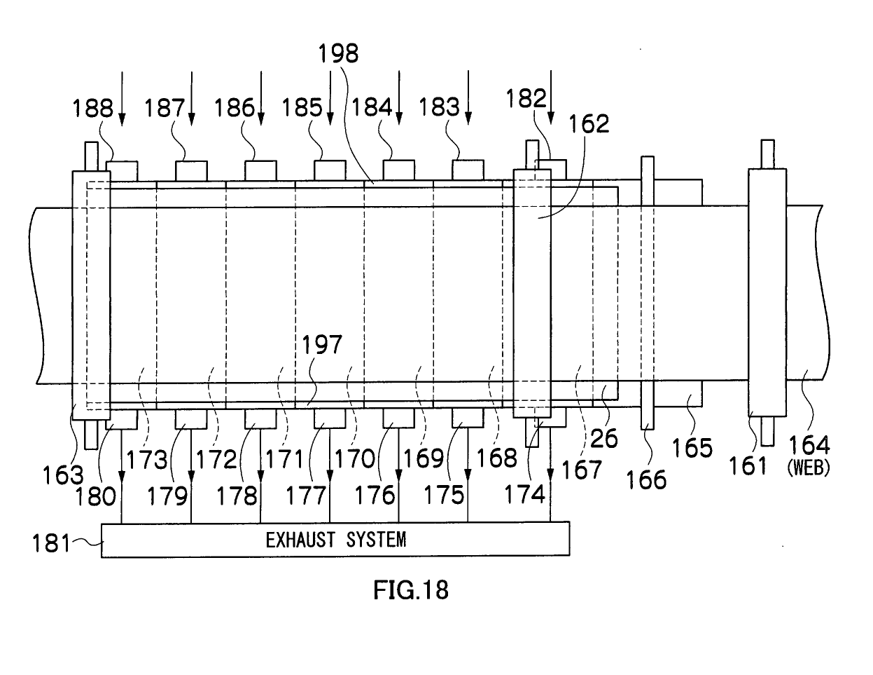

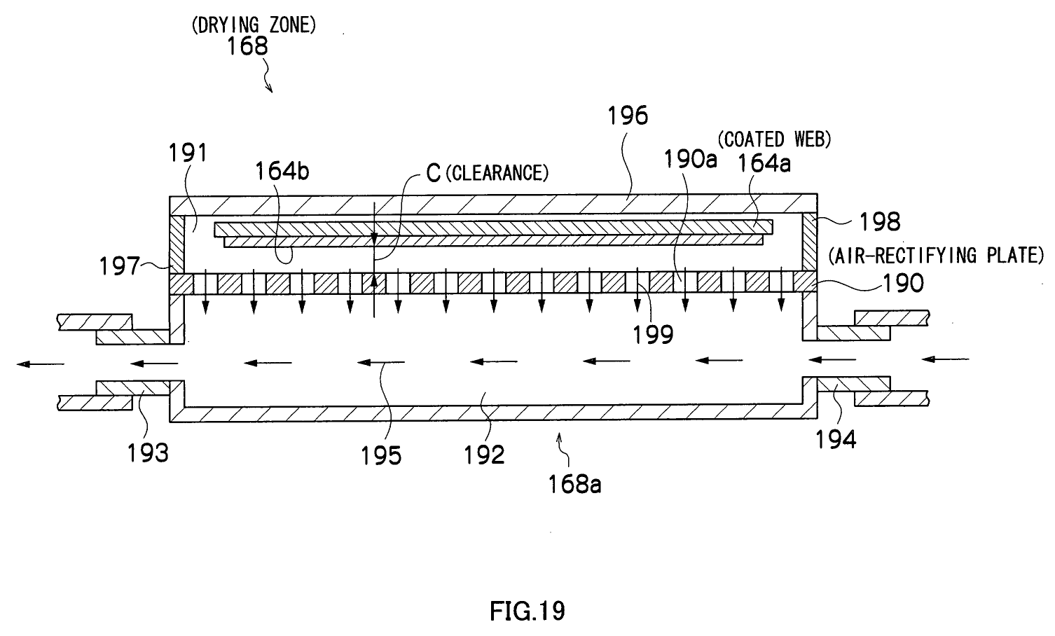

FIG. 17 is a side view of one example of drying equipment 160 used in the present invention, FIG. 18 is a plan view of the equipment shown in FIG. 17, and FIG. 19 is a cross-sectional view of the main part of the drying equipment 160 shown in FIG. 17. In FIG. 18, an upper cover, as described later, is removed.

The drying equipment 160 dries the wet coating having been formed by applying a coating solution onto a web 164, which is running while backed up by conveying rollers 161, 162 and 163, with a wire bar 166 of a coater 165.

The web on which a coating is formed is referred to as coated web 164a. The drying equipment 160 is used to dry the coating on the web. and is made up of 7 divided drying zones 167, 168, 169, 170, 171, 172 and 173. In FIGS. 17, 18 and 19, a wire bar coater is shown as one example of coaters; however, the coater used in the present invention is not limited to the wire bar coater. A coating film is formed on the web 164a by the gas of the organic solvent in the coating solution while the web passes through the drying zones 167 to 173.

As shown in FIG. 18, air exits 174, 175, 176, 177, 178, 179 and 180 are provided on one side of the drying zones 167 to 173 and connected to an exhaust device 181. The exhaust device 181 allows the air exits 174 to 180 to exhaust air independently. On the other side of the drying zones 167 to 173, ventilation ports 182, 183, 184, 185, 186, 187 and 188 are provided so that atmosphere (may be air or other gases) can enter the drying zones. Each air exit and ventilation port is provided with both exhaust pipe and intake pipe (neither is shown in the figure).

FIG. 19 is a cross-section of the drying zone 168, of the 7 divided drying zones. The drying zone 168 is provided with a drying zone body 168a and an air-rectifying plate 190. The drying zone body 168a includes: a passage chamber 191 through which the web 164 is allowed to pass; and an exhaust chamber 192 through which gas of an evaporated solvent is exhausted. The air-rectifying plate 190 is provided so as to separate the passage chamber 191 from the exhaust chamber 192. In the exhaust chamber 192, an exhaust pipe 193 and an intake pipe 194 are provided, and air (or other gases) is fed to the exhaust chamber 192 through the intake pipe 194. The intake pipe 194 and the exhaust pipe 193 are provided across the width of the web 164, whereby air flows across the width of the web 164 to form air flow 195.

The opening rate and material of the air-rectifying plate 190 are not particularly limited. However, wire cloth or punching metal having an opening rate of 50% or less is preferably used as the air-rectifying plate 190 and that having an opening rate of 20% to 40% is preferably used. Particularly, 300-mesh wire cloth having an opening rate of 30% can be used. If the clearance between the coating surface 164b and the air-rectifying plate 190 is large, swirls of air are generated, which results in occurrence of non-uniformity in the coating surface 164b. So then, to control the flow of air, the clearance C between the coating surface 164b and the air-rectifying plate 190 is preferably 3 mm to 30 mm and more preferably 5 mm to 15 mm. To inhibit the flow of unnecessary air from the back side of the web 164 (the surface on which no coating is applied) and the sides of the same, an upper cover 196, as a sealing member, and side seals 197 and 198 are provided. Although wire cloth is used as the air-rectifying plate 190 to control the opening rate, punch metal can also be used to determine the opening rate. According the above described drying step, the gas 199 of the organic solvent having been contained in the coating film (normally, vaporized solvent is contained at a high concentration) passes through holes 190a of the air-rectifying plate 190, exhausted through the exhaust pipe 193 uniformly across the width of the web by drying air 195 in the exhaust chamber 192 which extends on the opposite side of the air-rectifying plate 190 to the coating surface 164b and discharged out of the drying zone 168. Thus, air does not come in contact with the coating surface 164b, which prevents the occurrence of non-uniformity on the surface 164b.

As shown in FIG. 17, it is important to provide the drying zone 167 right after the application of a coating solution onto the web 164 so that fresh conditioned air of the coating chamber should not enter the drying equipment 160.

Japanese Patent Application Laid-open No. 2003-106767 discloses a process which enables the prevention of film thickness non-uniformity due to drying step from occurring by: providing a condenser plate as plate-like member, right after the coating step, almost in parallel with the web's running position; and arranging drying equipment for condensing and recovering the solvent in a coating solution while controlling the distance between the condenser plate and the coating film or the temperature of the condenser plate. This process is also applicable to the present invention.

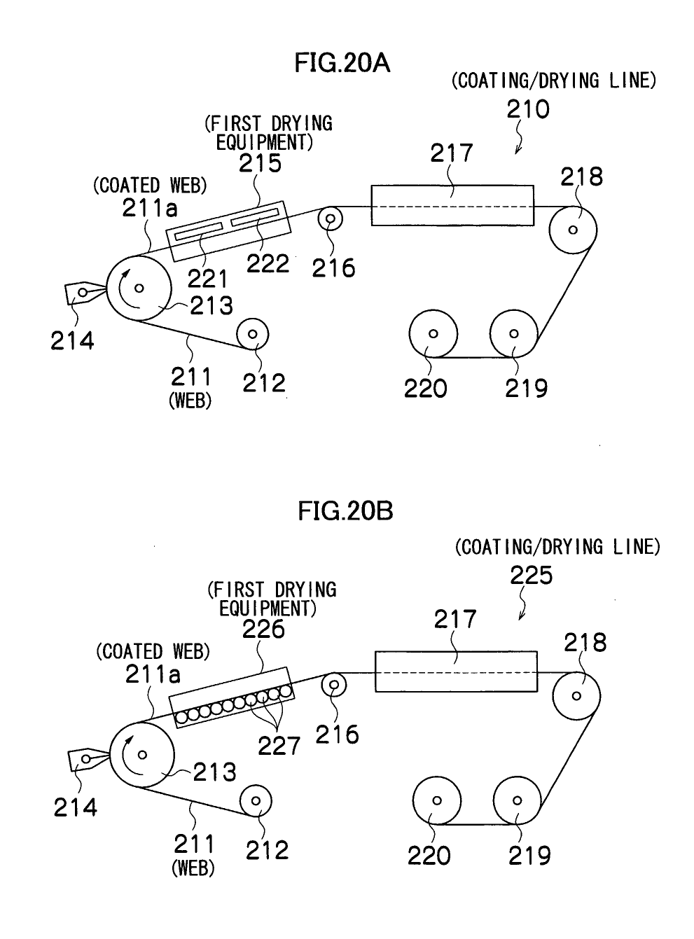

FIG. 20A is a schematic diagram showing one example of coating/drying line 210 for embodying the process for drying a coating film in accordance with the present invention. The coating/drying line is made up of: a delivery device 212 for delivering a web 211, a back-up roller 213, a coating die 214, first drying equipment 215, a roller 216, second drying equipment 217, rollers 218 and 219, and a roll-up device 220. The web 211 is delivered from the delivery device 212. A coating solution is applied onto the web 211, which is conveyed while being wound on the back-up roller 213, with the coating die 214 to produce a coated web 211a.

The first drying equipment 215 is made up of: condenser plates 221, 222 which are provided in parallel with the web 211 with a specified space left between themselves and the web 211; and a side plate which hangs from the position in front of and behind the condenser plates 221, 222. With this construction, when the solvent in the coating film is evaporated, the evaporated solvent is condensed on and recovered by the condenser plates 221, 222.

In the first drying equipment 215, the coating surface of the web 211 and the condenser plates 221, 222 forms a space, just like a space held between two plates. The solvent is evaporated within the space and the evaporated solvent is recovered by the condensation surface of the condenser plates 221, 222. To perform drying which provides a uniform coating surface, it is necessary to form a boundary layer free from disorder between the coating surface and the condenser plates 213, 214 and realize a uniform mass transfer and thermal transfer.

However, it is generally known that between two plain surfaces different in temperature as in the above drying equipment for coating films, natural heat convection occurs, which inhibits uniform thermal transfer. Once natural thermal convection occurs, the boundary layer is made unstable and put into disorder, which causes non-uniform drying speed distribution. As a result, the coating film cannot be uniformly dried.

Studies of natural convection have long been performed. For example, Max Jacob, Heat Transfer, vol. 1, John Wiley & Sons, 1953, presents various experimental studies on natural convention. The society of chemical Engineers, Japan (edit), A Handbook of Chemistry, Maruzen, presents a collection of studies on natural convection.

These studies relate to vertical flat plates, horizontal square plates, inclined flat plates, horizontal cylinder faces, inclined cylinder faces, spaces between vertical flat plates, spaces between horizontal flat plates, or the like. As is evident from these studies, the geometry of the solid surface affects largely the amount of heat transfer.

These studies, however, relate mainly to plates or cylinders which are simply put in air. In contrast, there are a very small number of studies on natural convection occurring between two planes which include a plane which is continuously running and onto which a coating solution has been applied. Conditions have not been clarified yet under which natural convection is inhibited and a uniform boundary layer is formed. Because natural convection is convection that is caused by buoyancy of fluid mass, the ratio of viscosity to buoyancy, the ratio of thermal diffusivity to momentum diffusivity, etc, are important factors. The dimensionless numbers representing these factors are expressed by the following equations.
Grashof number=[thermal expansion coefficient×(T₁−T₂)×L³×d²×g]/δ² Equation (11)
Prandtle number=(specific thermal capacity×δ)/thermal co nductivity Equation (12)

Generally, equation (11) is referred to as Grashof number and equation (12) as Prandtle number. On the relationship between these values and the occurrence of natural convex, experimental equations are given for only special cases. The product of these two dimensionless numbers is referred to as Rayleigh number.

In the coating/drying line 210 for embodying the coating process in accordance with the present invention, if the distance between the web 211 and the condenser plates 221, 222 and the temperatures of the condenser plates 221, 222 and coating film are established so that Rayleigh number is less than 5000, a satisfactory coating film, which is free from non-uniformity on drying, can be obtained independent of the kind of the solvent in the coating solution used, the shape of the condenser plates 221, 222 used, the angle at which the condenser plates 221, 222 are arranged and the angle at which the web 211 runs. If the above described conditions are established so that Rayleigh number is less than 2000, the surface characteristics of the coating film is further improved.

The materials used for the face of the condenser plates 221, 222 on which a solvent is to be condensed include: for example, not limited to, metals plastics and woods. When a coating solution contains an organic solvent, it is preferable to use a material resistant to such an organic solvent or apply a coating onto the surface of the material used.

In the first drying equipment 215, means for allowing the condenser plates 221, 222 to recover the condensed solvent include, for example, grooving the faces of the condenser plates 221, 222 on which the solvent is to be condensed and utilizing capillary force to recover the solvent. The direction in which the faces of the condenser plates 221, 222 are grooved may be the same as or perpendicular to the direction in which the web 211 is running. When the condenser plates 221, 222 are inclined, the faces can be grooved in the direction which makes easy the recovery of the solvent.

FIG. 20B shows another embodiment of coating/drying line 225. The same parts as those of the coating/drying line 210 shown in FIG. 20A are denoted by the same reference numeral and the description of such parts is omitted. The first drying equipment 226 of the coating/drying line 225 is provided with a number of temperature controlling rollers 227 capable of controlling temperature. The temperature of the coating surface of a coated web 221a is controlled by controlling the temperature of the temperature controlling rollers 227, whereby the amount of the organic solvent evaporated from the coating film is made a desired one.

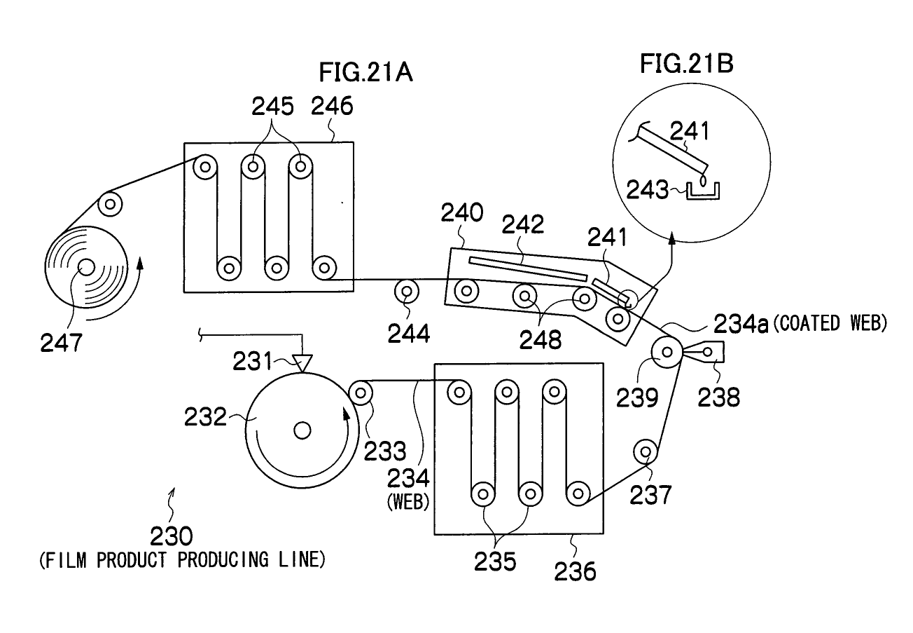

FIG. 21A shows a film-product production line 230 to which the process for producing a coating film of the present invention is applied. A prepared dope is cast from a cast die 231 over a rotating drum 232 to form a cast film. Once the cast film has attained self supporting properties, the cast film is stripped off, while backed up by a strip roller 233, as a web 234. The web 234 is conveyed to the above described drying chamber 226 provided with a number of rollers 235 where it is dried until the amount of the solvent contained in it is a desired one. Then the dried web 234 is conveyed to a coating die 238 by a roller 237. Coating equipment is made up of the coating die 238 and a back-up roller 239 provided so as to face the web 234. A coating solution is applied onto the web 234, which is conveyed while wound on the back-up roller 239, by a coating die 238 to produce a coated web 234a on which a wet coating has been formed.

The coated web 234a is conveyed to drying equipment 240 where it is dried until the amount of the solvent contained in the coating film is a desired one. The drying equipment 240 is provided with condenser plates 241, 242, which condense and recover the gas of the organic solvent evaporated from the coating film. On the lower portion of the right end of the condenser plate 241, a tub 243 for collecting the condensed solvent is provided. The solvent is recovered via the tub 243.

The coated web 234a delivered from the drying equipment 240 is conveyed by a roller 244 to a post-drying chamber 246, which is provided with a number of rollers 245, where it is dried until the amount of the solvent contained in it is a desired one. Lastly, the coated web 234a is wound up by a wind-up device 247.

The drying equipment 240 may have a construction, other than the one employing the condenser plate 241, which employs, for example, a porous plate, net, drainboard or roll, instead of the condenser plate 241. The drying equipment may also be used in combination with a recovery device described in U.S. Pat. No. 5,694,701.

To prevent the occurrence of non-uniformity on drying in the coating film due to the natural convection right after applying the coating solution, preferably the drying equipment 240 is arranged as close as possible to the coating die 238. Specifically, preferably the drying equipment 240 is arranged so that its entrance is located a distance of 5 m or less from the coating die 238, more preferably a distance of 2 m or less and most preferably a distance of 0.7 m or less. The length of the drying equipment 240 is desirably such that it allows the coating film after coating to stay in it for 2 seconds or longer, more preferably for 3 seconds or longer and most preferably for 5 seconds or longer.

For the same reason, the running speed of the web 234 is preferably such that it allows the web 234 to reach the drying equipment 240 within 30 seconds after the coating is performed with the coating die 238 and more preferably within 20 seconds after the coating is performed with the coating die 238.

The larger the amount of the coating solution applied and the thickness of the coating film formed become, the more likely the flow becomes to occur in the inside of the coating film. However, if the above described coating equipment 240 is used, sufficient effect can be obtained even when the amount of the coating solution applied and the thickness of the coating film formed are large. When the thickness of the coating film is 0.001 mm to 0.08 mm (1 μm to 80 μm), drying can be performed while avoiding occurrence of non-uniformity and efficiently.

If the running speed of the web 234 is too high, the boundary layer near the coating film is put into disorder by the entrained air, which has harmful effects on the coating film. Accordingly, preferably the running speed of the web 234 is set to 1 m/min to 100 m/min and more preferably to 5 m/min to 80 m/min.

Since non-uniformity in the coating film is likely to occur at the beginning of the drying step, preferably 70% or more of the solvent in the coating solution is condensed and recovered in the drying equipment 240 and the rest is dried in the post-drying chamber 246. How many % of the solvent in the coating solution should be condensed and recovered can be determined considering all the factors: the effect of the coating film on non-uniformity on drying, production efficiency, etc.

To accelerate the evaporation and condensation of the solvent in the coating solution, preferably the coated web 234a is heated or the condenser plates 241m 242 are cooled or both means are employed. For example, the drying equipment 240 can have cooling means and heating means, which is arranged on the side of the coated web 234a on which no coating is applied.

In either case, to control the drying speed of the coating film, it is preferable to control the temperature of the condenser plates 241, 242. The condenser plates 241, 242 should be so designed that its temperature can be controlled. And when intending to cool them, equipment for cooling needs to be installed in the drying equipment 240. For cooling, water-cooling heat exchange type equipment using a cooling medium, air-cooling type one using air, and one using electricity, for example, using a Peltier device can be employed.

When intending to heat the coated web 234a, heating can be performed by arranging a heater on the side of the web on which no coating is applied. Heating can also be performed by arranging a conveyance roll capable of heating (heating roll). Alternatively, an infrared heater or microwave heating means can also be used.

When determining the temperatures of the coated web 234a and condenser plates 241, 242, care should be taken not to allow the evaporated solvent to condense on the places other than the condenser plates 241, 242, such as the surface of the conveyance roll. This type of condensation is avoidable if the temperatures of the places other than the condenser plates 241, 242 are kept higher than those of the condenser plates 241, 242.

The distance (space) between the surface of the coating film and that of the condenser plates 241, 242 needs to be adjusted to a proper one, considering the desired coating-film drying speed. If the distance is small, the drying speed is upped, but the drying speed is more likely to be affected by the precision of the distance established. If the distance is too large, not only the drying speed is significantly decreased, but natural convection due to heat occurs, causing non-uniformity on drying.

The distance between the surface of the coating film and that of the condenser plates 241, 242 needs to be determined so that it falls within the range that satisfies the requirement: Rayleigh number, as the product of Grashof number expressed by equation (11) and Prandtle number expressed by equation (12), is less than 5000. Preferably, the distance is adjusted to fall within the range of 0.1 mm to 200 mm, more preferably 0.5 mm to 100 mm and most preferably 5 mm to 10 mm.

In the inside of the drying equipment 240, optionally a number of guide rollers 248 are provided on the opposite side of the coated web 234a to the condenser plates 241, 242.

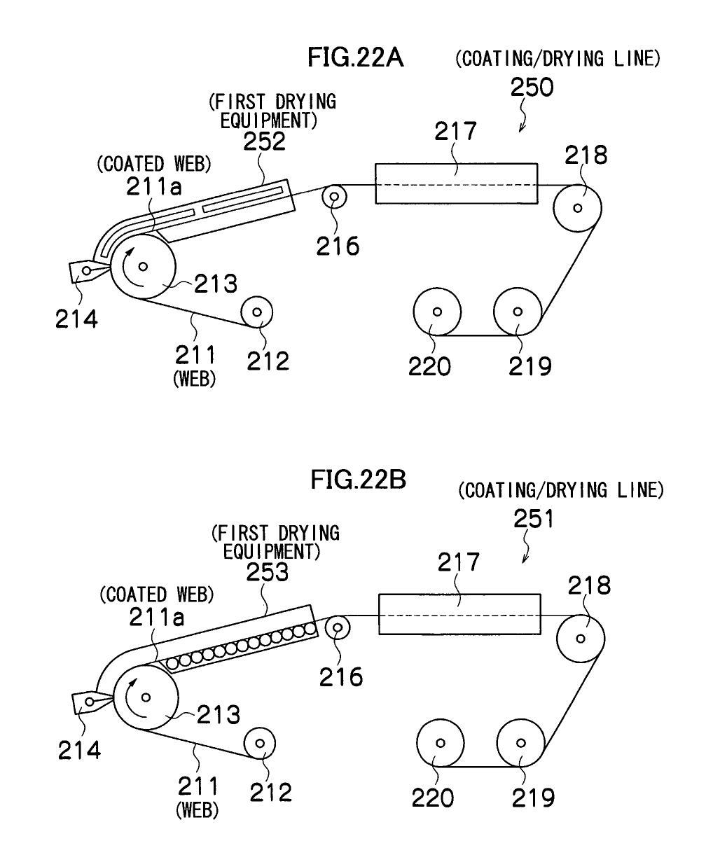

The first drying equipment does not necessarily take the rectilinear form as shown in FIGS. 20A and 20B. It may take the circular-arc form like the first drying equipment 252, 253 shown in the coating/drying lines 250, 251 of FIGS. 22A, 22B. The first drying equipment may be made up of: a large drum; and a drier arranged therein. The same parts as those of the coating/drying line of FIGS. 20A and 20B are denoted by the same reference numerals and the description thereof is omitted. In the coating/drying lines 250, 251 of FIGS. 22A and 22B, the first drying equipment 252, 253 in the form of a circular arc are arranged close to the coating die 214 so as to enhance the efficiency of recovering the solvent.

As the second drying equipment 217, conventionally used roller conveying dryer type or air floating dryer type of equipment can be used. These two types of equipment are common in that the coating film is dried by dried air fed onto the surface of the coating film.

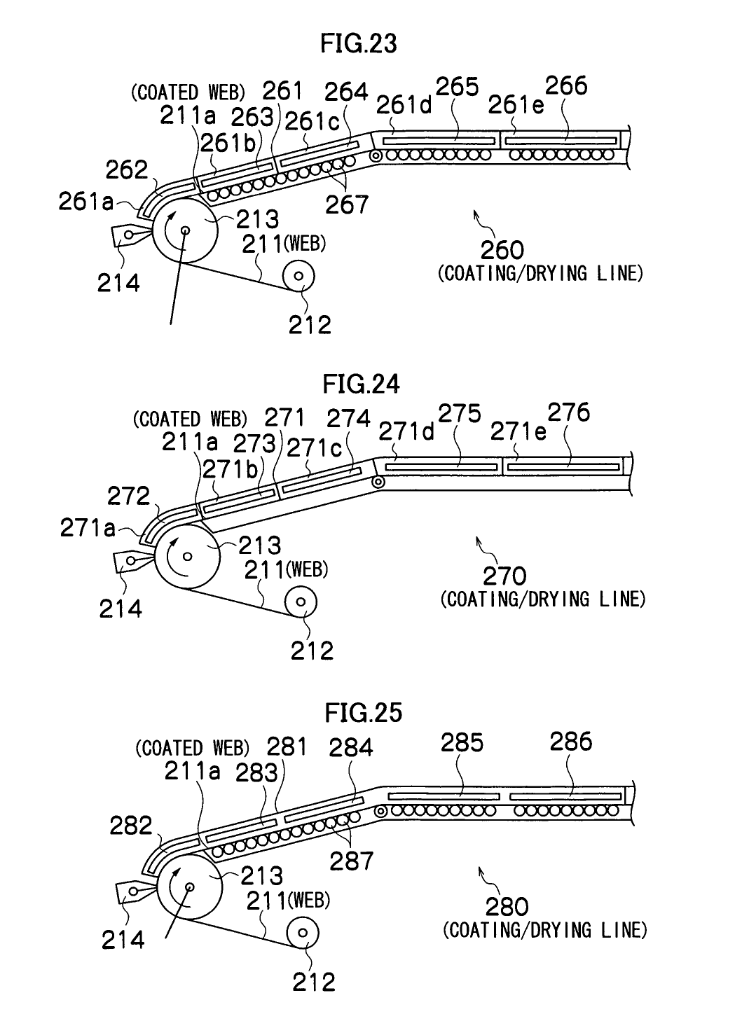

A process can also be selected in which the second drying equipment is not provided and drying the coating film is performed only with the first drying equipment. Examples of drying equipment having such a construction are shown in FIGS. 23, 24 and 25. In the FIGS. 23, 24 and 25, the same parts as those of the coating/drying line of FIGS. 20A and 20B are denoted by the same reference numerals and the description thereof is omitted. Each of FIGS. 23, 24 and 25 shows the main part of the coating/drying line.

In the coating/drying line 260 of FIG. 23, the first drying equipment 261 is divided into a plurality of zones 261a, 261b, 261c, 261d and 261e. The zones 261a to 261e are so constructed that the distance between the condenser plate 262, 263, 264, 265, 266 and the coating film is gradually changed. Further, a number of guide rollers 267 are provided on the opposite side of the web 211a to the condenser plates 262 to 266.

In the coating/drying line 270 of FIG. 24, the first drying equipment 271 is divided into a plurality of zones 271a to 271e. The zones 271a to 271e are so constructed that the distance between the condenser plate 272 to 276 and the coating film is gradually changed. No guide roller is provided.

In the coating/drying line 280 of FIG. 25, the first drying equipment 281 is not divided into a plurality of zones. The distance between the condenser plate 282 to 286 and the coating film is fixed. A number of guide rollers 287 are provided on the opposite side of the web 211a to the condenser plates 282 to 286.

[Step of Curing Coated Film]

In the present invention, preferably the layers constituting an antireflection film are cured by the crosslinking reaction or polymerization reaction caused by exposing the respective layers to light or electron beam or by heating the same at the same time or after the application of the coating composition.

When the layers constituting an antireflection film are formed by crosslinkng reaction or polymerization reaction of ionizing radiation curable compounds, preferably such crosslinkng reaction or polymerization reaction is performed in the atmosphere where oxygen concentration is 10% by volume or less. Forming the layers in the atmosphere where oxygen concentration is 10% by volume or less makes it possible to produce the outermost layer having excellent physical strength and chemical resistance.

Preferably the oxygen concentration is 5% by volume or less, more preferably 1% by volume or less, particularly preferably 0.5% by volume or less and most preferably 0.1% by volume or less.

To keep the oxygen concentration 10% by volume or less, preferably the atmosphere (with a nitrogen concentration of about 79% by volume and an oxygen concentration of about 21% by volume) is replaced by another gas and particularly preferably it is replaced by nitrogen (nitrogen purging).

As a light source for light irradiation, any light source can be used as long as the light is in the ultraviolet region or near infrared region. Examples of ultraviolet light sources are: super high pressure-, high pressure-, intermediate pressure- and low pressure mercury lamps, chemical lamp, carbon arc lamp, metal halide lamp, xenon lamp and solar light. Various available lasers with a wavelength in the range of 350 to 420 nm can also be used in the form of multi beam.

Examples of near infrared light sources include: a halogen lamp, a xenon lamp, and a high-pressure sodium lamp. Various available laser sources with a wavelength in the range of 750 to 1400 nm may also be used in the form of multibeam.

When using a near infrared light source, it may be used in combination with an ultraviolet light source, or light irradiation may be performed on the substrate side of the web opposite to the coated surface side. Use of these techniques allows the film curing to progress in the inside of the coating film across the depth of the film at almost the same speed as that of the surface and its vicinities, whereby a uniformly cured film can be obtained.

The intensity of ultraviolet ray irradiated is preferably about 0.1 to 1000 mW/cm² and the amount of light to which the surface of the coating film is exposed is preferably 10 to 1000 mJ/cm². In the light irradiation step, the more uniform temperature distribution the coating film has, the larger the effect of the light irradiation becomes. Preferably the temperature distribution is controlled to fall within the range of ±3° C. and more preferably within the range of ±1.5° C. The temperature distribution within the above range is preferable because it allows the polymerization reaction to progress uniformly in the plane as well as in the inside of the layer across the depth of the layer.

The antireflection film produced as above is applicable to articles that are required to have anti-reflection properties, particularly to sheet polarizer or various types of image display devices.

[Sheet Polarizer]

When using an antireflection film of the present invention as one side of the surface protective film for a polarizer, it is necessary to saponify one side of the web, which is opposite to the side on which an antireflection layer is formed, with an alkali. Specific means for alkali saponification can be selected from the following two.

(1) After forming an antireflection layer on a web, the web is immersed in an alkaline solution at least one time to saponify the back side of the web.

(2) Before or after forming an antireflection layer on a web, an alkaline solution is applied onto one side of the web, which is opposite to the side on which an antireflection film is formed, and the web is subjected to heating, water washing and/or neutralization to saponify the back side of the web alone.

The means (1) is superior in that the saponification can be performed in the same step as that of the general-purpose triacetyl cellulose film. However, the means may pose the problems of causing alkaline hydrolysis on the film surface, and thereby degrading the film and of staining the film when saponyfying solution remains on the film, because even the antireflection film surface is saponified. In these cases, the means (2) is superior, though it is a special case.

Polarizer includes: iodine polarizer, dye polarizer which uses a dichroic dye, and polyene polarizer. Generally, polyvinyl alcohol film (hereinafter described as “PVA”) is preferably used for iodine polarizer and dye polarizer. PVA is usually produced by saponifying polyvinyl acetate. Modified PVA can also be used.

A sheet polarizer can be obtained by dying PVA. Dying can be performed by any means, such as immersing a PVA film in an aqueous solution of iodine-potassium iodide, or coating or spraying iodine- or dye-solution over a PVA film. In the step of producing a sheet polarizer by orientating PVA, it is preferable to use an additive that causes crosslinking in PVA, such as boric acid.

The transmittance of the sheet polarizer is preferably in the range of 30 to 50% for the light with a wavelength of 550 nm and more preferably in the range of 35 to 50%. The polarization degree of the same is preferably in the range of 90 to 100% for the light with a wavelength of 550 nm, more preferably in the range of 95 to 100% and most preferably in the range of 99 to 100%.

[Image Display Device]

When used as one side of the surface protective film for a polarizer, the antireflection film of the present. invention is preferably used in a transmission, reflection or semi-transmission type LCD of, for example, Twisted Nematic (TN), Super Twisted Nematic (STN), Vertical Alignment (VA), In-Plane Switching (IPS) or Optically Compensated Bend Cell (OCB) mode.

If the antireflection film of the present invention is used together with a commercially available brightness enhanced film (a polarized-light separating film including a polarized-light selecting layer, e.g. D-BEF by Sumitomo 3M), when used in a transmission or semi-transmission type LCD, a display device having a higher visibility can be obtained.

When arranging a front panel such as an acrylic panel, via air, on the entire surface of the crystal liquid cell in a transmission, reflection or semi-transmission type LCD, it is preferable to laminate the antireflection film not only on the sheet polarizer on the front surface side of the liquid crystal cell, but on the inside and/or the outside of the front panel, via an adhesive or the like, because doing so can decrease the reflection at the interface between the front panel and the crystal liquid cell. If the antireflection film is combined with a λ/4 film, it can be used as a surface protective film for a reflection or semi-transmission type LCD or organic EL display.

Further, if the antireflection film of the present invention is formed on a transparent substrate of PET, PEN or the like, it is applicable to surface protective films for PDAs or cellular phones or image display devices such as touch panel, plasma display panel (PDP) or cathode ray tube display (CRT).

### EXAMPLES

In the following the present invention will be described by examples; however, it is to be understood that these examples are not intended to limit the present invention.

(Preparation of Coating Solution for Hard Coat Layer (HCL-1))

The composition shown below was fed into a mixing tank, followed by stirring to prepare a coating solution for a hard coat layer.

First, 277 parts by mass of poly(glycidyl methacrylate) with a weight average molecular weight of 15000, 728.0 parts by mass of methyl ethyl ketone, 503.0 parts by mass of cyclohexanone and 51.0 parts by mass of photopolymerization initiator (Irgacure 184, by Ciba-Geigy Japan Limited) were added to 742.0 parts by mass of trimethylolpropane triacrylate (TMPTA, by Nippon Kayaku Co., Ltd.) and stirred. Then, the mixture was filtered through a polypropylene filter having a pore diameter of 0.4 μm to prepare a coating solution for a hard coat layer (HCL-1).

(Preparation of Coating Solution for Anti-Glare Hard Coat Layer (HCL-2))

First, 284 parts by weight of a commercially available zirconia-containing UV curing hard coat fluid (DESOLITE Z7404, by JSR Corporation, solid content: about 61%, ZrO₂ content in solid content: about 70%, polymerizable monomer, containing polymerization initiator) and 86 parts by mass of a mixture of dipentaerythritol pentaacrylate and dipentaerythritol hexaacrylate (DPHA, by Nippon Kayaku Co., Ltd.) were mixed, and then the mixture was diluted with 60 parts by mass of methyl isobutyl ketone and 17 parts by mass of methyl ethyl ketone.

Further, 28.5 parts by mass of a silane coupling agent (KBM-5103, by Shin-Etsu Chemical Co., Ltd.) was mixed with stirred.

Then, 30 parts by mass of a dispersion prepared by dispersing 30% methyl isobutyl ketone dispersion of strongly classified crosslinked PMMA particles with an average particle size of 3.0 μm (with a refractive index of 1.49, MXS-300, by Soken Chemical & Engineering Co., Ltd.) using a Polytron disperser at 10000 rpm for 20 minutes and 95 parts by mass of a dispersion prepared by dispersing 30% methyl ethyl ketone dispersion of silica particles with an average particle size of 1.5 μm (with a refractive index of 1.46, Seehostar KE-P150, Nippon Shokubai Co., Ltd.) using a Polytron disperser at 10000 rpm for 30 minutes were added to the above solution and mixed with stirring to a finished fluid.

The above finished fluid was filtered through a polypropylene filter having a pore diameter of 30 μm to prepare a coating solution for an anti-glare hard coat layer (HCL-2).

(Preparation of Coating Solution for Anti-Glare Hard Coat Layer (HCL-3))

28.0 parts by mass of PET-30 (trade name, pentaerythritol triacrylate, by Nippon Kayaku Co., Ltd., with a refractive index of 1.51) as an ultraviolet curing resin, 2.94 parts by mass of acrylic polymer, 1.35 parts by mass of Irgacure 184 (trade name, by Ciba-Geigy Japan Limited) as a photocuring initiator, 1.5 parts by mass of acryl-styrene beads (by Soken Chemical & Engineering Co., Ltd., with a particle size of 3.5 μm and a refractive index of 1.55) as a first light transmitting fine particles, 4.65 parts by mass of styrene beads (by Soken Chemical & Engineering Co., Ltd., with a particle size of 3.5 μm and a refractive index of 1.60) as a second light transmitting fine particles, 0.05 parts by mass of a fluorine-base surface modifier shown below (chemical formula, FP-1), 6.2 parts by mass of KBM-5103 (trade name, by Shin-Etsu Chemical Co., Ltd.) as an organosilane compound, 38.7 parts by mass of toluene, and 16.6 parts by mass of cyclohexanone were fully mixed to prepare a coating solution.

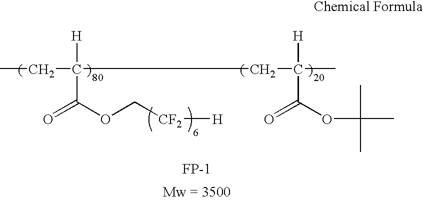

The coating solution was filtered through a polypropylene filter having a pore diameter of 30 μm to prepare a coating solution for an anti-glare hard coat layer (HCL-3).

(Preparation of Dispersion A of Titanium Dioxide Fine Particles)

Titanium dioxide fine particles which contained cobalt and had been subjected to surface treatment using aluminum hydroxide and zirconium hydroxide (MPT-129C, by Ishihara Sangyo Co., Ltd., weight ratio of TiO₂:Co₃O₄:Al₂O₃:ZrO₂=90.5:3.0:4.0:0.5) were used.

42 parts by mass of a dispersant shown below (chemical formula 12) and 702 parts by mass of cyclohexanone were added to 256 parts by mass of the above described titanium dioxide particles, and the particles were dispersed with a Dynomill to prepare a dispersion A of titanium dioxide with a weight average diameter of 70 nm.

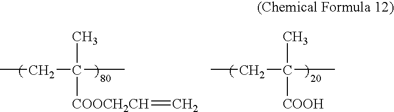

(Preparation of Coating Solution for Intermediate-Refractive-Index Layer (ML-1))

40.7 parts by mass of a mixture of dipentaerythritol pentaacrylate and dipentaerythritol hexaacrylate (DPHA), 2.19 parts by mass of a photopolymerization initiator (Irgacure 907), 0.8 parts by mass of a photosensitizer (Kayacure-DETX, by Nippon Kayaku Co., Ltd.), 280 parts by mass of methyl ethyl ketone, and 1049.0 parts by mass of cyclohexanone were added to 59.6 parts by mass of the above dispersion A of titanium dioxide, followed by stirring.

After fully stirring, the mixture was filtered through a polypropylene filter having a pore diameter of 0.4 μm to prepare a coating solution for an intermediate-refractive-index layer (ML-1). The coating solution had a viscosity of 1.5 mPa·sec and a surface tension of 28 mN/m. The amount of the coating solution applied onto a web W was 3.5 ml/m².

(Preparation of Coating Solution for High-Refractive-Index Layer (HL-1))

36.6 parts by mass of a mixture of dipentaerythritol pentaacrylate and dipentaerythritol hexaacrylate (DPHA, by Nippon Kayaku Co., Ltd.), 3.0 parts by mass of a photopolymerization initiator (Irgacure 907, by Ciba-Geigy Japan Limited), 1.0 parts by mass of a photosensitizer (Kayacure-DETX, by Nippon Kayaku Co., Ltd.), 535.0 parts by mass of methyl ethyl ketone, and 495 parts by mass of cyclohexanone were added to 430.7 parts by mass of the above dispersion A of titanium dioxide, followed by stirring.

The mixture was filtered through a polypropylene filter having a pore diameter of 0.4 μm to prepare a coating solution for a high-refractive-index layer (HL-1). The coating solution had a viscosity of 1.6 mPa·sec and a surface tension of 28 mN/m. The amount of the coating solution applied onto a web W was 3.5 ml/m².

(Preparation of Coating Solution for High-Refractive-Index Layer (HL-2))

36.7 parts by mass of a mixture of dipentaerythritol pentaacrylate and dipentaerythritol hexaacrylate (DPHA, by Nippon Kayaku Co., Ltd.), 3.0 parts by mass of a photopolymerization initiator (Irgacure 907, by Ciba-Geigy Japan Limited), 1.0 parts by mass of a photosensitizer (Kayacure-DETX, by Nippon Kayaku Co., Ltd.), 267.0 parts by mass of methyl ethyl ketone, and 761.7 parts by mass of cyclohexanone were added to 430.6 parts by mass of the above dispersion A of titanium dioxide, followed by stirring.

The mixture was filtered through a polypropylene filter having a pore diameter of 0.4 μm to prepare a coating solution for a high-refractive-index layer (HL-2). The coating solution had a viscosity of 2.0 mPa·sec and a surface tension of 28 mN/m. The amount of the coating solution applied onto a web W was 3.5 ml/m².

(Preparation of Coating Solution for High-Refractive-Index Layer (HL-3))

36.7 parts by mass of a mixture of dipentaerythritol pentaacrylate and dipentaerythritol hexaacrylate (DPHA, by Nippon Kayaku Co., Ltd.), 3.0 parts by mass of a photopolymerization initiator (Irgacure 907, by Ciba-Geigy Japan Limited), 1.0 parts by mass of a photosensitizer (Kayacure-DETX, by Nippon Kayaku Co., Ltd.), and 1028.6 parts by mass of cyclohexanone were added to 430.6 parts by mass of the above dispersion A of titanium dioxide, followed by stirring.

The mixture was filtered through a polypropylene filter having a pore diameter of 0.4 μm to prepare a coating solution for a high-refractive-index layer (HL-3). The coating solution had a viscosity of 2.6 mPa·sec and a surface tension of 28 mN/m. The amount of the coating solution applied onto a web W was 3.5 ml/m².

(Preparation of Coating Solution for High-Refractive-Index Layer (HL-4))

36.7 parts by mass of a mixture of dipentaerythritol pentaacrylate and dipentaerythritol hexaacrylate (DPHA, by Nippon Kayaku Co., Ltd.), 3.0 parts by mass of a photopolymerization initiator (Irgacure 907, by Ciba-Geigy Japan Limited), 1.0 parts by mass of a photosensitizer (Kayacure-DETX, by Nippon Kayaku Co., Ltd.), and 50.0 parts by mass of methyl ethyl ketone were added to 430.6 parts by mass of the above dispersion A of titanium dioxide, followed by stirring.

The mixture was filtered through a polypropylene filter having a pore diameter of 0.4 μm to prepare a coating solution for a high-refractive-index layer (HL-4). The coating solution had a viscosity of 20.0 mPa·sec and a surface tension of 28 mN/m. The amount of the coating solution applied onto a web W was 3.5 ml/m².

(Preparation of Coating Solution for High-Refractive-Index Layer (HL-5))

36.7 parts by mass of a mixture of dipentaerythritol pentaacrylate and dipentaerythritol hexaacrylate (DPHA, by Nippon Kayaku Co., Ltd.), 3.0 parts by mass of a photopolymerization initiator (Irgacure 907, by Ciba-Geigy Japan Limited), and 1.0 parts by mass of a photosensitizer (Kayacure-DETX, by Nippon Kayaku Co., Ltd.) were added to 430.6 parts by mass of the above dispersion A of titanium dioxide, followed by stirring.

The mixture was filtered through a polypropylene filter having a pore diameter of 0.4 μm to prepare a coating solution for a high-refractive-index layer (HL-5). The coating solution had a viscosity of 24.0 mPa·sec and a surface tension of 28 mN/m. The amount of the coating solution applied onto a web W was 3.5 ml/m².

(Preparation of Coating Solution for Low-Refractive-Index Layer (LL-1))

203.2 parts by mass of a solution prepared by dissolving a copolymer shown below (chemical formula 13) in methyl ethyl ketone so that the concentration is 23.7% by mass, 1.4 parts by mass of a terminal methacrylate group-containing silicone resin X-22-164C (by Shin-Etsu Chemical Co., Ltd.), 2.4 parts by mass of a photoradical generator, Irgacure 907 (trade name), 764.6 parts by mass of methyl ethyl ketone, and 28.4 parts by mass of cyclohexanone were added and stirred.

The mixture was filtered through a PTFE filter having a pore diameter of 0.45 μm to prepare a coating solution for a low-refractive-index layer (LL-1). The coating solution had a viscosity of 0.61 mPa·sec and a surface tension of 24 mN/m. The amount of the coating solution applied onto a web W was 3.5 ml/m².

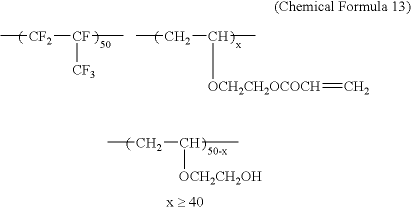

(Preparation of Coating Solution for Low-Refractive-Index Layer (LL-2))

468.8 parts by mass of a solution prepared by dissolving the above copolymer (chemical formula 13) in methyl ethyl ketone so that the concentration is 23.7% by mass, 3.3 parts by mass of a terminal methacrylate group-containing silicone resin X-22-164C (by Sin-Etsu Chemical Co., Ltd.), 5.6 parts by mass of a photoradical generator, Irgacure 907 (trade name), 495.9 parts by mass of methyl ethyl ketone, and 26.4 parts by mass of cyclohexanone were added and stirred.

The mixture was filtered through a PTFE filter having a pore diameter of 0.45 μm to prepare a coating solution for a low-refractive-index layer (LL-2). The coating solution had a viscosity of 1.0 mPa·sec and a surface tension of 24 mN/m. The amount of the coating solution applied onto a web W was 1.5 ml/m².

(Preparation of Coating Solution for Low-Refractive-Index Layer (LL-3))

355.5 parts by mass of a solution prepared by dissolving the above copolymer (chemical formula 13) in methyl ethyl ketone so that the concentration is 23.7% by mass, 2.5 parts by mass of a terminal methacrylate group-containing silicone resin X-22-164C (by Sin-Etsu Chemical Co., Ltd.), 4.2 parts by mass of a photoradical generator, Irgacure 907 (trade name), 610.5 parts by mass of methyl ethyl ketone, and 27.3 parts by mass of cyclohexanone were added and stirred.

The mixture was filtered through a PTFE filter having a pore diameter of 0.45 μm to prepare a coating solution for a low-refractive-index layer (LL-3). The coating solution had a viscosity of 0.76 mPa·sec and a surface tension of 24 mN/m. The amount of the coating solution applied onto a web W was 2.0 ml/m².

(Preparation of Coating Solution for Low-Refractive-Index Layer (LL-4))

142.2 parts by mass of a solution prepared by dissolving the above copolymer (chemical formula 13) in methyl ethyl ketone so that the concentration is 23.7% by mass, 1.0 parts by mass of a terminal methacrylate group-containing silicone resin X-22-164C (by Sin-Etsu Chemical Co., Ltd.), 1.7 parts by mass of a photoradical generator, Irgacure 907 (trade name), 862.2 parts by mass of methyl ethyl ketone, and 28.9 parts by mass of cyclohexanone were added and stirred.

The mixture was filtered through a PTFE filter having a pore diameter of 0.45 μm to prepare a coating solution for a low-refractive-index layer (LL-4). The coating solution had a viscosity of 0.49 mPa·sec and a surface tension of 24 mN/m. The amount of the coating solution applied onto a web W was 5.0 ml/m².

(Preparation of Coating Solution for Low-Refractive-Index Layer (LL-5))

118.4 parts by mass of a solution prepared by dissolving the above copolymer (chemical formula 13) in methyl ethyl ketone so that the concentration is 23.7% by mass, 0.8 parts by mass of a terminal methacrylate group-containing silicone resin X-22-164C (by Sin-Etsu Chemical Co., Ltd.), 1.4 parts by mass of a photoradical generator, Irgacure 907 (trade name), 850.3 parts by mass of methyl ethyl ketone, and 29.1 parts by mass of cyclohexanone were added and stirred.

The mixture was filtered through a PTFE filter having a pore diameter of 0.45 μm to prepare a coating solution for a low-refractive-index layer (LL-5). The coating solution had a viscosity of 0.46 mPa·sec and a surface tension of 24 mN/m. The amount of the coating solution applied onto a web W was 6.0 ml/m².

(Preparation of Coating Solution for Low-Refractive-Index Layer (LL-6))

71.1 parts by mass of a solution prepared by dissolving the above copolymer (chemical formula 13) in methyl ethyl ketone so that the concentration is 23.7% by mass, 0.5 parts by mass of a terminal methacrylate group-containing silicone resin X-22-164C (by Sin-Etsu Chemical Co., Ltd.), 0.8 parts by mass of a photoradical generator, Irgacure 907 (trade name), 898.1 parts by mass of methyl ethyl ketone, and 29.5 parts by mass of cyclohexanone were added and stirred.

The mixture was filtered through a PTFE filter having a pore diameter of 0.45 μm to prepare a coating solution for a low-refractive-index layer (LL-6). The coating solution had a viscosity of 0.43 mPa·sec and a surface tension of 24 mN/m. The amount of the coating solution applied onto a web W was 10.0 ml/m².

(Preparation of Sol Solution a)

119 parts by mass of methyl ethyl ketone, 101 parts by mass of acryloyloxypropyltrimethoxysilane (KBM 5103, by Sin-Etsu Chemical Co., Ltd.), 3 parts by mass of diisopropoxyaluminum ethyl acetoacetate were added to and mixed in a reactor equipped with a stirrer and a reflux condenser and then 30 parts by mass of ion-exchanged water was added. The mixture was allowed to react at 60° C. for 4 hours and cooled to room temperature to obtain a sol solution a.

The mass-average molecular weight of the sol solution a was 1600. 100% of the oligomer and polymer components of the sol solution had molecular weight of a 1000 to 20000. The results of gas chromatography confirmed that there existed no acryloyloxypropyltrimethoxysilane, which was a raw material, in the sol solution a.

(Preparation of Coating Solution for Low-Refractive-Index Layer (LL-7))

First, 14.9 parts by mass of JN-7228A (refractive index: 1.42, solid content: 6%, by JSR Corporation), 0.61 parts by mass of silica sol (silica, MEK-ST, average particle size: 15 nm, solid content: 30%, by Nissan Chemical Industries, Ltd.), 0.79 parts by mass of silica sol (silica, MEK-ST different from the above one in particle size, average particle size: 45 nm, solid content: 30%, by Nissan Chemical Industries, Ltd.), 0.41 parts by mass of the above sol solution a, 3.1 parts by mass of methyl ethyl ketone, and 0.6 parts by mass of cyclohexanone were added and stirred. Then, the mixture was filtered through a polypropylene filter having a pore diameter of 1 μm to prepare a coating solution for a low-refractive-index layer (LL-7).

The coating solution had a viscosity of 0.61 mPa·sec and a surface tension of 24 mN/m. The amount of the coating solution applied onto a web W was 2.8 ml/m².

(Preparation of Coating Solution for Low-Refractive-Index Layer (LL-8))

13.1 parts by mass of JTA 113 (trade name, refractive index: 1.44, solid content: 6%, MEK solution, by JSR Corporation) having an enhanced coating film strength compared with JN-7228A described above, 1.31 parts by mass of colloidal silica dispersion, MEK-ST-L (trade name, average particle size: 45 nm, solid content: 30%, by Nissan Chemical Industries, Ltd.), 0.59 parts by mass of the above sol solution a, 5.1 parts by mass of methyl ethyl ketone, and 0.6 parts by mass of cyclohexanone were added and stirred. Then, the mixture was filtered through a polypropylene filter having a pore diameter of 1 μm to prepare a coating solution for a low-refractive-index layer (LL-8).

The coating solution had a viscosity of 0.66 mPa·sec and a surface tension of 23.7 mN/m. The amount of the coating solution applied onto a web W was 2.8 ml/m².

(Preparation of Dispersion A-1)

First, 30 parts of acryloyloxypropyltrimethoxysilane (by Sin-Etsu Chemical Co., Ltd.) and 1.5 parts of diisopropoxyaluminum ethyl acetate were added to and mixed with 500 parts of a sol of hollow fine silica particles (isopropyl alcohol silica zol, average particle size: 60 nm, shell thickness: 10 nm, silica concentration: 20% by mass, refractive index of silica particles: 1.31, produced in accordance with the preparation example 4 described in Japanese Patent Application Laid-open No. 2002-79616 with a different particle size) and then 9 parts of ion-exchanged water was added to the mixture. The mixture was allowed to react at 60° C. for 8 hours and cooled to room temperature, followed by addition of 1.8 parts of acetylacetone. Then solvent replacement by vacuum distillation was performed for 500 g of the above dispersion at a pressure of 20 kPa, while adding cyclohexanone to the dispersion so as to hold the silica content constant. There was observed no foreign matter in the dispersion. The viscosity of the dispersion was 5 mPa·s at 25° C. when the solid content was adjusted to 20% by mass with cyclohexanone. Gas chromatography showed that the amount of isopropyl alcohol remaining in the resultant dispersion A-1 was 1.5%.

(Preparation of Coating Solution for Low-Refractive-Index Layer (LL-9))

44.0 parts by mass of a fluorine-containing copolymer, P-3 (with a weight average molecular weight of about 50000), described in Japanese Patent Laid-Open 2004-45462, 6.0 parts by mass of a mixture of dipentaerythritol pentaacrylate and dipentaerythritol hexaacrylate (DPHA, by Nippon Kayaku Co., Ltd.), 3.0 parts by mass of a terminal methacrylate group-containing silicone RMS-033 (by Gelest Inc.), 3.0 parts by mass of a photoradical generator, Irgacure 907, (by Ciba Specialty Chemicals) were added to and dissolved in 100 parts by mass of methyl ethyl ketone. After that, 195 parts by mass of the dispersion (A-1) (solid content of silica+surface treatment agent: 39.0 parts by mass) and 17.2 parts by mass of sol solution a (solid content: 5.0 parts by mass) were added. A coating solution for low-refractive-index layer (LL-9) was prepared by diluting the mixture with cyclohexanone and methyl ethyl ketone so that the solid content was 6% by mass and the cyclohexanone/methyl ethyl ketone ratio was 10/90 in the entire fluid.

The coating solution had a viscosity of 0.66 mPa·sec and a surface tension of 23.7 mN/m. The amount of the coating solution applied onto a web W was 2.8 ml/m².

(Preparation of Coating Solution for Low-Refractive-Index Layer (LL-10))

3.3 parts by mass of a mixture of dipentaerythritol pentaacrylate and dipentaerythritol hexaacrylate (DPHA, by Nippon Kayaku Co., Ltd.), 0.7 parts by mass of a terminal methacrylate group-containing silicone RMS-033 (by Gelest Inc.), 0.2 parts by mass of a photoradical generator, Irgacure 907, (by Ciba Specialty Chemicals) were added and dissolved. After that, 36.4 parts by mass of the dispersion (A-1) and 6.2 parts by mass of sol solution a were added. Then, 290.6 parts by mass of methyl ethyl ketone and 9.0 parts by mass of cyclohexanone were added to the above mixture to prepare a coating solution for low-refractive-index layer (LL-10).

The coating solution had a viscosity of 0.66 mPa·sec and a surface tension of 23.7 mN/m. The amount of the coating solution applied onto a web W was 2.8 ml/m².

(Construction of Die Coater)

In a slot die 13 used, as shown in FIGS. 10A and 10B, the land length, IUP, of its upstream lip was 0.5 mm, the land length, ILO, of its downstream lip was 50 μm, the length of the opening of the slot 16 along the length of the running web was 150 μm, and the length of the slot 16 was 50 mm.

The space between the land 18a of the upstream lip and the web W was made larger than the space between the land 18b of the downstream lip and the web W by 50 μm (hereinafter referred to as overbite length of 50 μm) and the space GL between the land 18b of the downstream lip and the web W was set to 50 μm.

The space, GS, between the side plate 40b of the vacuum chamber 40 and the web W and the space, GB, between the back plate 40a of the vacuum chamber and the web W were both 200 μm.

### Example 1

(Production of Antireflection Film)

A coating solution for a hard coat layer (HCL-1) was applied onto a triacetylcellulose film 80 μtm thick (TD-80UF, by Fuji Photo Film Co., Ltd.) at a coating speed of 25 m/min using the above described die coater. When applying HCL-1, the space GL between the land 18b of the downstream lip and the web W was changed to 80 μm and the vacuum degree of the vacuum chamber was set to 0.8 kPa.

Then, the coating solution applied onto the film was dried at 80° C. and cured by being exposed to ultraviolet rays using an air-cooled metal halide lamp of 160 W/cm (EYEGRAPHICS Co., Ltd.) at a irradiance of 400 mW/cm² and an irradiation dose of 500 mJ/cm², while performing nitrogen purging to make the oxygen concentration in the atmosphere 1.0% by volume or less, so that a hard coat layer (2) with a thickness 8 μm was formed.

Then, a coating solution for an intermediate-refractive-index layer (ML-1) was applied onto the above hard coat layer (2) at a coating speed of 25 ml/min using the same die coater as above. The vacuum degree of the vacuum chamber was set to 0.8 kPa.

The coating solution applied onto the hard coat layer (2) was dried at 100° C. for 30 seconds and cured by being exposed to ultraviolet rays using an air-cooled metal halide lamp of 240 W/cm (EYEGRAPHICS Co., Ltd.) at a irradiance of 550 mW/cm² and an irradiation dose of 550 mJ/cm², while performing nitrogen purging to make the oxygen concentration in the atmosphere 0.1% by volume or less, so that an intermediate-refractive-index layer (refractive index: 1.63, film thickness: 64 nm) was formed.

Then, a coating solution for a high-refractive-index layer (HL-1) was applied onto the above intermediate-refractive-index layer (3) at a coating speed of 25 m/min using the same die coater as above. The vacuum degree of the vacuum chamber was set to 0.8 kPa.

The coating solution applied onto the intermediate-refractive-index layer (3) was dried at 100° C. for 30 seconds and cured by being exposed to ultraviolet rays using an air-cooled metal halide lamp of 240 W/cm (EYEGRAPHICS Co., Ltd.) at a irradiance of 550 mW/cm² and an irradiation dose of 550 mJ/cm², while performing nitrogen purging to make the oxygen concentration in the atmosphere 0.1% by volume or less, so that a high-refractive-index layer (refractive index: 1.90, film thickness: 103 nm) was formed.

Then, a coating solution for a low-refractive-index layer (LL-1) was applied onto the above high-refractive-index layer at a coating speed of 25 m/min using the same die coater as above. The vacuum degree of the vacuum chamber was set to 0.8 kPa. The coating solution applied onto the high-refractive-index layer was dried at 90° C. for 30 seconds and cured by being exposed to ultraviolet rays using an air-cooled metal halide lamp of 240 W/cm (EYEGRAPHICS Co., Ltd.) at a irradiance of 600 mW/cm² and an irradiation dose of 400 mJ/cm², while performing nitrogen purging to make the oxygen concentration in the atmosphere 0.1% by volume or less, so that a low-refractive-index layer (refractive index: 1.45, film thickness: 83 nm) was formed. Thus, an antireflection film was produced.

In the above production process, the coating and drying steps were conducted in an atmosphere of air with an air cleanness degree of 30/m³, on the basis of the number of particles 0.5 μm or more in size. The coating was conducted while performing dust removing in such a manner as to remove dust deposits from the web W by blowing air with high cleanness degree described in Japanese Patent Application Laid-open No. 10-309553 at a high speed right before the coating operation and apply suction to the suction opening provided in close proximity to the web W. The static voltage of the base before dust removing was 200 V or less. The above described coating was conducted, for each layer, through the steps of: delivering—dust removing—coating—drying—(UV or heat) curing—rolling up.

The produced antireflection film was immersed in a 2.0 N aqueous solution of NaOH at 55° C. for 2 minutes to give saponification treatment to the surface of triacetylcellulose on the back side of the film. The antireflection film thus treated and a triacetylcellulose film 80 μm thick (TAC-TD80U, by Fuji Photo Film Co., Ltd.) having been subjected to saponification treatment under the same conditions as above were adhered, as protective films, to the respective sides of a polarizer having been produced by stretching polyvinyl alcohol with iodine adsorbed thereby to produce a sheet polarizer.

When replacing the sheet polarizer which was on the visible side of the liquid crystal display device (having D-BEF by Sumitomo 3M, which is a polarized-light separating film including a polarized-light selecting layer, between the back light and the liquid crystal cell) of a note personal computer equipped with a transmissive TN liquid crystal display device with the sheet polarizer produced as above in such a manner as to allow the antireflection film side of the sheet polarizer to be the top surface, a very high-quality display was obtained in which the reflection of the background was extremely lessened, the color tone of the reflected light was significantly decreased and the uniformity in the display screen was ensured.

### Example 2

An antireflection film was produced under the same conditions as those in example 1, provided that a gravure coater was used instead of the above described die coater. Coating could be performed; however, there were produced lines along the length of the web W (base) at regular intervals and step-like non-uniformity across the width of the same. When producing a display device in the same procedure as in. example 1, color tone non-uniformity was visually observed in the display device and the display was far from of high quality.

### Examples 3 to 6

Antireflection films were produced under the same conditions as those in example 1, provided that the land length ILO of the downstream lip of die coaters 10 was set to 10 μm, 30 μm, 100 μm and 120 μm, respectively.

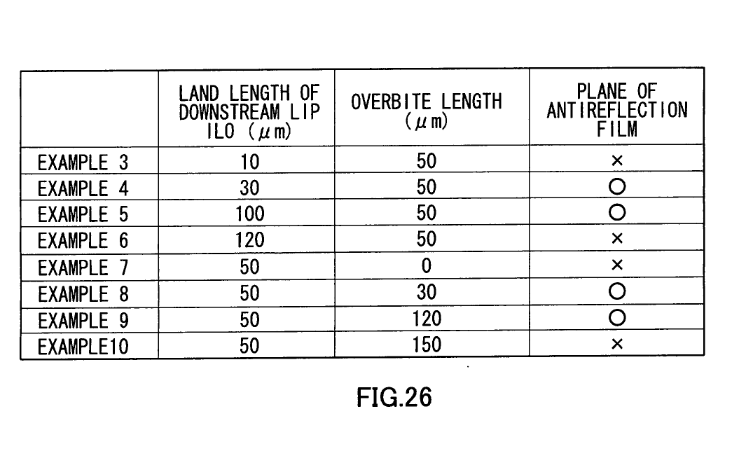

The results are shown in FIG. 26. The results confirmed that when the land length ILO of the downstream lip was in the range of 30 μm to 100 μm, antireflection films were obtained in which no defective planes occurred.

In example 3, line-like non-uniformity occurred along the length of the base.

In example 6, beads 14a could not be formed at the same coating speed as that in example 1, and therefore, coating could not be performed. Halving the coating speed made it possible to perform coating, but it caused line-like non-uniformity along the length of the base.

When using the antireflection films produced in examples 4 and 5 to produce display devices in the same procedure as that in example 1, very high-quality displays were obtained in which the reflection of the background was extremely lessened, the color tone of the reflected light was significantly decreased and the uniformity in the display screen was ensured.

In contrast, when using the antireflection films produced in examples 3 and 6 to produce display devices in the same procedure as that in example 1, color tone non-uniformity was visually observed in the display devices, and therefore, the resultant display devices were far from of high quality.

### Examples 7 to 10

Antireflection films were produced under the same conditions as those in example 1, provided that the overbite length LO of die coaters 10 was set to 0 μm, 30 μm, 120 μm and 150 μm, respectively.

The results are shown in FIG. 26. The results confirmed that when the overbite length LO was in the range of 30 μm to 120 μm, antireflection films were obtained in which no defective planes occurred.

In example 7, coating could be performed; however, step-like non-uniformity was observed across the width of the base.

In example 10, beads 14a could not be formed at the same coating speed as that in example 1, and therefore, coating could not be performed. Halving the coating speed made it possible to perform coating, but it caused line-like non-uniformity along the length of the base.

When using the antireflection films produced in examples 8 and 9 to produce display devices in the same procedure as that in example 1, very high-quality displays were obtained in which the reflection of the background was extremely lessened, the color tone of the reflected light was significantly decreased and the uniformity in the display screen was ensured.

In contrast, when using the antireflection films produced in examples 7 and 10 to produce display devices in the same procedure as that in example 1, color tone non-uniformity was visually observed in the display devices, and therefore, the resultant display devices were far from of high quality.

### Examples 11 to 15

Antireflection films were produced under the same conditions as those in example 1, provided that instead of the coating solution LL-1, coating solutions for low-refractive-index layers LL-2, LL-3, LL-4, LL-5 and LL-6 were used, respectively.

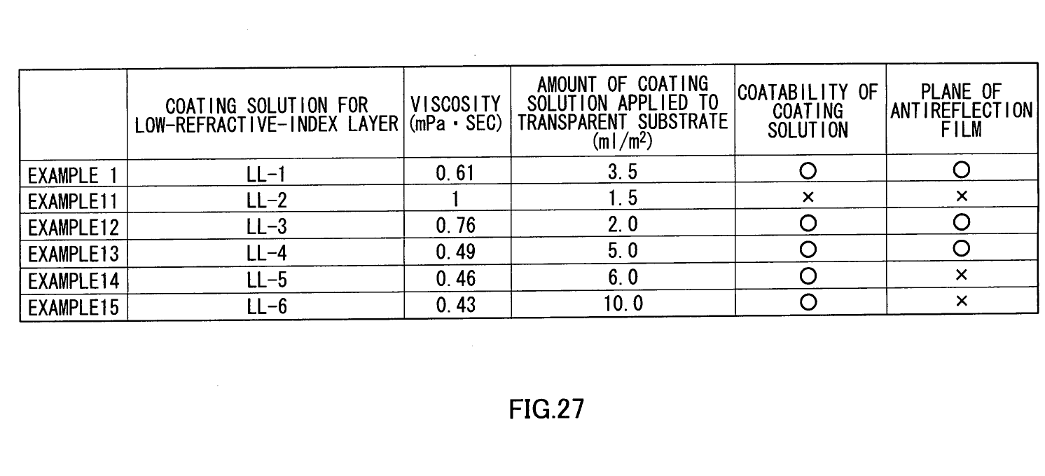

The results are shown in FIG. 27. When the amount of the coating solution applied onto a web W was 2 ml/m² or more, coating could be performed, whereas when the amount is 1.5 ml/m², the coating solution could not be applied uniformly to the entire web surface, and therefore, an antireflection film could not be produced.

When the amount of the coating solution applied onto a web W was 6 ml/m² and 10 ml/m², coating could be performed; however, the amount was too large to be fully dried, causing longitudinal line-like non-uniformity due to the air on the entire surface of the film.

When using the antireflection films produced in examples 12 and 13 to produce display devices in the same procedure as that in example 1, very high-quality displays were obtained in which the reflection of the background was extremely lessened, the color tone of the reflected light was significantly decreased and the uniformity in the display screen was ensured.

In contrast, when using the antireflection films produced in examples 14 and 15 to produce display devices in the same procedure as that in example 1, color tone non-uniformity was visually observed in the display devices, and therefore, the resultant display devices were far from of high quality.

### Examples 16 to 19

Antireflection films were produced under the same conditions as those in example 1, provided that instead of the coating solution HL-1, coating solutions for high-refractive-index layers HL-2, HL-3, HL-4 and HL-5 were used, respectively.

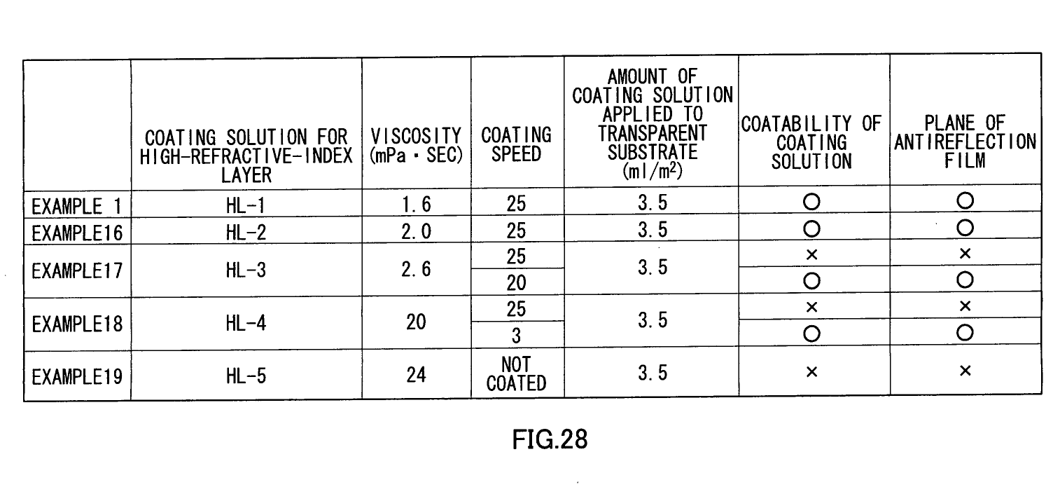

The results are shown in FIG. 28. Coating could be performed at a coating speed of 25 m/min for the coating solutions having a viscosity of 2 mPa·sec or less.

For HL-3, whose viscosity was 2.6 mPa·sec, it could not be applied uniformly to the entire web surface at a coating speed of 25 m/min, but at a coating speed of 20 m/min, a satisfactory antireflection film could be produced.

For HL-4, whose viscosity was 20 mPa·sec, it could not be applied uniformly to the entire web surface at a coating speed of 25 m/min, but at a coating speed of 3 m/min, a satisfactory antireflection film could be produced.

For HL-5, whose viscosity was 24 mPa·sec, it could not be applied to the entire web surface even if the coating speed was decreased.

When using the antireflection film produced in example 16 and the antireflection film produced by coating HL-3 at a coating speed of 20 ml/min to produce display devices in the same procedure as that in example 1, very high-quality displays were obtained in which the reflection of the background was extremely lessened, the color tone of the reflected light was significantly decreased and the uniformity in the display screen was ensured.

### Example 20

(Production of Antireflection Film)

(1) Coating of Anti-Glare Hard Coat Layer

A coating solution for an anti-glare hard coat layer (HCL-2) was applied onto a triacetylcellulose film 80 μm thick (TAC-TD80UL, by Fuji Photo Film Co., Ltd.) in a roll, while unrolling the same, at a coating speed of 25 m/min using the above described die coater. When applying HCL-2, the space GL between the land 18b of the downstream lip and the web W was changed to 80 μm and the vacuum degree of the vacuum chamber was set to 0.8 kPa.

The coating solution applied onto the film was dried at 60° C. for 150 seconds and cured by being exposed to ultraviolet rays using an air-cooled metal halide lamp of 160 W/cm (EYEGRAPHICS Co., Ltd.) at a irradiance of 400 mW/cm² and an irradiation dose of 300 mJ/cm², under nitrogen purging, so that a hard coat layer (2) with a thickness 2.9 μm was formed. The resultant triacetylcellulose film with the hard coat layer (2) thereon was rolled up.

(2) Coating of Low-Refractive-Index Layer

The triacetylcellulose film with the hard coat layer (2) thereon was unrolled again and the above described coating solution for a low-refractive-index layer (LL-7) was applied onto the above hard coat layer (2) at a coating speed of 25 m/min using the same die coater as above. The vacuum degree of the vacuum chamber was set to 0.8 kPa.

The coating solution applied onto the hard coat layer (2) was dried at 120° C. for 150 seconds and further dried at 140° C. for 8 minutes, and cured by being exposed to ultraviolet rays using an air-cooled metal halide lamp of 240 W/cm (EYEGRAPHICS Co., Ltd.) at a irradiance of 400 mW/cm and an irradiation dose of 600 mJ/cm², under nitrogen purging, so that a low-refractive-index layer (5) with a thickness 100 nm was formed. The resultant triacetylcellulose film with the hard coat layer (2) and the low-refractive-index layer (5) thereon was rolled up.

In the above production process, the coating and drying steps were conducted in an atmosphere of air with an air cleanness degree of 30/m³, on the basis of the number of particles 0.5 μm or more in size. The coating was conducted while performing dust removing in such a manner as to remove dust deposits from the film surface by blowing air with high cleanness degree described in Japanese Patent Application Laid-open No. 10-309553 at a high speed right before the coating operation and apply suction to the suction opening provided in close proximity to the film. The static voltage of the base before dust removing was 200 V or less. The above described coating was conducted, for each layer, through the steps of: delivering—dust removing—coating—drying—(UV or heat) curing—rolling-up.

The produced antireflection film was immersed in a 2.0 N aqueous solution of NaOH at 55° C. for 2 minutes to give saponification treatment to the surface of triacetylcellulose on the back side of the film. The antireflection film thus treated and a triacetyl cellulose film 80 μm thick (TAC-TD80U, by Fuji Photo Film Co., Ltd.) having been subjected to saponification treatment under the same conditions as above were adhered, as protective films, to the respective sides of a polarizer having been produced by stretching polyvinyl alcohol with iodine adsorbed thereby to produce a sheet polarizer.

When replacing the sheet polarizer which was on the visible side of the liquid crystal display device (having D-BEF by Sumitomo 3M, which is a polarized-light separating film including a polarized-light selecting layer, between the back light and the liquid crystal cell) of a note personal computer equipped with a transmissive TN liquid crystal display device with the sheet polarizer produced as above in such a manner as to allow the antireflection film side of the sheet polarizer to be the top surface, a very high-quality display was obtained in which the reflection of the background was extremely lessened, the color tone of the reflected light was significantly decreased and the uniformity in the display screen was ensured.

### Example 21

(Production of Antireflection Film)

(1) Coating of Anti-Glare Hard Coat Layer

A coating solution for an anti-glare hard coat layer, HCL-3, was applied onto a triacetylcellulose film 80 μm thick (TD80U: trade name, by Fuji Photo Film Co., Ltd.) in a roll, while unrolling the same, at a coating speed of 25 m/min using the above described die coater so that the coating thickness was 7 μm in a dried state.

When applying HCL-3, the space GL between the land 18b of the downstream lip and the web W was changed to 80 μm and the vacuum degree of the vacuum chamber was set to 0.8 kPa. The coating solution applied onto the film was dried at 110° C. for 10 seconds and further dried at 50° C. for 20 seconds. After drying the solvent, the coating layer was photo-cured by being exposed to ultraviolet rays until the integrated quantity of light was 55 mJ, under nitrogen purging (oxygen concentration of 200 ppm or lower), so that an anti-glare layer was formed. The resultant triacetylcellulose film with the anti-glare hard coat layer coated thereon was rolled up.

(2) Coating of Low-Refractive-Index Layer

The triacetylcellulose film with the above anti-glare layer coated thereon was unrolled again and the above described coating solution for a low-refractive-index layer (LL-8) was applied onto the above anti-glare layer at a coating speed of 25 m/min using the same die coater as above so that the coating thickness was 100 nm in a dried state. The vacuum degree of the vacuum chamber was set to 0.8 kPa.

The coating solution applied onto the anti-glare layer was dried at 120° C. for 70 seconds and further dried at 110° C. for 10 minutes and thermoset. Then, the coating layer was photo-cured by being exposed to ultraviolet rays until the integrated quantity of light was 120 mJ, under nitrogen purging (oxygen concentration of 100 ppm or lower), so that an antireflection film with a low-refractive-index layer (5) coated thereon was produced. The resultant triacetylcellulose film with the anti-glare hard coat layer and the low-refractive-index layer (5) coated thereon was rolled up.

In the above production process, the coating and drying steps were conducted in an atmosphere of air with an air cleanness degree of 30/m³, on the basis of the number of particles 0.5 μm or more in size. The coating was conducted while performing dust removing in such a manner as to remove dust deposits from the film surface by blowing air with high cleanness degree described in Japanese Patent Application Laid-open No. 10-309553 at a high speed right before the coating operation and apply suction to the suction opening provided in close proximity to the film. The static voltage of the base before dust removing was 200 V or less. The above described coating was conducted, for each layer, through the steps of: delivering—dust removing—coating—drying—(UV or heat) curing—rolling-up.

The produced antireflection film was immersed in a 2.0 N aqueous solution of NaOH at 55° C. for 2 minutes to give saponification treatment to the surface of triacetylcellulose on the back side of the film. The antireflection film thus treated and a triacetylcellulose film 80 μm thick (TAC-TD80U, by Fuji Photo Film Co., Ltd.) having been subjected to saponification treatment under the same conditions as above were adhered, as protective films, to the respective sides of a polarizer having been produced by stretching polyvinyl alcohol with iodine adsorbed thereby to produce a sheet polarizer. When replacing the sheet polarizer which was on the visible side of the liquid crystal display device (having D-BEF by Sumitomo 3M, which is a polarized-light separating film including a polarized-light selecting layer, between the back light and the liquid crystal cell) of a note personal computer equipped with a transmissive TN liquid crystal display device with the sheet polarizer produced as above in such a manner as to allow the antireflection film side of the sheet polarizer to be the top surface, a very high-quality display was obtained in which the reflection of the background was extremely lessened, the color tone of the reflected light was significantly decreased and the uniformity in the display screen was ensured.

### Example 22

(Production of Antireflection Film)

(1) Coating of Anti-Glare Hard Coat Layer

A coating solution for an anti-glare hard coat layer, HCL-3, was applied onto a triacetylcellulose film 80 μm thick (TD80U: trade name, by Fuji Photo Film Co., Ltd.) in a roll, while unrolling the same, at a coating speed of 25 m/min using the above described die coater so that the coating thickness was 7 μm in a dried state.

When applying HCL-3, the space GL between the land 18b of the downstream lip and the web W was changed to 80 μm and the vacuum degree of the vacuum chamber was set to 0.8 kPa. The coating solution applied onto the film was dried at 110° C. for 10 seconds and further dried at 50° C. for 20 seconds. After drying the solvent, the coating layer was photo-cured by being exposed to ultraviolet rays until the integrated quantity of light was 55 mJ, under nitrogen purging (oxygen concentration of 200 ppm or lower), so that an anti-glare layer was formed. The resultant triacetylcellulose film with the anti-glare hard coat layer coated thereon was rolled up.

(2) Coating of Low-Refractive-Index Layer

The triacetylcellulose film with the above anti-glare layer coated thereon was unrolled again and the above described coating solution for a low-refractive-index layer (LL-9) was applied onto the above anti-glare layer at a coating speed of 25 m/min using the same die coater as above. The vacuum degree of the vacuum chamber was set to 0.8 kPa. The coating solution applied onto the anti-glare layer was dried at 90° C. for 30 seconds and cured by being exposed to ultraviolet rays using an air-cooled metal halide lamp of 240 W/cm (by EYEGRAPHICS Co., Ltd.) at a irradiance of 600 mW/cm² and an irradiation dose of 400 mJ/cm², while performing nitrogen purging to make the oxygen concentration in the atmosphere 0.1% by volume or less, so that a low-refractive-index layer (with film thickness 95 nm) was formed. Thus, an antireflection film was produced.

In the above production process, the coating and drying steps were conducted in an atmosphere of air with an air cleanness degree of 30/m³, on the basis of the number of particles 0.5 μm or more in size. The coating was conducted while performing dust removing in such a manner as to remove dust deposits from the film surface by blowing air with high cleanness degree described in Japanese Patent Application Laid-open No. 10-309553 at a high speed right before the coating operation and apply suction to the suction opening provided in close proximity to the film. The static voltage of the base before dust removing was 200 V or less. The above described coating was conducted, for each layer, through the steps of: delivering—dust removing—coating—drying—(UV or heat) curing—rolling-up.

The produced antireflection film was immersed in a 2.0 N aqueous solution of NaOH at 55° C. for 2 minutes to give saponification treatment to the surface of triacetylcellulose on the back side of the film. The antireflection film thus treated and a triacetylcellulose film 80 μm thick (TAC-TD80U, by Fuji Photo Film Co., Ltd.) having been subjected to saponification treatment under the same conditions as above were adhered, as protective films, to the respective sides of a polarizer having been produced by stretching polyvinyl alcohol with iodine adsorbed thereby to produce a sheet polarizer. When replacing the sheet polarizer which was on the visible side of the liquid crystal display device (having D-BEF by Sumitomo 3M, which is a polarized-light separating film including a polarized-light selecting layer, between the back light and the liquid crystal cell) of a note personal computer equipped with a transmissive TN liquid crystal display device with the sheet polarizer produced as above in such a manner as to allow the antireflection film side of the sheet polarizer to be the top surface, a very high-quality display was obtained in which the reflection of the background was extremely lessened, the color tone of the reflected light was significantly decreased and the uniformity in the display screen was ensured.

### Example 23

Coating was performed under the same conditions as those in example 22, provided that a coating solution for a low-refractive-index layer LL-10 was used instead of LL-9, so that an antireflection film was produced. When using the antireflection film to produce a display device in the same procedure as that in example 22, the resultant display device was a very high-quality one in which the reflection of the background was extremely lessened, the color tone of the reflected light was significantly decreased and the uniformity in the display screen was ensured.

### Comparative Example

An antireflection film was produced by forming, on the hard coat layer of example 1, a substantial intermediate-refractive-index layer made up of two layers: a titanium oxide (refractive index: 2.39) layer 25 nm thick and a silicon oxide (refractive index: 1.47) layer 25 nm thick, a high-refractive-index layer made up of titanium oxide 46 nm thick, and a low-refractive-index layer made up of silicon oxide 97 nm thick in this order. The light reflected from the antireflection film was strong reddish purple.

When using the antireflection film to produce a display device in the same procedure as that in example 1, the resultant display screen was strong reddish purple and inferior in display quality.

### Example 101

(Preparation of Coating Solution for Hard Coat Layer (HCL-1))

The same HCL-1 as in example 1 was prepared.

(Preparation of Coating Solution for Anti-Glare Hard Coat Layer (HCL-2))

50.0 parts by mass of PETA (trade name, a mixture of pentaerythritol triacrylate and pentaerythritol tetraacrylate, by Nippon Kayaku Co., Ltd.) as an ultraviolet curing resin, 2.0 parts by mass of Irgacure 184 (by Ciba Specialty Chemicals) as a photocuring initiator, 13.3 parts by mass of crosslinked acryl-styrene particles (by Soken Chemical & Engineering Co., Ltd., with an average particle size of 3.5 μm and a refractive index of 1.55, a 30% dispersion in toluene) as a first light transmitting fine particles, 1.7 parts by mass of crosslinked polystyrene particles (by Soken Chemical & Engineering Co., Ltd., with a particle size of 3.5 μm and a refractive index of 1.60, a 30% dispersion in toluene, used after dispersing with a Polytron disperser at 10000 rpm for 20 minutes) as a second light transmitting fine particles, 0.75 parts by mass of FP-132 as a fluorine-base surface modifier shown below (chemical formula 2), 10.0 parts by mass of KBM-5103 (trade name, by Shin-Etsu Chemical Co., Ltd.) as an organosilane compound and 38.5 parts by mass of toluene were fully mixed to prepare a coating solution. The coating solution was filtered through a polypropylene filter having a pore diameter of 30 μm to prepare a coating solution for an anti-glare hard coat layer (HCL-2).

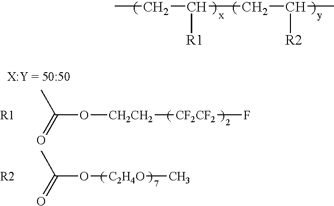

(Preparation of Dispersion A of Titanium Dioxide Fine Particles)

A dispersion A of titanium dioxide fine particles was prepared in the completely same manner as that used in example 1.

(Preparation of Coating Solution for Intermediate-Refractive-Index Layer (ML-1))

ML-1 was prepared in the completely same manner as that used in example 1.

(Preparation of Coating Solution for High-Refractive-Index Layer (HL-1))

HL-1 was prepared in the completely same manner as that used in example 1.

(Preparation of Coating Solution for Low-Refractive-Index Layer (LL-1))

LL-1 was prepared in the completely same manner as that used in example 1.

(Preparation of Sol Solution a)

A sol solution a was prepared in the completely same manner as that used in example 1.

(Preparation of Coating Solution for Low-Refractive-Index Layer (LL-2))

13.1 g of JTA 113 (trade name, refractive index: 1.44, solid content: 6%, MEK solution, by JSR Corporation) having an enhanced coating film strength compared with JN-7228A described above, 1.31 g of colloidal silica dispersion, MEK-ST-L (trade name, average particle size: 45 nm, solid content: 30%, by Nissan Chemical Industries, Ltd.), 0.59 g of the above sol solution a, 5.1 g of methyl ethyl ketone, and 0.6 g of cyclohexanone were added and stirred. Then, the mixture was filtered through a polypropylene filter having a pore diameter of 1 μm to prepare a coating solution for a low-refractive-index layer (LL-2).

(Construction of Die Coater)

In a slot die 13 used, as shown in FIGS. 10A and 10B, the land length, I_{UP}, of its upstream lip was 0.5 mm, the land length, I_{LO}, of its downstream lip was 50 μm, the length of the opening of the slot 16 along the length of the running web was 150 μm, and the length of the slot 16 was 50 mm. The space between the land 18a of the upstream lip and the web 12 was made larger than the space between the land 18b of the downstream lip and the web 12 by 50 μm (hereinafter referred to as overbite length of 50 μm) and the space G_{L} between the land 18b of the downstream lip and the web 12 was set to 50 μm. The space, G_{S}, between the side plate 40b of the vacuum chamber 40 and the web W and the space, G_{B}, between the back plate 40a of the vacuum chamber and the web W were both 200 μm.

(Production of Antireflection Film)

A coating solution for a hard coat layer (HCL-1) was applied onto a triacetylcellulose film 80 μm thick (TD-80UF, by Fuji Photo Film Co., Ltd.), whose coating-side surface had undergone antistatic treatment with an ultrasonic dust remover, at a coating speed of 30 m/min using the above described die coater. The vacuum degree of the vacuum chamber 40 was set to 0.8 kPa. When applying HCL-1 (a coating solution for a hard coat layer), the space G_{L} between the land 18b of the downstream lip and the web W was changed to 80 μm. Right after the coating, the coating layer underwent initial drying using first drying equipment 215 shown in FIG. 20A. The total length of the first drying equipment 215 was 5 m. Condenser plates 221, 222 in the first drying equipment 215 were arranged in such a manner as to be inclined at a given angle so that their downstream portions, in terms of the direction in which the web W ran, were kept away from the coating film. The coated web 211a having undergone initial drying in the first drying equipment 215 was then dried at 80° C. using second drying equipment 217. And the coating layer was cured by being exposed to ultraviolet rays using an air-cooled metal halide lamp of 160 W/cm (EYEGRAPHICS Co., Ltd.) at a irradiance of 400 mW/cm² and an irradiation dose of 500 mJ/cm², while performing nitrogen purging to make the oxygen concentration in the atmosphere 0.1% by volume or less, so that a hard coat layer with a thickness 8 μm was formed. Then, a coating solution for an intermediate-refractive-index layer (ML-1) was applied onto the above hard coat layer at a coating speed of 30 m/min using the same die coater as above. The vacuum degree of the vacuum chamber was set to 0.8 kPa.

Right after the coating of the coating solution for an intermediate-refractive-index layer, the coating layer underwent initial drying using first drying equipment 215 shown in FIG. 20A. Condenser plates 221, 222 in the first drying equipment 215 were arranged in such a manner as to be inclined at a given angle so that their downstream portions, in terms of the direction in which the web W ran, were kept away from the coating film. The coated web 211a having undergone initial drying in the first drying equipment 215 was then dried at 100° C. for 30 seconds using second drying equipment 217. And the coating layer was cured by being exposed to ultraviolet rays using an air-cooled metal halide lamp of 240 W/cm (EYEGRAPHICS Co., Ltd.) at a irradiance of 550 mW/cm² and an irradiation dose of 550 mJ/cm², while performing nitrogen purging to make the oxygen concentration in the atmosphere 1.0% by volume or less, so that an intermediate-refractive-index layer (with a refractive index of 1.63 and thickness 64 nmn) was formed.

Then, a coating solution for a high-refractive-index layer (HL-1) was applied onto the above intermediate-refractive-index layer at a coating speed of 30 m/min using the same die coater as above. The vacuum degree of the vacuum chamber was set to 0.8 kPa. Right after the coating, the coating layer underwent initial drying using first drying equipment 215 shown in FIG. 20A. Condenser plates 221, 222 in the first drying equipment 215 were arranged in such a manner as to be inclined at a given angle so that their downstream portions, in terms of the direction in which the web W ran, were kept away from the coating film. The coated web 211a having undergone initial drying in the first drying equipment 215 was then dried at 100° C. for 30 seconds using second drying equipment 217. And the coating layer was cured by being exposed to ultraviolet rays using an air-cooled metal halide lamp of 240 W/cm (EYEGRAPHICS Co., Ltd.) at a irradiance of 550 mW/cm² and an irradiation dose of 550 mJ/cm², while performing nitrogen purging to make the oxygen concentration in the atmosphere 1.0% by volume or less, so that a high-refractive-index layer (with a refractive index of 1.90 and thickness 103 nm) was formed.

A coating solution for a low-refractive-index layer (LL-1) was applied onto the above high-refractive-index layer at a coating speed of 30 m/min using the same die coater as above. The vacuum degree of the vacuum chamber was set to 0.8 kPa. Right after the coating, the coating layer underwent initial drying using first drying equipment 215 shown in FIG. 20A. Condenser plates 221, 222 in the first drying equipment 215 were arranged in such a manner as to be inclined at a given angle so that their downstream portions, in terms of the direction in which the web W ran, were kept away from the coating film. The coated web 211a having undergone initial drying in the first drying equipment 215 was then dried at 90° C. for 30 seconds using second drying equipment 217. And the coating layer was cured by being exposed to ultraviolet rays using an air-cooled metal halide lamp of 240 W/cm (EYEGRAPHICS Co., Ltd.) at a irradiance of 600 mW/cm² and an irradiation dose of 400 mJ/cm², while performing nitrogen purging to make the oxygen concentration in the atmosphere 0.1% by volume or less, so that a low-refractive-index layer (with a refractive index of 1.45 and thickness 83 nm) was formed. Thus, an antireflection film 10 shown in FIG. 1 was produced.

In the above production process, the coating and drying steps were conducted in an atmosphere of air with an air cleanness degree of 30/m³, on the basis of the number of particles 0.5 μm or more in size. The coating was conducted while performing dust removing in such a manner as to remove dust deposits from the web surface by blowing air with high cleanness degree described in Japanese Patent Application Laid-open No. 10-309553 at a high speed right before the coating operation and apply suction to the suction opening provided in close proximity to the web. The static voltage of the base before dust removing was 200 V or less. The above described coating was conducted, for each layer, through the steps of: delivering—dust removing—coating—drying—(UV or heat) curing—rolling up.

In the antireflection film thus produced, no troubles due to the coating operation occurred. Further, although the drying speed right after the coating operation was 0.3 [g/(m²·s)] or higher for each layer whose film thickness was 200 nm or less in a dried state, the resultant antireflection film was highly uniform in color tone, because the film thickness non-uniformity due to the coating operation was not visually observed. The above described drying speed was measured by extracting the coating film at several positions in the first drying equipment 215.

The produced antireflection film 10 was immersed in a 2.0 N aqueous solution of NaOH at 55° C. for 2 minutes to give saponification treatment to the surface of triacetylcellulose on the back side of the film. The antireflection film thus treated and a triacetylcellulose film 80 μm thick (TAC-TD80U, by Fuji Photo Film Co., Ltd.) having been subjected to saponification treatment under the same conditions as above were adhered, as protective films, to the respective sides of a polarizer having been produced by stretching polyvinyl alcohol with iodine adsorbed thereby to produce a sheet polarizer. When replacing the sheet polarizer which was on the visible side of the liquid crystal display device (having D-BEF by Sumitomo 3M, which is a polarized-light separating film including a polarized-light selecting layer, between the back light and the liquid crystal cell) of a note personal computer equipped with a transmissive TN liquid crystal display device with the sheet polarizer produced as above in such a manner as to allow the antireflection film side of the sheet polarizer to be the top surface, a very high-quality display device was obtained in which the reflection of the background was extremely lessened, the color tone of the reflected light was significantly decreased and the uniformity in the display screen was ensured.

### Example 102

A coating solution for an anti-glare hard coat layer, HCL-2, was applied onto a triacetylcellulose film 80 μm thick (TD80U: trade name, by Fuji Photo Film Co., Ltd.) in a roll, while unrolling the same, at a coating speed of 30 m/min using the above described die coater (refer to FIGS. 8 and 9) so that the coating thickness was 7 μm in a dried state.

When applying HCL-2, the space GL between the land 18b of the downstream lip and the web W was changed to 80 μm and the vacuum degree of the vacuum chamber was set to 0.8 kPa. Right after the coating, the coating layer underwent initial drying using the first drying equipment 215 shown in FIG. 20A. The total length of the first drying equipment 215 was 5 m. Condenser plates 221, 222 in the first drying equipment 215 were arranged in such a manner as to be inclined at a given angle so that their downstream portions, in terms of the direction in which the web W ran, were kept away from the coating film. The coated web 211a having undergone initial drying in the first drying equipment 215 was dried at 110° C. for 10 seconds and further dried at 50° C. for 20 seconds using second drying equipment 217. And the coating layer was photo-cured by being exposed to ultraviolet rays until the integrated quantity of light was 55 mJ, under nitrogen purging (oxygen concentration of 200 ppm or lower), so that an anti-glare layer was formed. The resultant triacetylcellulose film with the anti-glare hard coat layer coated thereon was rolled up.

The triacetylcellulose film with the above anti-glare layer coated thereon was unrolled again and the above described coating solution for a low-refractive-index layer (LL-8) was applied onto the above anti-glare layer at a coating speed of 30 m/min using the same die coater as above so that the coating thickness was 100 nm in a dried state. The vacuum degree of the vacuum chamber was set to 0.8 kPa. Right after the coating, the coating layer underwent initial drying using first drying equipment 215 shown in FIG. 20A. The total length of the first drying equipment 215 was 5 m. Condenser plates 221, 222 in the first drying equipment 215 were arranged in such a manner as to be inclined at a given angle so that their downstream portions, in terms of the direction in which the web W ran, were kept away from the coating film. The coated web 211a having undergone initial drying in the first drying equipment 215 was dried at 120° C. for 70 seconds and further dried at 110° C. for 10 minutes using second drying equipment 217. After thermoset, the coating layer was photo-cured by being exposed to ultraviolet rays until the integrated quantity of light was 120 mJ, under nitrogen purging (oxygen concentration of 100 ppm or lower), so that an antireflection film 30 with an anti-glare layer and a low-refractive-index layer coated thereon (refer to FIG. 3) was produced. The resultant antireflection film was rolled up.

In the above production process, the coating and drying steps were conducted in an atmosphere of air with an air cleanness degree of 30/m³, on the basis of the number of particles 0.5 μm or more in size. The coating was conducted while performing dust removing in such a manner as to remove dust deposits from the film surface by blowing air with high cleanness degree described in Japanese Patent Application Laid-open No. 10-309553 at a high speed right before the coating operation and apply suction to the suction opening provided in close proximity to the film. The static voltage of the base before dust removing was 200 V or less. The above described coating was conducted, for each layer, through the steps of: delivering—dust removing—coating—drying—(UV or heat) curing—rolling-up.

In the antireflection film 30 thus produced, no troubles due to the coating operation occurred. Further, although the drying speed right after the coating operation was 0.3 [g/(m²·sec)] or higher for each layer whose film thickness was 200 nm or less in a dried state, the resultant antireflection film 30 was highly uniform in color tone, because the film thickness non-uniformity due to the coating operation was not visually observed.

The produced antireflection film 30 was immersed in a 2.0 N aqueous solution of NaOH at 55° C. for 2 minutes to give saponification treatment to the surface of triacetylcellulose on the back side of the film. The antireflection film thus treated and a triacetylcellulose film 80 μm thick (TAC-TD80U, by Fuji Photo Film Co., Ltd.) having been subjected to saponification treatment under the same conditions as above were adhered, as protective films, to the respective sides of a polarizer having been produced by stretching polyvinyl alcohol with iodine adsorbed thereby to produce a sheet polarizer. When replacing the sheet polarizer which was on the visible side of the liquid crystal display device (having D-BEF by Sumitomo 3M, which is a polarized-light separating film including a polarized-light selecting layer, between the back light and the liquid crystal cell) of a note personal computer equipped with a transmissive TN liquid crystal display device with the sheet polarizer produced as above in such a manner as to allow the antireflection film side of the sheet polarizer to be the top surface, a very high-quality display was obtained in which the reflection of the background was extremely lessened, the color tone of the reflected light was significantly decreased and the uniformity in the display screen was ensured.

### Example 103

Coating was performed in the same manner as in example 102, provided that initial drying in the drying step right after each coating operation was performed using drying equipment 160 shown in FIG. 17 instead of that shown in a coating/drying line 210 of FIG. 20A, to produce an antireflection film 30 (refer to FIG. 3). In the drying equipment 160 shown in FIG. 17, the opening rate of the air-rectifying plate 190 was set to 25%, the distance C between the coating film surface and the air-rectifying plate to 10 mm, the exhaust velocity in each of drying zones 167 to 173 to 0.1 m/sec. The total length of the drying equipment 160 was 5 m. In the antireflection film 30 thus produced, no troubles due to the coating operation occurred. Further, although the drying speed right after the coating operation was 0.3 [g/(m²·sec)] or higher for each layer whose film thickness was 200 nm or less in a dried state, the resultant antireflection film 30 was highly uniform in color tone, because the film thickness non-uniformity due to the coating operation was not visually observed. When producing a display device using this antireflection film in the same procedure as that in example 102, the resultant display device was a very high-quality one in which the reflection of the background was extremely lessened, the color tone of the reflected light was significantly decreased and the uniformity in the display screen was ensured.

### Example 104

Coating was performed in the same manner as in example 102, provided that initial drying in the drying step right after each coating operation was performed using drying equipment shown in FIG. 14 instead of that shown in a coating/drying line 210 of FIG. 20A, to produce an antireflection film 30. In each drying step, air (relative air velocity to the coated surface: 0.05 m/sec in the direction in which the web ran, 25° C., 50% RH) was introduced from the air inlet (5 mm×1600 mm) of the coating chamber through the wire cloth of a drying zone 113 where the web having passed the air-rectifying plate 112 entered. The air from the air inlet of the coating chamber is exhausted not only through the air exit of the coating chamber, but through an outlet 117 via a porous plate 115 and wire cloth 116.

In the antireflection film 30 thus produced, no troubles due to the coating operation occurred. Further, although the drying speed right after the coating operation was 0.3 [g/(m²·sec)] or higher for each layer whose film thickness was 200 nm or less in a dried state, the resultant antireflection film 30 was highly uniform in color tone, because the film thickness non-uniformity due to the coating operation was not visually observed. When producing a display device using this antireflection film in the same procedure as that in example 102, the resultant display device was a very high-quality one in which the reflection of the background was extremely lessened, the color tone of the reflected light was significantly decreased and the uniformity in the display screen was ensured.

### Comparative Example 101

An antireflection film was produced by performing coating in the same manner as in example 102, provided that initial drying in the drying step right after each coating operation was performed employing a hot-air drying process in which drying was performed by blowing air from an air nozzle on the coated surface of the web while supporting the non-coated surface of the web with a roll. The coated surface was disordered because it was struck by air right after the coating operation, and significant film thickness non-uniformity occurred throughout the web surface. The drying speed right after the coating operation was 0.3 [g/(m²·sec)] or higher for each layer. When producing a display device using this antireflection film in the same procedure as that in example 102, color tone non-uniformity was visually observed in the resultant display device, and the device was far from of high quality.

### Comparative Example 102

An antireflection film was produced by performing coating in the same manner as in example 102, provided that initial drying in the drying step right after each coating operation was performed by arranging condenser plates, so as to make the evaporation rate of each layer 0.15 [g/(m²·sec)], in such a manner as to be inclined at a given angle so that their downstream portions, in terms of the direction in which the web W ran, were kept away from the coating film.

In this experiment (comparative example 102), since the evaporation rate of each layer was 0.15 [g/(m²·sec)], which was lower than 0.3 [g/(m²·sec)], the web went out from the drying equipment with its coating layer having been not fully dried. But, once the web had gone out from the drying equipment, drying progressed rapidly in the coating layer, which caused film thickness non-uniformity in the entire surface of the web. When producing a display device using this antireflection film in the same procedure as that in example 102, color tone non-uniformity was visually observed in the resultant display device, and the device was far from of high quality.

### Comparative Example 103

An antireflection film was produced by performing coating in the same manner as in example 102, provided that the total length of the drying equipment used in the drying step right after each coating operation was 0.5 m. In comparative example 103, since the total length of the drying equipment is short, the web went out from the drying equipment with its coating layer having been not fully dried. But, once the web had gone out from the drying equipment, drying progressed rapidly in the coating layer, which caused film thickness non-uniformity in the entire surface of the web. When producing a display device using this antireflection film in the same procedure as that in example 102, color tone non-uniformity was visually observed in the resultant display device, and the device was far from of high quality.

### Comparative Example 104

An antireflection film was produced under the same conditions as those in example 102, provided that a gravure coater was used instead of the above described die coater (refer to FIGS. 9, 10A and 10B). Coating could be performed; however, there were produced film thickness non-uniformity due to the coating operation. When producing a display device using this antireflection film in the same procedure as in example 102, color tone non-uniformity was visually observed in the display device, and the device was far from of high quality.

Antireflection films were produced by performing application under the same conditions as those in example 102, provided that the land length ILO of the downstream lip was set to 10 μm (comparative example 105), 30 μm (example 105), 100 μm (example 106) and 120 μm (comparative example 106), respectively. The results confirmed that when the land length ILO of the downstream lip was in the range of 30 μm to 100 μm, antireflection films were obtained in which no defective planes occurred. In comparative example 105, film thickness non-uniformity occurred along the length of the base due to the coating operation. In comparative example 106, coating beads 14a could not be formed at the same coating speed as that in example 102, and therefore, coating could not be performed. When producing display devices using the antireflection films of examples 105 and 106, respectively, in the same procedure as that in example 101, the resultant display devices were very high-quality ones in which the reflection of the background was extremely lessened, the color tone of the reflected light was significantly decreased and the uniformity in the display screen was ensured.

In contrast, when producing display devices using the antireflection films of comparative examples 105 and 106, respectively, in the same procedure as that in example 102, color tone non-uniformity was visually observed in the display device, and the device was far from of high quality.

### Comparative Example 107, Example 107, Example 108, Comparative Example 108

Antireflection films were produced by performing application under the same conditions as those in example 102, provided that the overbite length LO of die coaters were set to 0 μm (comparative example 107), 30 μm (example 107), 120 μm (example 108) and 150 μm (comparative example 108), respectively. When the overbite length was in the range of 30 μm to 120 μm, antireflection films were obtained in which no defective planes occurred. In comparative example 107, coating could be performed; however, film-thickness non-uniformity due to the coating operation was observed in the plane.

In comparative example 108, coating beads 14a could not be formed at the same coating speed as that in example 102, and therefore, coating could not be performed. When producing display devices using the antireflection films produced in examples 107 and 108 to the same procedure as that in example 102, very high-quality displays were obtained in which the reflection of the background was extremely lessened, the color tone of the reflected light was significantly decreased and the uniformity in the display screen was ensured. In contrast, when producing display devices using the antireflection films produced in comparative examples 107 and 108 in the same procedure as that in example 102, color tone non-uniformity was visually observed in the display devices, and therefore, the resultant display devices were far from of high quality.

1. A process for producing an antireflection film comprising applying, using a slot die, a coating solution onto a transparent substrate which is backed up by a back-up roller and runs continuously to form at least one layer, on the transparent substrate, having thickness of 200 nm or less in a dried state and having a refractive index lower than that of the transparent substrate, wherein
the slot die has a first edge lip having a land length along a running direction of the transparent substrate of 30 to 100 μm in downstream of the running transparent substrate, and
a space between a second edge lip of the slot die in upstream of the running transparent substrate and a surface of the transparent substrate is set to be 30 to 120 μm larger than a space between the first edge lip of the slot die in downstream of the running transparent substrate and a surface of the transparent substrate.

2. The process for producing an antireflection film according to claim 1, wherein the coating solution has a viscosity at the time of coating of 20.0 mPa·sec or less, and the coating solution is applied onto the transparent substrate in an amount of 2.0 to 5.0 ml/m².

3. The process for producing an antireflection film according to claim 1, wherein substantially three layers with different refractive indices: an intermediate-refractive-index layer, a high-refractive-index layer, and a low-refractive-index layer are formed on the transparent substrate in this order.

4. The process for producing an antireflection film according to claim 3, wherein, in relation to a designed wavelength λ (=400 to 680 nm) for the antireflection film, the intermediate-refractive-index layer satisfies the following formula 1, the high-refractive-index layer satisfies the following formula 2, and the low-refractive-index layer satisfies the following formula 3:
(λ/4)×0.80<n1d1<(λ/4)×1.00 (Formula 1)
(λ/2)×0.75<n2d2<(λ/2)×0.95 (Formula 2)
(λ/4)×0.95<n3d3<(λ/4)×1.05 (Formula 3)
wherein, in the formula 1, n1 represents a refractive index of the intermediate-refractive-index layer and d1 represents a layer thickness (nm) of the intermediate-refractive-index layer; in the formula 2, n2 represents the refractive index of the high-refractive-index layer and d2 represents a layer thickness (nm) of the high-refractive-index layer; and in the formula 3, n3 represents a refractive index of the low-refractive-index layer and d3 a layer thickness (nm) of the low-refractive-index layer.

5. The process for producing an antireflection film according to claim 4, wherein the intermediate-refractive-index layer has a refractive index n1 of 1.60 to 1.65, the high-refractive-index layer has a refractive index n2 of 1.85 to 1.95 and the low-refractive-index layer has a refractive index n3 of 1.35 to 1.45, as compared with the transparent substrate having a refractive index of 1.45 to 1.55.

6. The process for producing an antireflection film according to claim 3, wherein the layer having a refractive index lower than that of the transparent substrate or the low-refractive-index layer is composed of a thermoset and/or ionizing radiation curable fluorine-containing resin.

7. The process for producing an antireflection film according to claim 3, wherein the high-refractive-index layer comprises inorganic fine particles that contain titanium dioxide, as a main component, including at least one element selected from a group consisting of cobalt, aluminum and zirconium and has a refractive index of 1.55 to 2.40.

8. The process for producing an antireflection film according to claim 1, wherein the antireflection film includes at least one hard coat layer between the layer having a refractive index lower than that of the transparent substrate or the low-refractive-index layer and the transparent substrate.

9. The process for producing an antireflection film according to claim 1, wherein one or more layers constituting the antireflection film are continuously formed without being wound.

10. An antireflection film, comprising at least one layer obtained by the process according to claim 1.

11. A process for producing a coating film by applying, using a slot die, a coating solution onto a continuously running web so that a wherein
the slot die has a first edge lip having a land length along a running direction of the web of 30 μm to 100 μm in downstream of the running web, and
the coating solution applied onto the web is dried using a drying equipment which performs drying while avoiding turbulence of air adjacent to a coated surface with a drier that has a casing surrounding the web right after the application and keeping concentration of a solvent vapor of the coated surface high under drying.

12. The process for producing a coating film according to claim 11, wherein a condenser which condenses and recovers a solvent in the coating solution is provided on the coated surface side of a position through which the web runs within the drier.

13. The process for producing a coating film according to claim 12, wherein the condenser comprises a cooling mechanism, thereby being able to control its temperature.

14. A process for producing a coating film by applying, using a slot die, a coating solution onto a continuously running web so that a wherein
the slot die has a first edge lip having a land length along a running direction of the web of 30 μm to 100 μm in downstream of the running web, and
a surface of the coating film is dried using a drying equipment which performs drying while moving a gas along a surface of the coating film so that velocity of the gas relative to the running web is −0.1 m/sec to 0.1 m/sec.

15. A process for producing a coating film by applying, using a slot die, a coating solution onto a continuously running web so that a resultant coating layer has a thickness of 200 nm or less in a dried state, and drying the coating layer in a drying equipment, wherein
the slot die has a first edge lip having a land length along a running direction of the web of 30 μm to 100 μm in downstream of the running web, and
the drying equipment is designed to allow a gas of an organic solvent evaporating from the coating solution applied onto the web to escape to an exhaust chamber via holes in a rectifying member and exhaust the gas of the organic solvent entered the exhaust chamber to an outside through an exhaust pipe, while the web is conveyed through the drying equipment.

16. The process for producing a coating film according to claim 11, wherein a space between a second edge lip of the slot die in upstream of the running web and a surface of the web is set to be larger than a space between the first edge lip of the slot die in downstream of the web and the web.

17. The process for producing a coating film according to claim 16, wherein the space between the second edge lip of the slot die in upstream of the running web and the surface of the web is set to be 30 μm to 120 μm larger than the space between the-first edge lip of the slot die in downstream of the web and the web.

18. The process for producing a coating film according to claim 11, wherein the drying equipment has a total length such that it takes 2 seconds or longer to convey the coating film through the drying equipment and the solvent in the coating solution has an evaporation rate in the drying equipment of 0.3 g/(m²·sec) or higher.

19. A coating film, wherein the coating film is produced by the process for producing a coating film according to claim 11.

20. An antireflection film, wherein the antireflection film comprises a coating film of claim 19, and the coating film has at least one layer having a thickness of 200 nm or less in a dried state and having a refractive index lower than that of a transparent substrate as the web.

21. A sheet polarizer, wherein the sheet polarizer comprises:
a polarizing film; and
an antireflection film of claim 10 applied onto at least one surface of the polarizing film.

22. A sheet polarizer, wherein the sheet polarizer comprises:
a polarizing film;
an antireflection film of claim 10 applied onto one surface of the polarizing film; and
an anisotropic optical compensation film applied onto the other surface of the polarizing film.

23. An image display device, wherein the image display device is constituted by an antireflection film of claim 10.

24. An image display device, wherein the image display device is constituted by a sheet polarizer of claim 21.

25. An image display device, wherein the image display device is constituted by a sheet polarizer of claim 22.
